(19) United States
(12) Patent Application Publication
(10) Pub. No.: US 2026/0332465 A1
(43) Pub. Date: Oct. 22, 2026

(54) TIME-DOMAIN SHAPING OF SENSING SIGNALS

(71) Applicant: Lenovo (United States) Inc., Morrisville, NC (US)

(72) Inventors: Seyedomid Taghizadeh Motlagh, Oberursel (DE); Sher Ali Cheema, Ilmenau (DE); Robin Rajan Thomas, Bad Nauheim (DE)

(73) Assignee: Lenovo (United States) Inc., Morrisville, NC (US)

(21) Appl. No.: 19/307,953

(22) Filed: Aug. 22, 2025

(51) Int. Cl. H04L 27/26; H04W 72/02; H04W 72/0453; H04W 72/51; H04W 72/54

(52) U.S. Cl. CPC H04L 27/2634; H04L 27/2614; H04W 72/02; H04W 72/0453; H04W 72/51; H04W 72/54

(57) ABSTRACT

Various aspects of the present disclosure relate to time-domain energy shaping of a sensing signal. A device determines parameters of a time-domain signal pattern of a sensing signal. The time-domain signal pattern defines signal characteristics subsequent to inverse fast Fourier transform (IFFT) processing of frequency domain resources. The device selects, from the frequency domain resources, a first set of resource elements (REs) for transmission of data symbols and a second set of REs for generating the time-domain signal pattern. The device calculates values for the second set of REs based on the data symbols in the first set of REs, the time-domain signal pattern, IFFT block dimensions, and/or a location of the second set of REs within an IFFT input. The device generates the sensing signal having the time-domain signal pattern by performing IFFT processing of the frequency domain resources including both sets of REs and transmits the sensing signal.

### TECHNICAL FIELD

The present disclosure relates to wireless communications, and more specifically to time-domain signal shaping for sensing applications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A device for wireless communication is described. The device may be configured to, capable of, or operable to perform one or more operations as described herein. For example, the device may be configured to, capable of, or operable to determine a configuration for a sensing measurement procedure associated with a sensing signal having a first time period and a third time period that are associated with a low-power or zero-power (ZP) transmission state and a second time period that is associated with a high-power or non-zero-power (NZP) transmission state; select, based on the configuration, respective parameters for each of the first time period, the second time period, and the third time period, the respective parameters including one or more of a start time, a duration, a power level, or a time-domain sequence; generate the sensing signal according to the configuration and the respective parameters; and transmit the sensing signal during the first, second, and third time periods according to the respective power levels.

A processor for wireless communication is described. The processor may be configured to, capable of, or operable to perform one or more operations as described herein. For example, the processor may be configured to, capable of, or operable to determine a configuration for a sensing measurement procedure associated with a sensing signal having a first time period and a third time period that are associated with a low-power or zero-power transmission state and a second time period that is associated with a high-power or non-zero-power transmission state; select, based on the configuration, respective parameters for each of the first time period, the second time period, and the third time period, the respective parameters including one or more of a start time, a duration, a power level, or a time-domain sequence; generate the sensing signal according to the configuration and the respective parameters; and transmit the sensing signal during the first, second, and third time periods according to the respective power levels.

A method performed or performable by a device for wireless communication is described. The method may include determining a configuration for a sensing measurement procedure associated with a sensing signal having a first time period and a third time period that are associated with a low-power or zero-power transmission state and a second time period that is associated with a high-power or non-zero-power transmission state; selecting, based on the configuration, respective parameters for each of the first time period, the second time period, and the third time period, the respective parameters including one or more of a start time, a duration, a power level, or a time-domain sequence; generating the sensing signal according to the configuration and the respective parameters; and transmitting the sensing signal during the first, second, and third time periods according to the respective power levels.

In some implementations of the device, the processor, and the method described herein, to select the respective parameters, the device may be configured to, capable of, or operable to receive an indication of one or more of the respective parameters from at least one second device that is acting as a sensing receiver (RX) node or a sensing controller entity. In some implementations of the device, the processor, and the method described herein, the respective parameters are selected based on one or more of capability information associated with at least one second device that is acting as a sensing RX node, an energy, delay, angle, or doppler difference between a sensing target and environment clutter, an observed sensing target signal-to-noise ratio (SNR) at the at least one second device, a threshold sensing target SNR at the at least one second device, a delay or angle of one or more paths interfering with the sensing signal, geometry information that includes positions of one or more sensing transmitter (TX) devices and the at least one second device, radar cross-section information of a sensing target, a transmitter-receiver switching time associated with the at least one second device, a measurement quantity type or a measurement quantity resolution or accuracy to be generated by the at least one second device upon reception of the sensing signal, channel statistics of a channel of the sensing signal, a type of the sensing measurement procedure, or a self-interference isolation level associated with a sensing TX node and a sensing RX node.

In some implementations of the device, the processor, and the method described herein, the device may be configured to, capable of, or operable to transmit the respective parameters to a second device that is acting as a sensing TX node. In some implementations of the device, the processor, and the method described herein, the device may be configured to, capable of, or operable to perform reception and measurement of the sensing signal according to the respective parameters. In some implementations of the device, the processor, and the method described herein, the configuration includes at least one of a sensing target area, a sensing target type, a sensing TX node location, or a sensing RX node location. In some implementations of the device, the processor, and the method described herein, the power level of the first time period and the third time period are the same and are defined jointly according to a ratio relative to the power level of the second time period, or the first time period, the second time period, and the third time period each include one or more distinct time-domain symbols, guard intervals, slots, subframes, or a combination thereof, according to a sensing signal frame structure.

In some implementations of the device, the processor, and the method described herein, the first time period and the third time period are embedded within a same symbol, within a same cyclic prefix, or a combination thereof, the duration of the first time period is based on a threshold delay difference from a first arrival path for a target decibel (dB) isolation value, the duration of the third time period is equal to the duration of the second time period plus a threshold expected delay of a path associated with a sensing target, at least one of the first time period or the third time period are defined, as part of a slot format or a subframe format, as ZP periods within a symbol, a guard band, or a zero-interval outside of a symbol or guard-band period, or a cyclic prefix, a guard band, or a unique word is defined as a ZP or low-power sequence and is utilized as the first time period or the third time period. In some implementations of the device, the processor, and the method described herein, the device may be configured to, capable of, or operable to update at least one of a symbol format, a cyclic prefix format, or a slot format according to a predefined pattern based on the respective parameters.

In some implementations of the device, the processor, and the method described herein, to determine the configuration, the device may be configured to, capable of, or operable to allocate, when the second time period is within an uplink symbol or a cyclic prefix of an uplink symbol, the third time period to a downlink symbol, or allocate, when the second time period is within a downlink symbol or a cyclic prefix of a downlink symbol, the third time period to an uplink symbol. In some implementations of the device, the processor, and the method described herein, the power level of the second time period is based on a previous transmission instance and an associated measurement, an associated processing gain value, and a target SNR value, or the duration of the second time period is based on a delay difference between a sensing target path and a background channel, minus a threshold relative path delay for a target dB isolation value.

In some implementations of the device, the processor, and the method described herein, to generate the sensing signal, the device may be configured to, capable of, or operable to determine signal shaping parameters based on a group report, group capability information, or location information of a group of sensing RX nodes. In some implementations of the device, the processor, and the method described herein, one or more of the signal shaping parameters correspond to one or more indexes of a codebook. In some implementations of the device, the processor, and the method described herein, rows of the codebook indicate repetition patterns for repetitions of the sensing signal, each repetition pattern associated with a respective periodicity and a respective quantity of repetitions. In some implementations of the device, the processor, and the method described herein, each repetition pattern includes a distance-dependent signal shaping parameter that jointly defines at least one of the duration of the second time period or the duration of the third time period and at least one of the quantity of repetitions or the periodicity. In some implementations of the device, the processor, and the method described herein, the device may be configured to, capable of, or operable to adjust the power level of the second time period based on feedback indicating a ratio between an observed SNR and a threshold SNR for the sensing measurement procedure.

A device for wireless communication is described. The device may be configured to, capable of, or operable to perform one or more operations as described herein. For example, the device may be configured to, capable of, or operable to receive a configuration for a sensing measurement procedure associated with a sensing signal having a first time period and a third time period that are associated with a low-power or ZP transmission state and a second time period that is associated with a high-power or NZP transmission state; receive, in accordance with the configuration, the sensing signal during the first, second, and third time periods; and perform at least one sensing measurement on the sensing signal received during the second time period.

A processor for wireless communication is described. The processor may be configured to, capable of, or operable to perform one or more operations as described herein. For example, the processor may be configured to, capable of, or operable to receive a configuration for a sensing measurement procedure associated with a sensing signal having a first time period and a third time period that are associated with a low-power or ZP transmission state and a second time period that is associated with a high-power or NZP transmission state; receive, in accordance with the configuration, the sensing signal during the first, second, and third time periods; and perform at least one sensing measurement on the sensing signal received during the second time period.

A method performed or performable by a device for wireless communication is described. The method may include receiving a configuration for a sensing measurement procedure associated with a sensing signal having a first time period and a third time period that are associated with a low-power or ZP transmission state and a second time period that is associated with a high-power or NZP transmission state; receiving, in accordance with the configuration, the sensing signal during the first, second, and third time periods; and performing at least one sensing measurement on the sensing signal received during the second time period.

In some implementations of the device, the processor, and the method described herein, the device may be configured to, capable of, or operable to determine a ratio of an observed received SNR associated with a sensing target channel to a threshold SNR and transmit a report indicating the ratio. In some implementations of the device, the processor, and the method described herein, the device may be configured to, capable of, or operable to determine one or more parameters for the sensing signal based on performing one or more measurements associated with the sensing measurement procedure and transmit a report indicating the one or more parameters, where the configuration is received based on the report.

A device for wireless communication is described. The device may be configured to, capable of, or operable to perform one or more operations as described herein. For example, the device may be configured to, capable of, or operable to determine one or more parameters of a time-domain signal pattern of a sensing signal, where the time-domain signal pattern defines signal characteristics subsequent to inverse fast Fourier transform (IFFT) processing of frequency domain resources; select a first set of resource elements (REs) of the frequency domain resources allocated for transmission, by the device, of data symbols using a data modulation scheme; select a second set of REs of the frequency domain resources allocated for generation of the time-domain signal pattern; calculate values for the second set of REs to produce the time-domain signal pattern based on the data symbols in the first set of REs, the time-domain signal pattern, IFFT block dimensions, a location of the second set of REs within an IFFT input, or some combination thereof; generate the sensing signal having the time-domain signal pattern by performing the IFFT processing of the frequency domain resources including the first set of REs and the second set of REs; and transmit the sensing signal.

A processor for wireless communication is described. The processor may be configured to, capable of, or operable to perform one or more operations as described herein. For example, the processor may be configured to, capable of, or operable to determine one or more parameters of a time-domain signal pattern of a sensing signal, where the time-domain signal pattern defines signal characteristics subsequent to IFFT processing of frequency domain resources; select a first set of REs of the frequency domain resources allocated for transmission, by the device, of data symbols using a data modulation scheme; select a second set of REs of the frequency domain resources allocated for generation of the time-domain signal pattern; calculate values for the second set of REs to produce the time-domain signal pattern based on the data symbols in the first set of REs, the time-domain signal pattern, IFFT block dimensions, a location of the second set of REs within an IFFT input, or some combination thereof; generate the sensing signal having the time-domain signal pattern by performing the IFFT processing of the frequency domain resources including the first set of REs and the second set of REs; and transmit the sensing signal.

A method performed or performable by a device for wireless communication is described. The method may include determining one or more parameters of a time-domain signal pattern of a sensing signal, where the time-domain signal pattern defines signal characteristics subsequent to IFFT processing of frequency domain resources; selecting a first set of REs of the frequency domain resources allocated for transmission, by the device, of data symbols using a data modulation scheme; selecting a second set of REs of the frequency domain resources allocated for generation of the time-domain signal pattern; calculating values for the second set of REs to produce the time-domain signal pattern based on the data symbols in the first set of REs, the time-domain signal pattern, IFFT block dimensions, a location of the second set of REs within an IFFT input, or some combination thereof; generating the sensing signal having the time-domain signal pattern by performing the IFFT processing of the frequency domain resources including the first set of REs and the second set of REs; and transmitting the sensing signal.

In some implementations of the device, the processor, and the method described herein, to select the second set of REs, the device may be configured to, capable of, or operable to determine a resource allocation pattern that includes one or more of a starting RE position or physical resource block (PRB) position, a quantity of consecutive REs or PRBs, a frequency domain spacing between REs or PRBs, a bitmap indicating the second set of REs, or an index referencing preconfigured frequency domain resources.

In some implementations of the device, the processor, and the method described herein, to select the second set of REs, the device may be configured to, capable of, or operable to perform one or more channel measurements and select, for the second set of REs, REs having channel responses that satisfy a quality threshold. In some implementations of the device, the processor, and the method described herein, to select the second set of REs, to select the second set of REs, the device may be configured to, capable of, or operable to select the second set of REs based on capability information of the device, the capability information including one or more of a computational capacity for time-domain shaping, a processing latency associated with time-domain shaping, or a threshold quantity of time-domain shaping REs. In some implementations of the device, the processor, and the method described herein, the device may be configured to, capable of, or operable to transmit, to a sensing configuration entity, the capability information and receive, from the sensing configuration entity, an indication of the one or more parameters. In some implementations of the device, the processor, and the method described herein, the device may be configured to, capable of, or operable to transmit, to an RX device or a configuration node, an indication of the one or more parameters, an indication of the second set of REs, or both.

In some implementations of the device, the processor, and the method described herein, to select the second set of REs, the device may be configured to, capable of, or operable to receive, from an RX device, a report that includes a channel quality indication corresponding to the second set of REs or an indication of a candidate set of frequency domain REs determined by the RX device according to predefined selection criteria and select the second set of REs based on the report. In some implementations of the device, the processor, and the method described herein, a quantity of REs in the second set of REs corresponds to a quantity of time-domain samples defining the time-domain signal pattern. In some implementations of the device, the processor, and the method described herein, the time-domain signal pattern includes one or more of a pulse pattern having one or more ZP periods and at least one non-zero power period, an isolated ZP period, a pattern associated with reduction of a peak-to-average power ratio (PAPR) of the sensing signal, or some combination thereof.

In some implementations of the device, the processor, and the method described herein, the sensing signal is transmitted within a portion of a symbol and has a quasi-co-location (QCL) relationship with frequency domain resources of a second signal that are precoded according to a same spatial pattern as the portion of the symbol. In some implementations of the device, the processor, and the method described herein, the frequency domain resources of the second signal include data REs or demodulation reference signal (DMRS) REs, and the device may be configured to, capable of, or operable to transmit an indication of the QCL relationship to an RX device. In some implementations of the device, the processor, and the method described herein, the time-domain signal pattern is associated with a first spatial transmission pattern and the first set of REs are associated with a second spatial transmission pattern different from the first spatial transmission pattern. In some implementations of the device, the processor, and the method described herein, the time-domain signal pattern spans one or more transmission symbols or a portion of a transmission symbol.

A device for wireless communication is described. The device may be configured to, capable of, or operable to perform one or more operations as described herein. For example, the device may be configured to, capable of, or operable to receive a sensing signal having a time-domain signal pattern that defines signal characteristics subsequent to IFFT processing of frequency domain resources of the sensing signal, where the frequency domain resources include at least a first set of REs allocated for data symbols using a data modulation scheme and a second set of REs allocated for generation of the time-domain signal pattern; obtain the data symbols from the first set of REs by performing fast Fourier transform (FFT) processing on the sensing signal; and perform one or more measurements using the sensing signal based on the time-domain signal pattern.

A processor for wireless communication is described. The processor may be configured to, capable of, or operable to perform one or more operations as described herein. For example, the processor may be configured to, capable of, or operable to receive a sensing signal having a time-domain signal pattern that defines signal characteristics subsequent to IFFT processing of frequency domain resources of the sensing signal, where the frequency domain resources include at least a first set of REs allocated for data symbols using a data modulation scheme and a second set of REs allocated for generation of the time-domain signal pattern; obtain the data symbols from the first set of REs by performing FFT processing on the sensing signal; and perform one or more measurements using the sensing signal based on the time-domain signal pattern.

A method performed or performable by a device for wireless communication is described. The method may include receiving a sensing signal having a time-domain signal pattern that defines signal characteristics subsequent to IFFT processing of frequency domain resources of the sensing signal, where the frequency domain resources include at least a first set of REs allocated for data symbols using a data modulation scheme and a second set of REs allocated for generation of the time-domain signal pattern; obtaining the data symbols from the first set of REs by performing FFT processing on the sensing signal; and performing one or more measurements using the sensing signal based on the time-domain signal pattern.

In some implementations of the device, the processor, and the method described herein, the device may be configured to, capable of, or operable to receive a configuration indicating the second set of REs and one or more time-domain shaping parameters associated with the sensing signal. In some implementations of the device, the processor, and the method described herein, the device may be configured to, capable of, or operable to perform channel state information (CSI) estimation based on the configuration. In some implementations of the device, the processor, and the method described herein, the sensing signal includes one or more ZP time periods and at least one NZP time period, and the device may be configured to, capable of, or operable to apply different automatic gain control (AGC) states during different time periods of the sensing signal according to the time-domain signal pattern. In some implementations of the device, the processor, and the method described herein, to obtain the data symbols, the device may be configured to, capable of, or operable to perform rate matching around the second set of REs. In some implementations of the device, the processor, and the method described herein, the device may be configured to, capable of, or operable to transmit a report that includes a channel quality indication corresponding to the second set of REs or an indication of a candidate set of frequency domain REs determined according to predefined selection criteria.

### BRIEF DESCRIPTION OF THE DRAWINGS

FIG. 1 illustrates an example of a wireless communications system in accordance with aspects of the present disclosure.

FIG. 2 illustrates an example of an integrated sensing and communication (ISAC) channel, in accordance with aspects of the present disclosure.

FIG. 3 illustrates an example of a timing diagram, in accordance with aspects of the present disclosure.

FIGS. 4A and 4B illustrate examples of sensing procedure configurations, in accordance with aspects of the present disclosure.

FIGS. 5A through 5D illustrate examples of sensing network architectures, in accordance with aspects of the present disclosure.

FIG. 6 illustrates an example of a timing diagram, in accordance with aspects of the present disclosure.

FIGS. 7A through 7F illustrate examples of sensing signal frame structures, in accordance with aspects of the present disclosure.

FIG. 8 illustrates an example of a multiplexing procedure, in accordance with aspects of the present disclosure.

FIGS. 9 through 11 illustrate examples of multiplexing computation logic, in accordance with aspects of the present disclosure.

FIG. 12 illustrates an example of a symbol diagram, in accordance with aspects of the present disclosure.

FIGS. 13A and 13B illustrate examples of waveform processing diagrams, in accordance with aspects of the present disclosure.

FIG. 14 illustrates an example of a UE in accordance with aspects of the present disclosure.

FIG. 15 illustrates an example of a processor in accordance with aspects of the present disclosure.

FIG. 16 illustrates an example of an NE in accordance with aspects of the present disclosure.

FIG. 17 illustrates a flowchart of a method performed by a UE in accordance with aspects of the present disclosure.

FIG. 18 illustrates a flowchart of a method performed by an NE in accordance with aspects of the present disclosure.

### DETAILED DESCRIPTION

A wireless communications system may include one or more devices, such as UEs and NEs, that transmit and receive signaling using a waveform, including an OFDM waveform. An OFDM waveform divides a communication channel into multiple frequency resources in a frequency domain, referred to as subcarriers, such that the UEs and the NEs exchange data in parallel streams using the multiple subcarriers. In some cases, a transmitting device (e.g., a transmitter of a UE or an NE) may encode data onto orthogonal subcarriers in the frequency domain, perform an IFFT on the encoded data to generate a time-domain signal, and transmit the time-domain signal over a communication pathway that may be referred to as a channel. A receiving device (e.g., a receiver of a UE or an NE) may perform the reverse process (e.g., FFT) to demodulate and decode a received time-domain signal. Types of OFDM waveforms include cyclic prefix OFDM (CP-OFDM) and discrete Fourier transform spreading OFDM (DFT-s-OFDM).

Devices in the wireless communications system may implement integrated sensing and communication (ISAC) capabilities that enable simultaneous communication services and environmental sensing operations. In ISAC systems, wireless signals may serve dual purposes by carrying communication data while also providing sensing information about objects, targets, or environmental conditions within a coverage area. A device (e.g., a UE, an NE) performs a sensing procedure to generate and collect measurements to obtain sensing information of target objects and/or environments, such as target detection, target information (orientation, shape, material), positioning, velocity estimation, direction or heading information, radar cross section (RCS) information, and environmental monitoring without requiring dedicated sensing hardware. A sensing device that transmits a sensing signal may be referred to as a sensing TX, while a sensing device that receives the sensing signal may be referred to as a sensing RX. The sensing RX may receive reflections of the sensing signal off of the environment and/or a sensing target, process the received reflections, and infer relevant information. A sensing process may include one or multiple (static or mobile) sensing TX nodes and one or multiple (static or mobile) sensing RX nodes.

An ISAC channel combines a target channel (including paths impacted by the sensing target) and a background channel (including propagation paths that exist between the sensing TX and sensing RX, but are not impacted by the sensing target). Background channel paths may include line-of-sight (LoS) paths, ground reflections, and other environmental scattering paths that do not contain sensing information about the target of interest. Challenges in ISAC systems arises from interference between sensing signals and background channel paths that may have substantially different power characteristics. For example, a sensing RX may receive sensing target reflections at significantly lower power levels compared to signals received via direct transmission (e.g., LoS) paths between the sensing TX and the sensing RX. When background channel signals are orders of magnitude stronger than sensing target reflection signals, the resulting interference may cause weaker sensing signals to become difficult to detect and process accurately, leading to degraded sensing performance and reduced measurement accuracy.

Accordingly, the techniques described herein improve isolation of a sensing signal from interfering background channel paths by shaping the sensing signal in the time-domain. After shaping, the sensing signal includes a first (e.g., initial) time period, a second (e.g., subsequent to the initial) time period, and a third (e.g., subsequent to the second) time period. The first and third time periods may be associated with a zero- or low-power transmission state and may be referred to herein as ZP periods, while the second time period is associated with a non-zero or high-power transmission state, referred to herein as a NZP period. This results in a pulse-shaped sensing signal in the time-domain, with zero- or low-power transmissions prior to and subsequent to the pulse. Parameters used in the shaping (e.g., time-domain position, duration, transmission power level) may depend on geometry of the sensing scenario and/or environment (e.g., sensing TX position, sensing RX position, target area) and a dynamic range and/or processing capability of the sensing RX. The sensing TX, sensing RX, and, in some examples, a configuration entity, can exchange information to determine or adjust the parameters.

To support ISAC procedures, the described techniques further provide for multiplexing the sensing signal with other reference signals or data. For example, the sensing TX can assign the ZP periods and/or the NZP periods to different (e.g., distinct) NFFT blocks, symbols, cyclic prefixes, and/or guard intervals according to a frame structure (e.g., a slot format, a symbol format, a subframe format, or the like). During signal generation, the sensing TX may calculate values used in the shaping based on data symbols to be multiplexed with the sensing signal, thereby ensuring that the shaped sensing signal (including the data symbols) maintains the pulse shape.

By performing the techniques described herein, a device in a wireless communications system can reduce interference between sensing signals and environmental clutter, thereby improving accuracy and efficiency in sensing procedures. For example, by leveraging the different propagation delays inherent in background channel paths versus sensing target reflection paths, the three-period structure of the shaped sensing signal creates temporal separation between interfering background signals and desired sensing target reflections. Coordinating timing of the three periods with expected delay differences may ensure that stronger background signals arrive at the sensing RX during ZP periods while sensing target reflections arrive when the sensing RX can process them without interference. Additionally, multiplexing shaped sensing signals with other reference signals or data signals provides improved efficiency and reduces overhead while supporting ISAC procedures.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

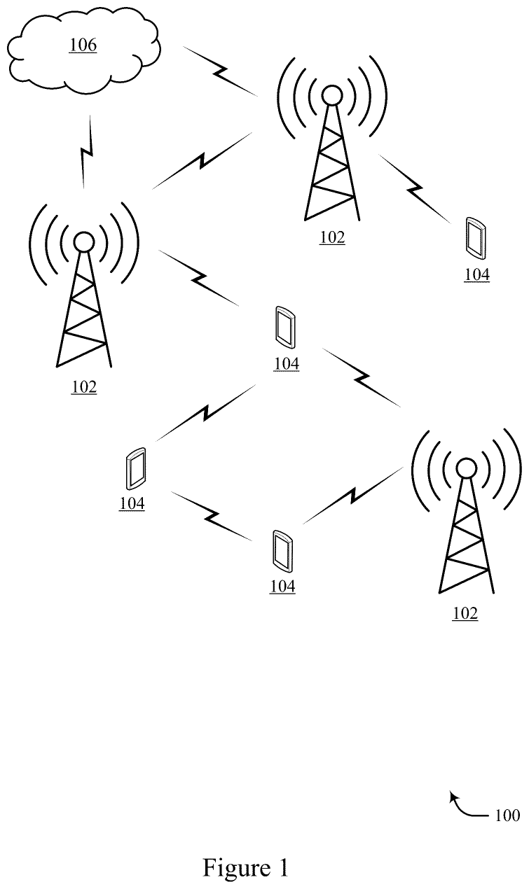

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network equipment, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network equipment, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network equipment 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network equipment 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The devices in the wireless communications system 100 may implement multi-carrier-based waveforms. For example, one or more NEs 102 and/or one or more UEs 104 in the wireless communications system 100 may implement OFDM based waveforms for both uplink and downlink communications, such as a CP-OFDM based waveform for uplink and downlink communications and/or a DFT-s-OFDM waveform for uplink communications, among other examples. The devices may utilize a hierarchical radio frame structure in a communication channel, in which a radio frame is divided into multiple subframes. Each subframe is divided into multiple slots and each slot includes a number of OFDM symbols.

An OFDM-based waveform refers to a modulation technique that divides a communication channel into multiple orthogonal subcarriers in a frequency domain, providing for parallel data transmission. A CP-OFDM based waveform is a type of OFDM waveform that includes a CP, which is a copy of the end portion of an OFDM symbol added to the beginning or start of the OFDM symbol. The CP may reduce inter-symbol interference and maintain orthogonality between subcarriers by introducing a guard interval or period in the symbol. A DFT-s-OFDM waveform is a type of OFDM-based waveform that applies a DFT operation to allocate (e.g., assign, partition, spread) the modulated data symbols across multiple subcarriers before performing an IFFT operation.

In some cases, devices in the wireless communications system 100 can exchange (e.g., transmit and receive) one or more reference signals (also referred to herein as sensing signals). A reference signal may refer to a signal or a sequence known to both a transmitter and a receiver and used for channel estimation, synchronization, or other signal processing tasks. Additionally, or alternatively, the devices may implement ISAC technology, in which signal processing extracts sensing information from wireless transmissions. Sensing operations may involve transmitting one or more sensing signals toward one or more sensing targets and analyzing reflected or scattered signals to determine target characteristics. A sensing procedure may include measuring parameters such as signal delay, Doppler shift, angle of arrival, and received signal strength to infer information about target presence, location, velocity, and other physical properties.

Sensing procedures may include network-to-network sensing where multiple NEs 102 coordinate to perform sensing measurements across coverage areas. Network-to-UE sensing scenarios may involve the NE 102 transmitting sensing signals that are received and processed by the UE 104 to generate sensing measurements. UE-to-UE sensing configurations may enable direct sensing operations between multiple UE 104 devices without requiring coordination through the NE 102. UE-to-same-UE sensing scenarios may allow a single UE 104 to transmit sensing signals and receive reflected signals from targets within the environment, enabling self-contained sensing operations.

According to implementations, one or more of the NEs 102 and the UEs 104 are operable to implement various aspects of the techniques described with reference to the present disclosure. For example, a device (e.g., a UE 104, an NE 102, a network node) acting as a sensing TX can determine a configuration for a sensing procedure associated with a sensing signal. The sensing signal may have at least a first time period and a third time period that are each associated with a low-power or ZP transmission state, and a second time period that is associated with a high-power or NZP transmission state. The sensing TX determines respective parameters for each of the time periods, including a start time, a duration, a power level, a time-domain sequence, or a combination thereof. The sensing TX generates the sensing signal according to the configuration and the parameters and transmits the sensing signal as part of the sensing procedure.

A device (e.g., a UE 104, an NE 102, a network node) acting as a sensing RX may receive and process the sensing signal during the first, second, and third time periods. In some examples, a same device operates as both the sensing TX and the sensing RX, while in other examples, the sensing TX and the sensing RX are distinct devices. In some cases, the sensing RX receives a configuration for the sensing procedure, parameters for the sensing signal, or both, such as from the sensing TX or from another device (e.g., a configuration entity). The sensing RX may perform one or more sensing measurements on (e.g., using) the sensing signal. In some cases, the sensing RX transmits a report to the sensing TX or another device indicating result(s) of the sensing measurements.

To generate the sensing signal, the sensing TX may determine one or more shaping parameters of a time-domain signal pattern of a sensing signal. The time-domain signal pattern may define target characteristics (e.g., parameters) of the sensing signal subsequent to IFFT processing of frequency domain resources. The target characteristics may be those that support a particular sensing procedure, e.g., by reducing interference from a background channel or based on a delay between a background path and a sensing target path at a sensing RX. In some cases, the sensing TX selects (e.g., determines, calculates) the shaping parameters that will produce a time-domain sensing signal with the target characteristics.

The shaping parameters may be based on data to be multiplexed with the sensing signal. For example, the sensing TX may select a first set of REs (e.g., frequency domain REs) allocated for transmission of data (e.g., data symbols) toward one or more data receivers via dedicated or group/multicast signaling. The sensing TX selects a second set of REs (e.g., frequency domain resources) for shaping the sensing signal into the time-domain signal pattern. Based on values of the first set of REs, the time-domain signal pattern (e.g., the target characteristics), IFFT block dimensions, a location of the second set of REs within an IFFT input, and the like, the sensing TX calculates values to load into the second set of REs. In some examples, the sensing TX additionally selects a third set of REs that are loaded with zero values (e.g., zero REs) and are not used for transmission. The sensing TX generates the sensing signal by performing IFFT processing of the first set of REs and the second set of REs (and, if applicable, the third set of REs). The IFFT processing outputs the shaped time-domain sensing signal to be transmitted by the sensing TX.

Broadly, the techniques described herein provide for configuration of a time-domain pattern of a sensing signal that includes three adjacent periods including a first ZP period, a high-power or NZP period, and a subsequent ZP period. The time-domain shaping pattern may be defined through an index from a codebook that includes supported time-domain patterns jointly incorporating respective energy levels and time durations of the three periods as well as pulse-repetition characteristics. Parameterization of the time-domain pattern is determined based on sensing scenario geometry, including joint delay and energy differences or relationships between target channels and background channels, and/or based on sensing RX reports. In this manner, sensing signal characteristics are adaptively selected or otherwise configured based on the specific propagation environment and interference conditions present in each sensing scenario. The parameters are further determined based on geometric relationships between sensing TXs, receivers, and targets to optimize temporal isolation between desired sensing signals and interfering background signals.

The time-domain pattern of sensing signals including low-power or ZP, and high-power or NZP, transmission periods may be assigned to distinct and adjacent symbols, cyclic prefixes, or guard-bands within a frame structure. For example, the time-domain pattern may be such that the shaped time-domain sensing signal spans a portion of a time-domain symbol (e.g., a sub-symbol), where the remainder of the time-domain symbol is used for data or other reference signal transmission(s). Additionally, or alternatively, the time-domain pattern including one or more of the ZP, high-power or NZP, and ZP transmission periods may be assigned as part of the same NFFT block.

The techniques described herein further establish QCL relationships for time-domain signals observed at partial segments of symbols. A cyclic prefix duration of a symbol or any sub-symbol duration may be associated with a first beam or sensing target or sensing path through a first quasi-co-location relation defined between beams, between a beam and a path, or between a beam and a sensing target, while a set of frequency domain resources carrying data are associated with a second beam that differs from the first beam. Such QCL relationships maintain independent spatial processing of sensing signals and data signals within the same transmission symbol. Additionally, or alternatively, the described techniques support association of multiple beams to different MIMO layers of sensing signals defined in the time-domain at partial symbol time durations. Multiple time-domain sensing signals occupying cyclic prefix durations or locations within a symbol may be beamformed toward different directions or sensing target areas, enabling simultaneous sensing operations toward multiple targets or coverage areas while maintaining spatial separation between different sensing beams.

To ensure cohesive sensing operations among multiple sensing nodes, a sensing TX and/or a configuration entity may indicate time-domain behavior to sensing RXs for sensing measurements or channel state information estimation. Sensing RXs may perform channel state information estimation or demodulation based on time-domain processing of received sensing signals according to known or indicated time-domain pulse patterns.

Additionally, radio node capabilities for computation of time-domain shaping REs are defined herein including computation latency, supported time-domain shaping RE sizes or quantities, and supported time-domain pulse patterns to be generated based on time-domain shaping REs. Radio node capabilities for performing sensing measurements based on time-domain sensing signals are also specified to enable network coordination and resource allocation that considers the processing limitations and capabilities of different sensing nodes.

Shaping of a sensing signal as described herein includes selection (e.g., determination) of time-domain shaping REs for shaping sensing signal patterns within NFFT blocks and determination of time-domain shaping REs based on data and time-domain patterns or shapes. A sensing TX may compute time-domain shaping REs jointly with peak-to-average power ratio reduction and formulation of joint time-domain shaping and peak-to-average power ratio reduction as efficient second-order cone programming computation. The determination or indication by sensing RX nodes of paths belonging to background channels of sensing targets as undesired or strongly interfering paths enables further determination of shaping parameters based on delay differences between background paths and sensing paths of target channels.

In some examples, AGC gains for sensing RX nodes may be configured based on configured time-domain shaping parameters, such as indicated AGC gain increases for the third period of sensing signals. In some examples, a sensing RX node may utilize (e.g., based on receiving an indication/instruction to do so, or based on an autonomous determination) different AGC gains for different reception occasions (e.g., durations) associated with at least one of one or more identified sensing signals; a sensing signal associated with (e.g., based on receiving an indication of such an association) one or more of a target type and/or RCS level, a target area, a sensing signal transmission power, a path (e.g., a previously detected sensing target path reflected from a same target location or area); a period/portion of a sensing signal including a described time-domain shaping pattern, where the AGC gain differs from one period to another period; sensing signal transmissions associated with spatial precoding including zero-forcing of the undesired/interfering paths (e.g., paths previously determined and/or indicated, by the sensing RX node, as undesired paths) such as a LOS path or a strong path belonging to the background channel; or signal transmissions (e.g., sensing signal transmissions) associated with an expected reception power (from the target) of an indicated level/class, e.g., according to a table defining expected RX power levels. In some examples, an indicated expected reception power level is defined relatively (e.g., to a previous reception by the sensing RX node) and/or defined as being associated with the same RX spatial filter/beam used at the sensing RX node. In some such examples, the indicated expected power level to the sensing RX node is determined by the SensMF or the sensing TX node, such as according to an expected RCS level of the target and/or an expected distance/pathloss associated with the sensing TX-target and target-sensing RX links. In some examples, the sensing RX AGC gain is determined at the sensing RX node according to an indicated (e.g., relative or absolute) RX power level.

A sensing signal may include or be an example of one or more reference signals, such as positioning reference signals, DMRSs, CSI reference signals, sounding reference signals, or synchronization signal blocks. A sensing signal may include or be an example a physical random access channel (PRACH) transmission, a physical uplink control channel (PUCCH) signal, or a physical downlink control channel (PDCCH) signal. Additionally, or alternatively, a sensing signal may be implemented as part of uplink transmissions from UE to network entities, downlink transmissions from network entities to UEs, sidelink transmissions between UEs, or transmission and reception point (TRP) to TRP signals for network-to-network sensing scenarios. The sensing signal may include wideband signals that provide enhanced resolution for sensing measurements or narrowband signals that enable efficient resource utilization in specific sensing applications. The sensing signal may be configured as a set of periodic transmissions, one or more aperiodic transmissions (e.g., in response to a sensing trigger or request), or one or more semi-persistent transmissions. The sensing signal may incorporate beamformed transmissions that direct sensing energy toward specific target areas or omnidirectional transmissions that provide broad coverage for target detection across multiple directions.

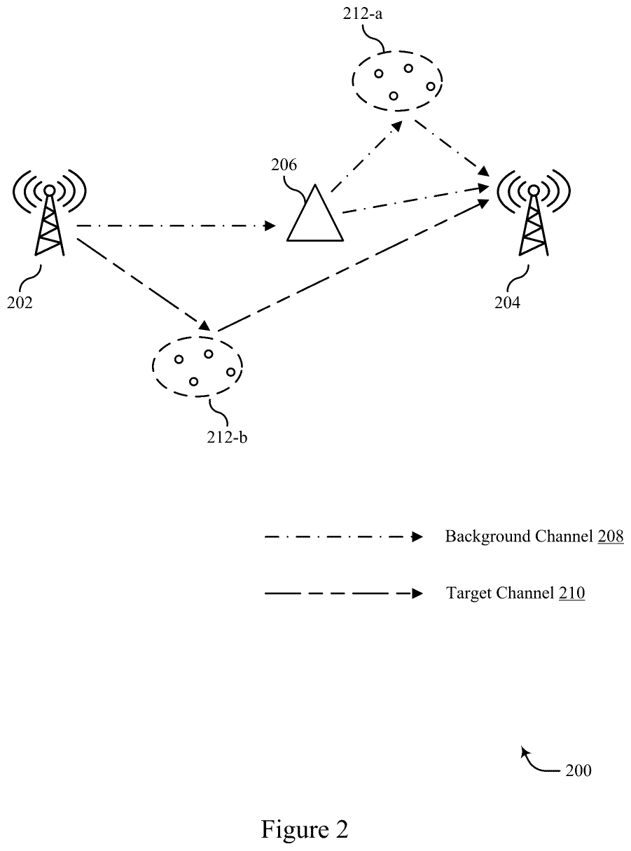

FIG. 2 illustrates an example ISAC channel 200 in accordance with aspects of the present disclosure. In some examples, the ISAC channel 200 implements or is implemented by aspects of the wireless communications system 100. For example, the ISAC channel 200 may be implemented by a sensing TX 202 and a sensing RX 204, each of which may include or be an example of a UE 104 or an NE 102 as described with reference to FIG. 1.

The sensing TX 202 and the sensing RX 204 perform a sensing procedure to sense (e.g., obtain information regarding) an object 206, which may be referred to as a target (e.g., a target object, a sensing target). For example, the sensing TX 202 may transmit a sensing signal that reflects off of the object 206. Reflections of the sensing signal may be received by the sensing RX 204 and, in some cases, the sensing TX 202. The object 206 may include or be an example of one or more vehicles, pedestrians, aircraft, or other physical objects that reflect or scatter wireless signals in ways that provide measurable sensing information.

As illustrated, the ISAC channel 200 combines a background channel 208 and a target channel 210. The background channel 208 may represent signal paths (referred to herein as direct paths, background paths, LoS paths, and the like) between the sensing TX and the sensing RX that are not impacted by the object 206. These background paths may include direct line-of-sight transmissions, ground reflections, and environmental scattering that occur independently of the object 206. The target channel 210 may represent signal paths (referred to herein as sensing paths, target paths, and the like) that are impacted by interactions with the object 206, such as reflections, scattering, or diffraction caused by the physical presence of the object 206. The target channel 210 may carry sensing information that enables determination of target characteristics such as position, velocity, size, and material properties. The background channel 208 may also be considered or understood as environmental clutter.

Signal propagation within the ISAC channel 200 may be influenced by environmental factors that affect both background and target channels. Stochastic clusters 212-a and stochastic clusters 212-b may represent areas of signal scattering or reflection that contribute to multipath propagation effects. The stochastic clusters 212-a and stochastic clusters 212-b may include buildings, terrain features, vegetation, or other environmental elements that cause signal reflections and create multiple propagation paths between transmitter and receiver locations. These clusters may introduce additional complexity to the sensing procedures by creating multiple arrival paths with different delays, angles, and power levels that must be considered in sensing signal processing.

Sensing of the object 206 includes measurement and processing of an impacted/reflected sensing signal by the object 206 and subsequent inference of the physical conditions associated with the object 206, e.g., presence, position, velocity, etc. The sensing RX 204 performs radio measurements, e.g., by detecting and quantifying parameters associated with propagation paths observed at the sensing RX 204. Timing-based measurements may analyze signal delay characteristics to determine target distance and position relative to the transmitting and receiving nodes. Doppler-based measurements may examine frequency shifts in received signals to determine target velocity and direction of movement. Phase-based measurements may utilize carrier phase information to provide precise ranging and positioning capabilities with enhanced accuracy compared to timing-based approaches. Angle-based measurements may determine the azimuth and elevation angles of arrival or departure for signals interacting with the object 206. Energy-based measurements may analyze received signal power levels to determine target radar cross-section and material properties that affect signal reflection characteristics. Micro-doppler measurements may detect small-scale motion patterns or vibrations associated with the object 206, such as rotating components or structural vibrations that create characteristic frequency signatures.

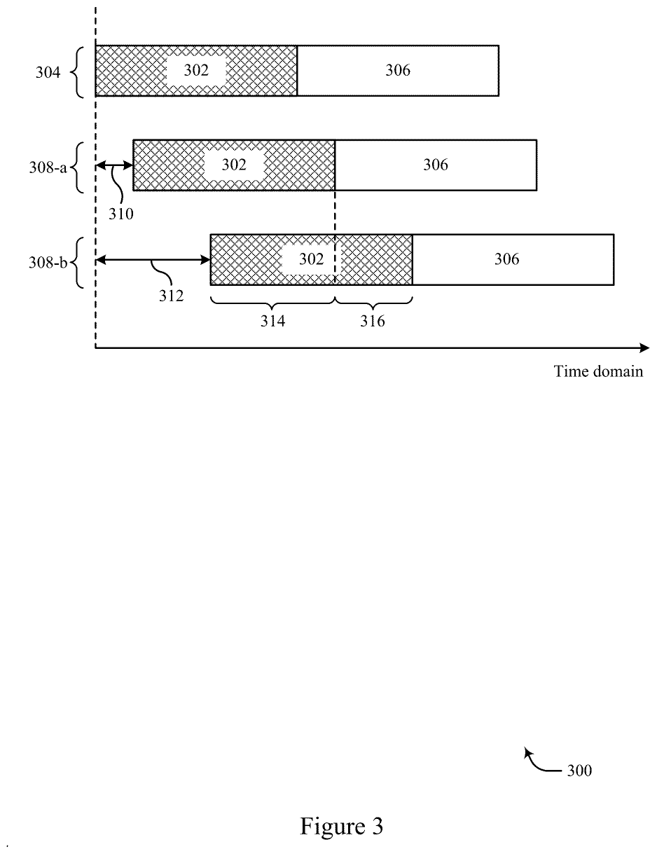

In some cases, and as described with reference to FIG. 3, the sensing RX 204 may receive a first instance of the sensing signal via a direct (e.g., LoS) path between the sensing TX 202 and the sensing RX 204, in which the sensing signal does not reflect off of the object 206, and a second instance of the sensing signal via a target path, in which the sensing signal does reflect off of the object 206. In such cases, because the first instance of the sensing signal lacks interaction with (and thus information regarding) the object 206, the first instance is considered part of the background channel 208.

The propagation characteristics of the background channel 208 and the target channel 210 may create interference challenges that affect sensing measurement accuracy. Even when the sensing signal is received at the sensing RX 204 without interference from external signals, the sensing signal received via the target path(s) associated with a sensing target may be distorted due to the presence of other paths (e.g., the presence of the clutter/background channel 208) interfering with the desired target path. For example, background channel signals may arrive at the sensing RX 204 with significantly higher power levels compared to target channel signals due to shorter propagation distances and reduced path loss. The power imbalance between background and target channels may cause target reflection signals to be masked or overwhelmed by stronger background interference, particularly when both signal types arrive at similar times or occupy similar frequency bands. The stochastic clusters 212-a and stochastic clusters 212-b may further complicate the interference environment by creating additional multipath components that contribute to background channel interference.

The impact of the interfering paths of the background channel 208 and environmental clutter on a sensing procedure is significant when a background path is relatively strong, or when the interfering background path occupies a similar feature space as the target path (e.g., of delay, angle of arrival (AoA), zenith of arrival (ZoA), Doppler, etc.). In such scenarios, conventional signal processing techniques may struggle to differentiate between desired sensing signals and interfering background signals. The dynamic range limitations of receiver hardware may further compound this challenge, as analog-to-digital converters and other receiver components may be unable to simultaneously process both high-power background signals and low-power sensing target reflections with adequate resolution.

Conventional wireless communication systems may employ CP insertion to address some interference challenges related to multipath propagation and inter-symbol interference. The CP may provide a guard interval that allows delayed multipath components to settle before the start of the next symbol, enabling frequency-domain equalization techniques to compensate for channel effects. However, cyclic prefix insertion may not adequately address the power imbalance problem between background and target channels in sensing applications. For example, when target reflection signals are orders of magnitude weaker than background channel signals, the cyclic prefix may not provide sufficient isolation to enable effective sensing target detection and measurement.

In contrast, the techniques described herein provide temporal separation between background and target channel signals. By shaping sensing signals to include alternating time periods having different power levels, the described techniques coordinate sensing signal transmission timing with expected propagation delays to minimize interference between background and target channels. The three-period pulse structure described herein may enable sensing RXs to process target reflection signals during time intervals when background interference is reduced, thereby improving sensing measurement accuracy and enabling effective sensing operations in challenging interference environments where conventional techniques may provide inadequate performance.

FIG. 3 illustrates an example of a timing diagram 300 in accordance with aspects of the present disclosure. In some examples, the timing diagram 300 implements or is implemented by aspects of the wireless communications system 100. For example, the timing diagram 300 illustrates timing of a sensing signal 302 transmitted by a sensing TX and received by a sensing RX, each of which may include or be an example of a UE 104 or an NE 102 as described with reference to FIG. 1.

The timing diagram 300 illustrates an example in which sensing signal transmission and reception are negatively affected by differing propagation delays (e.g., path delays) that create overlapping signal arrivals at a sensing RX. Propagation characteristics of different signal paths may create timing offsets that affect sensing signal reception at sensing RX nodes. Due to different path delays associated with the target path(s) and the background path(s), signals transmitted via background paths (e.g., non-sensing target paths) interfere with reception of a sensing signal via the desired sensing target paths.

Sensing TX timing 304 illustrates timing (e.g., a temporal pattern) of a sensing signal 302 and one or more subsequent signals 306 (e.g., additional transmissions or data signals that occur after the sensing signal 302) transmitted by a sensing TX. Sensing RX timing 308-a illustrates reception timing of signals arriving via background channel paths at a sensing RX, such as direct line-of-sight paths and/or paths that do not interact with sensing targets. In the sensing RX timing 308-a, the sensing signal 302 and the subsequent signal 306 arrive at the sensing RX after a background path delay 310. The background path delay 310 corresponds to the propagation time for signals traveling through the background channel, which may be relatively short compared to sensing target paths (e.g., because sensing target paths travel to the sensing target before being reflected to the sensing RX).

Sensing RX timing 308-b illustrates reception timing of the sensing signal 302 and the subsequent signal 306 arriving at the sensing RX via one or more sensing target paths (e.g., reflection paths) of the target channel, after a sensing path delay 312. The sensing path delay 312 corresponds to the propagation time for signals that travel from the sensing TX to a sensing target, reflect or scatter from the sensing target, and then propagate to the sensing RX. The sensing path delay 312 may be longer than the background path delay 310 due to the additional distance traveled and the time required for signal interaction with the sensing target. The timing (e.g., duration) difference between the sensing path delay 312 and the background path delay 310 may depend on the geometry of the sensing scenario, including the positions of the sensing TX and the sensing RX and the location of the sensing target(s).

The timing differences between background and sensing target paths introduces inter-path interference that degrades sensing measurement performance. For example, inter-path interference 314 may occur when the sensing RX simultaneously receives portions of the sensing signal 302 via both the background path and the sensing target path. The inter-path interference 314 may result from the temporal overlap between the sensing signal 302 arriving via the background channel and the sensing signal 302 arriving via the target channel, which, in turn, results from the difference between the background path delay 310 and the sensing path delay 312. Additionally, if background channel signals are associated with relatively higher power (e.g., energy) than target channel signals, which can occur with direct line-of-sight paths compared to target reflections, the sensing RX may be unable to accurately process the target channel signals due to the inter-path interference 314. A higher-power (e.g., stronger) background channel signal may overwhelm a weaker target channel signal, making sensing target detection and measurement difficult or impossible at the sensing RX.

Inter-path interference 316 may occur when the sensing RX simultaneously receives the sensing signal 302 via a sensing target path and the subsequent signal 306 via a background path. The inter-path interference 316 may result from the temporal overlap between target reflection signals and background channel signals (e.g., from different transmission events, such as associated with the subsequent signal 306 or other signals). The sensing path delay 312 may cause target reflections of the sensing signal 302 to arrive at the sensing RX at approximately the same time as background channel signals (e.g., the subsequent signal 306). Thus, the sensing RX may not be capable of distinguishing between desired target reflection signals and interfering background signals from unassociated transmission events. The inter-path interference 316 may compound the challenges of sensing target detection by introducing additional interference sources that mask or distort the target reflection signals.

The conventional sensing approach illustrated in FIG. 3 may demonstrate how interference conditions may prevent sensing RXs from accurately processing target reflection signals due to the presence of stronger background channel signals that arrive simultaneously or nearly simultaneously with the desired sensing signals. The dynamic range limitations of sensing RX hardware may further exacerbate these interference problems by preventing adequate resolution of weak target signals in the presence of strong background interference. Conventional interference mitigation techniques may provide insufficient isolation between background and target channels when power imbalances are severe and/or timing overlaps are extensive.

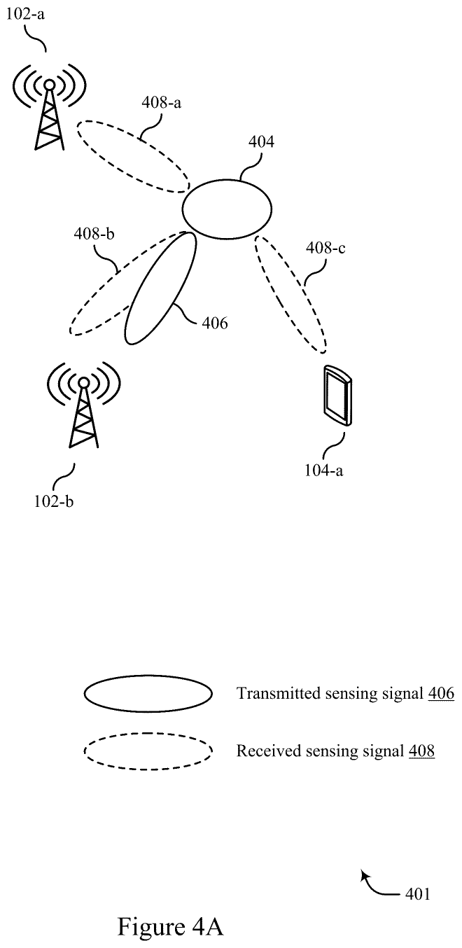

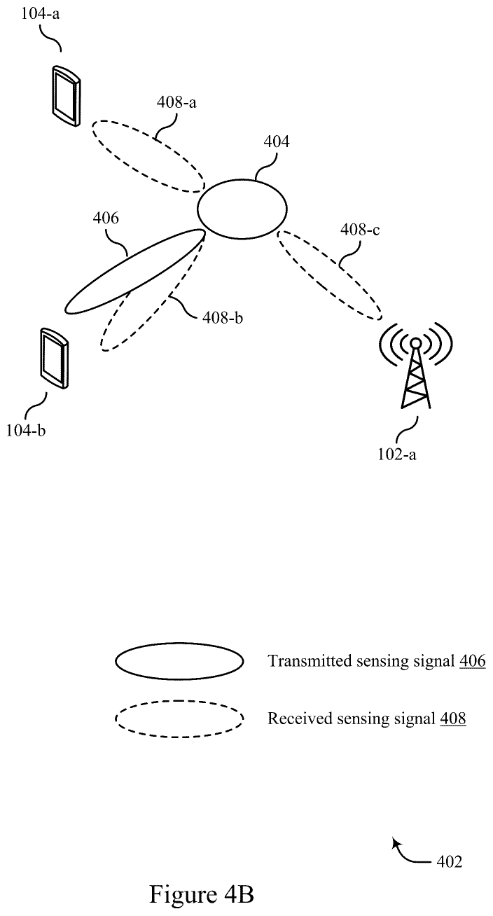

FIGS. 4A and 4B illustrate examples of sensing procedure configurations 401 and 402, respectively, in accordance with aspects of the present disclosure. In some examples, the sensing procedure configurations 401 and 402 implement or are implemented by aspects of the wireless communications system 100. For example, the sensing procedure configurations 401 and 402 include one or more NEs 102 and UEs 104, which may be examples of the corresponding devices as described with reference to FIG. 1.

ISAC scenarios may include multi-node sensing procedure configurations that enable flexible deployment of sensing operations across different network topologies. The sensing procedure configurations may involve coordination between multiple sensing nodes, such as NEs 102, UEs 104, and/or other network nodes, to perform sensing measurements while maintaining communication services. A sensing procedure may be network-based (e.g., controlled and/or initiated by one or more NEs 102 or other network nodes) or UE-based (e.g., controlled and/or initiated by one or more UEs 104). A network may configure participating sensing nodes (e.g., sensing entities) to act as sensing TX nodes and/or sensing RX nodes. The network may additionally or alternatively configure sensing signals and necessary measurements and reporting procedures for the sensing nodes. In this regard, the functional split between network sensing nodes (e.g., NEs 102 and other network nodes acting as sensing nodes) and UE nodes for a particular sensing task may take various forms, depending on the availability of sensing-capable devices and the requirements of the particular sensing task. A “sensing task” may include or be an example of detecting the presence (or lack thereof) of a pedestrian in a road.

FIG. 4A illustrates the sensing procedure configuration 401 in which a network node acts as a sensing TX and another network node and/or a UE acts as a sensing RX to sense a target 404. The target 404 may be present within the environment, representing an object or target of interest that reflects or scatters wireless signals to provide sensing information about target characteristics such as position, velocity, and physical properties.

In a first example, the NE 102-b acts as a sensing TX that generates and transmits sensing signals toward the target 404 within the coverage area. For example, a transmitted sensing signal 406 may propagate from the NE 102-b toward the target 404, where the transmitted sensing signal 406 may reflect or scatter to create sensing target reflections that carry information about target characteristics. The sensing signal may include or be an example of a sensing reference signal or another reference signal used for sensing or data/control channels known to the network. The NE 102-a may serve as a sensing RX that detects and processes received sensing target reflections (e.g., sensing signals reflected off the target 404), such as a received sensing signal 408-a, to generate sensing measurements. In such examples, involvement of UEs, such as the UE 104-a, may be limited to aspects of interference management, and the network (e.g., the NE 102-b) may not utilize UEs for sensing assistance.

In a second example, the NE 102-b acts as both a sensing TX and a sensing RX. Here, the transmitted sensing signal 406 transmitted by the NE 102-b is also received by the NE 102-b after reflection off the target 404, e.g., as the received sensing signal 408-b. The NE 102-b detects and processes the received sensing signal 408-b to generate the sensing measurements. The NE 102-b may not utilize UEs, such as the UE 104-a, for sensing assistance in this scenario.

In a third example of the NE 102-b acting as a sensing TX, the UE 104-a (e.g., and any quantity of other UEs) is configured (e.g., by the NE 102-b or other network node, such as a configuration entity) to act as a sensing RX. The UE 104-a detects and processes a received sensing signal 408-c after reflection off the target 404. Configuration of the UE 104-a may be based on the UE 104-a's capabilities for sensing and any requirements of the particular sensing task.

FIG. 4B illustrates the sensing procedure configuration 402 in which a UE acts as a sensing TX and another network node and/or a UE acts as a sensing RX to sense the target 404. The network (e.g., an NE 102 or another network node, such as a configuration entity) configures the UE 104-b according to the UE 104-b's capabilities and requirements of the sensing task. In a first example, the transmitted sensing signal 406 is transmitted by the UE 104-b and the received sensing signal 408 is received by a network node, such as the NE 102-a, for processing and measurements. In a second example, a separate UE, such as the UE 104-a, is configured by the network to act as the sensing RX. Here, the network and/or a UE (e.g., the UE 104-a or the UE 104-b) may configure the UE 104-a and the UE 104-b for the sensing procedure. For instance, the network may configure the UE 104-b to act as the sensing TX and may configure the UE 104-a to act as the sensing RX, e.g., based on respective capabilities and on any requirements of the sensing task.

In a third example, the UE 104-b acts as both the sensing TX and the sensing RX. The transmitted sensing signal 406 propagates from the UE 104-b to the target 404 and reflects back as the received sensing signal 408-b at the UE 104-b. The network or the UE 104-b itself may configure the UE 104-b for the sensing task.

The above scenarios are not intended to be restricted to a specific UE type, and may include any UE category and/or functionality (e.g., a UE road-side unit (RSU)). In any of the above scenarios, any of the roles depicted for the NE(s) 102 and/or the UE(s) 104 may be replaced (e.g., with equal validity as an example of a radio sensing scenario) with a smart repeater node, an IAB node, an RSU, or the like, among other examples. Additionally, in scenarios where the sensing signal includes a physical channel or physical signal (e.g., a physical data channel, a physical control channel, a DMRS or other reference signal(s) associated with the physical channel or physical signal), the sensing TX and/or the sensing RX may also act as a data transmitter or data receiver, respectively, over the same or a different signal as the sensing signal.

In accordance with the techniques described herein, one or more devices in a wireless communications system may perform a sensing procedure that utilizes a shaped time-domain sensing signal in accordance with the techniques described herein. The sensing procedure may be performed according to a sensing configuration, where the sensing configuration includes at least one of a sensing target area, a sensing target type, a sensing TX (e.g., a sensing TX device type, a sensing TX location, capabilities of a sensing TX), a sensing RX (e.g., a sensing RX device type, a sensing RX location, capabilities of a sensing RX), or a sensing configuration entity. For example, the sensing configuration may include positions/locations of the sensing TX, the sensing target, and/or the sensing RX as illustrated in FIGS. 4A and 4B.

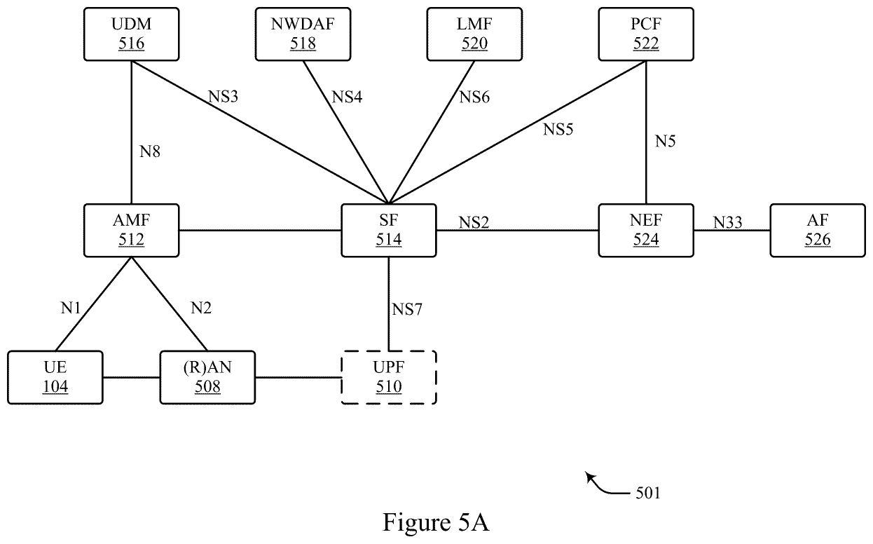

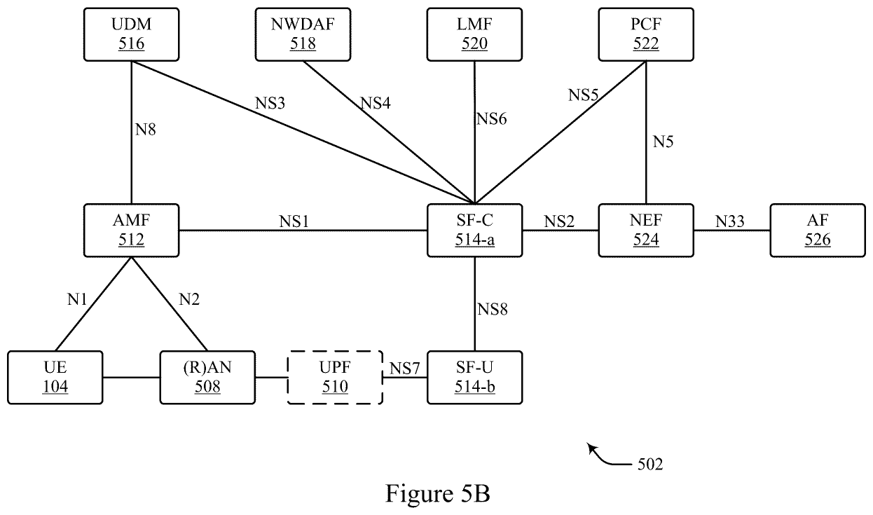

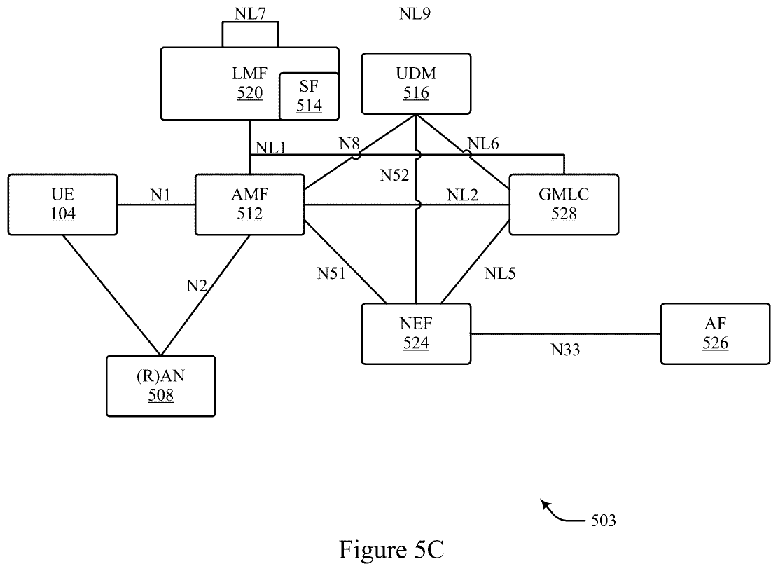

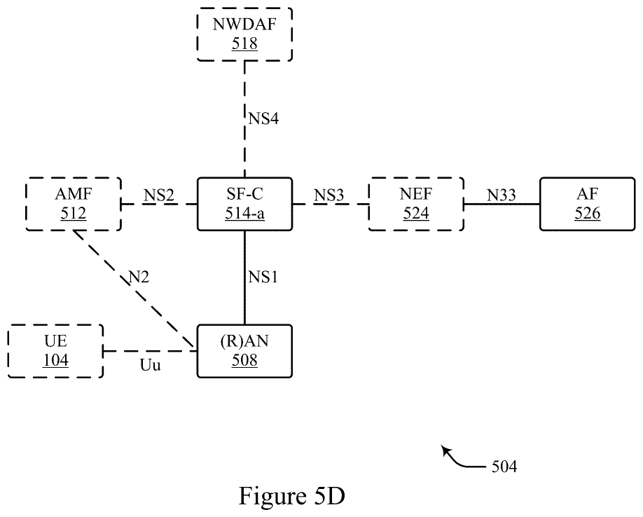

A “sensing node” refers to any device or node participating in the sensing procedure, such as a sensing TX, sensing RX, or sensing configuration entity. The sensing configuration entity may also be referred to as a controller entity (e.g., a sensing controller entity) and may be defined as a device or entity that controls or otherwise determines (e.g., calculates, selects, identifies) at least a subset of parameters and configuration aspects for the sensing procedure. The sensing configuration entity can include or be an example of a network sensing function (e.g., as described with reference to FIGS. 5A through 5D), a network node (e.g., an NE 102 or other network node), and/or a UE. In some cases, the sensing configuration entity also participates in the sensing procedure. For instance, the sensing configuration entity may also act as a sensing TX and/or a sensing RX. In other cases, the sensing configuration entity configures, but does not participate in, the sensing procedure.

The techniques described herein provide for configuration and shaping (e.g., generation) of a time-domain sensing signal according to a time-domain pattern (e.g., a desired/target shaped time-domain sensing signal having a set of target characteristics), such that the time-domain sensing signal includes three adjacent periods including a first ZP period, a high-power or NZP period, and a subsequent (e.g., third) ZP period. In some cases, each period of the time-domain sensing signal is associated with a respective one or more parameters (e.g., sensing signal parameters, shaping parameters), which may differ for each period. Parameters of the time-domain sensing signal and/or the time-domain signal pattern such as shaping parameters (e.g., parameters associated with generation of the sensing signal) and sensing signal parameters (e.g., parameters associated with the sensing signal itself) may be determined, selected, calculated, etc. by one or more of the sensing TX, the sensing RX, and/or the sensing configuration entity.

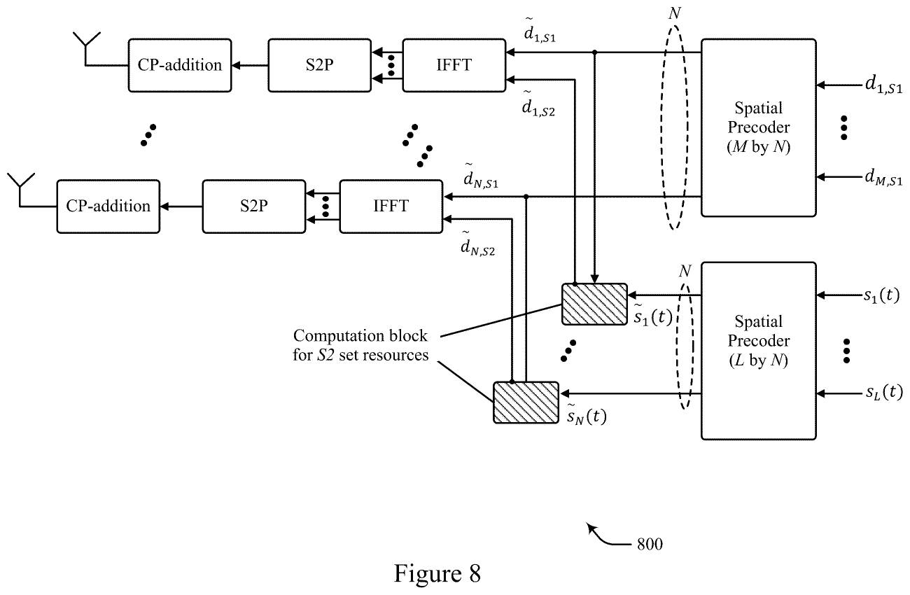

The parameters may be known to both the sensing TX and the sensing RX. When a sensing signal is multiplexed with data, as described with reference to FIGS. 8-11, the sensing TX also acts as a data transmitter. Time-domain parameters may include a time-domain location of the sensing signal, a length (e.g., total time duration) of the sensing signal, and/or a guard band (e.g., adjacent zeros to separate data samples if used). Shaping parameters may also be in the time-domain, such as a modulation scheme, code rate, sequence root, and sequence type (e.g., Zadoff-Chu, Chirp). These time-domain parameters may be utilized by both the sensing TX and the sensing RX to ensure accurate reception and processing. Frequency-domain parameters may be optional in some cases, and may include a frequency domain location and length (e.g., quantity) of REs used to generate the time-domain sensing signal at the desired time-domain location.

In some cases, the sensing configuration entity transmits, conveys, or otherwise indicates the sensing configuration and/or associated parameters (e.g., shaping parameters, sensing signal parameters, etc.) to the sensing TX and/or the sensing RX. In some examples, the sensing configuration entity communicates the sensing configuration and/or parameters to the sensing TX, which forwards them to the sensing RX. Additionally, or alternatively, the sensing RX and/or the sensing TX may determine the sensing configuration and/or one or more parameters (e.g., shaping parameters, sensing signal parameters, etc.). Additionally, or alternatively, the sensing node that determines the sensing configuration and/or one or more parameters may communicate them to one or more other devices, such as other sensing nodes or other devices (e.g., data RX devices). In some examples, the sensing configuration and/or parameters may be indicated to one or more data RX devices that are to receive the sensing signal multiplexed with data, where the data RX devices extract the multiplexed data from the sensing signal but do not perform or participate in the sensing procedure.

Any combination of the above may be implemented, and the examples described herein should not be construed as limiting. For example, a sensing RX may determine one or more parameters (e.g., preferred or recommended parameters) for the sensing procedure and may indicate them to the sensing TX. The sensing TX may consider the recommended parameters when selecting parameters for the sensing procedure and, in some cases, may utilize the recommended parameters for the sensing procedure. As another example, one or more sensing nodes (e.g., the sensing TX, the sensing RX, the configuration entity, etc.) may select or otherwise determine a subset of the parameters and may communicate the subset to other sensing nodes. The sensing nodes can communicate parameter and configuration information with one another and/or adjust the parameters and configuration for one or more sensing procedures.

In some examples, the time-domain shaping parameters and beam information, such as spatial precoding associated with the shaped time-domain signal within a specified time window, may be indicated to receivers other than the sensing RX, such as data sensing RXs expected to demodulate data at the non-time-domain shaping REs. Data sensing RXs may use knowledge of the time-domain signal shape for CSI estimation, determining line-of-sight or non-line-of-sight status, and the like, among other examples. From the data sensing RX perspective, time-domain shaping REs may be indicated, known, or introduced as reserved REs whose transmission is not intended to be received by the data sensing RX, and their use for time-domain shaping may or may not be indicated to the data sensing RX. The data sensing RX may instead be configured for data REs including location and length information. As such, the data sensing RX may implicitly determine which REs are used for sensing signal generation, e.g., based on the indication. Additionally, or alternatively, frequency domain parameters may or may not be indicated to data sensing RXs. Frequency domain parameters may indicate to data receivers which REs are not used for data transmission (e.g., may indicate or otherwise identify the location and presence of time-domain shaping REs). The data sensing RXs may perform rate matching around the indicated time-domain shaping REs.

In some cases, a time-domain signal defined as a portion of a time-domain symbol, such as a transmitted time-domain sensing signal within the time window, may be QCL-ed (type D) with a second signal defined in the frequency domain, such as frequency domain REs of the second signal that are precoded or beamformed according to a same spatial pattern or beam used for the portion of the symbol within the time window. In such cases, the QCL relationship may be indicated to the sensing TX, the sensing RX, and/or the data receiver(s).

Based on the time-domain parameters and the frequency-domain parameters, the sensing TX determines a set of time-domain shaping REs to be used in generating/shaping the sensing signal. For instance, the sensing TX may solve an optimization algorithm (e.g., as described with reference to FIGS. 8-11) and may calculate weights for the frequency domain parameters. The TX node applies these weights to the frequency domain parameters and maps them to the subcarrier locations for which the optimization algorithm was solved. The weights generate the sensing signal at the desired location in the time-domain, while the sensing signal in the frequency domain is generated by applying FFT processing (e.g., or other known linear transformation matrices) to the time-domain sensing signal. The IFFT output produces the shaped sensing signal having signal characteristics at time-domain locations corresponding to the time-domain signal pattern, while the remaining samples contain data (if data is multiplexed with the sensing signal).

At the receiving side, the sensing RX (and the data RX node, if configured/indicated) knows the location and time-domain properties of the time-domain sensing signal and considers samples at the configured time-domain location as the sensing signal. The sensing RX can generate one or more measurements based on the received sensing signal, such as correlating with the known sequence to calculate a delay and angle of arrival (AoA). In parallel, the sensing RX can apply FFT processing to the entire received signal and, in the frequency domain, use the REs other than the time-domain shaping REs to decode the multiplexed data. The procedure for data processing remains similar to legacy CP-OFDM without additional constraints. At the data RX node, the data portion of the sensing signal is mapped to the respective data-containing REs without additional signal processing, so data remains unaffected by this procedure. The data RX node may or may not be aware of the location and purpose of the time-domain shaping REs.

In some examples, the respective parameters of the first, second, and third periods of the sensing signal, such as a respective duration or respective power, may be determined based on identification of an undesired path. An undesired path may be identified (e.g., by the sensing TX, the sensing RX, and/or the configuration entity) as a path belonging to the background channel of a sensing target and that does not contain sensing information associated with the sensing target. The undesired path may additionally or alternatively cause strong signal interference with the sensing signal received via a sensing target path. An example of an undesired path may include a line-of-sight path between a sensing or data TX and a sensing RX that creates strong interference. In some cases, the undesired path may be identified at the sensing RX based on transmission of an initial signal from the sensing TX. For instance, path parameters, such as a delay or a delay difference between the undesired path and a sensing target path, may be determined at the sensing RX and reported to a sensing management function or the sensing TX. Subsequently, parameters for shaping the sensing signal, such as a duration of the second period, may be determined based on the obtained parameters associated with the undesired path.

After identifying the undesired path based on reception of the initial signal, in some cases, the sensing RX may transmit a second signal that is received by the sensing TX to better understand the background channel of a sensing target. The parameters associated with reception of the undesired path may be determined at the sensing TX, including an AoA or a ZoA of the undesired path, based on the received second signal from the sensing RX. Additionally, or alternatively, the sensing RX may transmit, to the sensing TX, a report indicating one or more parameters associated with the undesired path, such as the order of the undesired path in delay, relative delay, path absolute or relative Doppler shift. After determining the undesired path, the sensing TX may adjust one or more sensing signal shaping parameters, e.g., based on the determined parameters of the undesired path. Additionally, or alternatively, the sensing TX may perform spatial zero-forcing in the direction of the undesired path based on the AoA or a ZoA of the received path according to the report from the sensing RX and/or a reception/measurement of the second signal at the sensing TX node (e.g., the sensing TX node receives the second signal, detects incoming paths based on the reception, identifies the “undesired” path(s) reported by the sensing RX node as an undesired path(s), for instance based on the sensing RX indicating the undesired path as a second path ordered according to a delay or doppler shift). In some cases, the spatial zero-forcing procedure may be performed based on reception of a signal from the sensing RX (e.g., without relying on prior information or reports from the sensing RX), where the sensing TX determines the AoA and/or a ZoA for zero-forcing based on reception of the signal transmitted by the sensing RX and identification of a path with a line-of-sight or otherwise strongly-interfering condition for the target channel associated with the sensing target.

In some examples, when data is multiplexed with the sensing signal, the sensing TX may indicate to the sensing RX whether the same or different time and frequency domain precoders are used for data and the sensing signals. When the data and the sensing signal use the same precoder in the frequency domain, the sensing signal may be used (e.g., by the sensing RX and/or one or more data receivers) as a DMRS for channel estimation. In such cases, the sensing RX and/or one or more data receivers may determine whether to use the sensing signal as the DMRs.

In some examples, the beam or spatial transmission pattern of the sensing signal associated with a time-domain shaping pattern, such as a sensing signal shaped within a guard interval or within a partial duration within a time-domain symbol, may be indicated to a data sensing RX via a QCL relation. This QCL relation may be defined between a signal defined in the time-domain and a set of frequency domain resources associated with data-containing REs or DMRS-containing REs of a physical channel (e.g., a physical data channel, a physical control channel) transmitted over the frequency domain resources. For a given symbol, the first set of frequency resources may be associated with a first spatial pattern or beam or transmission direction, and a sub-symbol time-duration of the same symbol, such as the cyclic prefix duration or the segment of the outcome of the IFFT block corresponding to the specified time period, may be associated with a second beam that is QCL-ed with a second beam associated with a sensing target. Thus, for the same symbol period with data-containing REs towards a data sensing RX and associated with a MIMO layer, and a time-domain pulse-shaped sensing signal at the cyclic prefix periods of the symbol, separate or different beamforming or precoding may be utilized.

In some cases, when a sensing signal with a defined time-domain shaping pattern including first, second, and third periods is indicated, a sensing RX may be configured to use different AGC states, such as different AGC scaling factors, for each of the first, second, and third periods. A sensing RX may apply a different scaling factor with higher gain or larger amplification when receiving the sensing signal during the third period.

In some examples, shaping parameters may be determined by the sensing configuration entity, e.g., at least partially based on the reported capabilities of the sensing TX for computing time-domain shaping REs. These capability parameters may include computation latency, supported time-domain shaping RE size or quantity, supported time-domain pulse or pattern types that can be generated, and maximum duration of the time-domain shaping pattern expressed as either an absolute value or relative to the symbol duration.

The sensing signal transmitted by the sensing TX and received by the sensing RX may be one or more of various reference signals and/or reference signal types. A sensing signal may be a reference signal which is specific to a sensing operation and one or more of the uplink, downlink, sidelink, or TRP-to-TRP transmission directions, or for joint transmission and reception, or a combination thereof. Examples of a downlink sensing signal may include synchronization signal (SS)/physical broadcast channel (PBCH) block, a synchronization reference signal, CSI reference signal, downlink positioning reference signal (PRS), tracking reference signal (TRS), phase tracking reference signal (PT-RS), DMRS (e.g., for PDCCH and/or PDSCH), PDDCH, PDSCH, PBCH, and/or any of the downlink reference signals or downlink physical data or control channels defined within a communication system (e.g., 5G, 6G), or a new downlink sensing reference signal.

Examples of an uplink sensing signal may include MIMO (MIMO) sounding reference signal, sounding reference signal (SRS) for positioning, SRS for sensing, any of the uplink reference signals or uplink physical data or control channels defined within the communication system (e.g., 5G, 6G), or a new uplink sensing reference signal. Examples of UE-to-UE (e.g., sidelink) signals may include sidelink PRS, sidelink CSI, physical sidelink shared channel (PSSCH) DMRS, physical sidelink control channel (PSCCH) DMRS, any of the sidelink reference signals or sidelink physical data or control channels defined within the communication system (e.g., 5G, 6G), or a new sidelink sensing reference signal.

NE-to-NE or TRP-to-TRP sensing signals may include downlink sensing signals, uplink sensing signals, or remote interference management (RIM) signals, including legacy NR RIM signals or enhanced RIM signals for sensing. For instance, the sensing signal may be a reference signal transmitted by a TRP and received by another TRP. In such cases, the sensing signal may hold properties associated with transmission by a TRP (or radio point or array segment of a TRP) and reception by a TRP (or radio point or array segment of a TRP).

Exchanges of sensing procedure information (e.g., sensing procedure configuration(s) and/or associated parameters, such as sensing signal parameters, shaping parameters, and the like) may occur via the uplink, downlink, or sidelink physical data and control channels defined within the communication network, such as any 5G/6G physical channel, PBCH, PDSCH, PDCCH, PUSCH, PUCCH, PSBCH, PSCCH, PSSCH, or through higher layer signaling (e.g., media access control (MAC) control elements (MAC-CEs) or radio resource control (RRC) signaling).

Additionally, or alternatively, the information exchanges may occur via a defined or logical interface between a configuration entity, such as a sensing management function (SensMF) as described with reference to FIGS. 5A-5D, and one or more sensing nodes, such as part of a location protocol plus (LPP), or as a message framework for sensing, or as an interface defined for sensing message exchanges over the N1 interface (e.g., between the SensMF and a UE acting as a sensing TX or sensing RX). As another example, when the sensing TX or sensing RX is an NE, the information exchanges may occur through a defined interface between the SensMF and the NE as part of an NR positioning protocol A (NRPPa) or a modified or enhanced NRPPa framework for sensing, or as an interface defined over the next generation application protocol interface (NGAP). When the SensMF is a serving NE of a sensing task or a sensing management component residing in the RAN and the sensing node is a UE or an NE of the RAN, such information exchange may utilize, at least partially, the X2/Xn interface between the serving NE and the sensing node. As another example, the exchanges may occur via an interface which is defined between TRPs and not necessarily specified within network standard operations, such as data or messages exchanged via the application layer of a device and via an over-the-top (OTT) application connection.

FIGS. 5A through 5D illustrate examples of sensing network architectures 501 through 504, respectively, in accordance with aspects of the present disclosure. In some examples, the sensing network architectures 501 through 504 implement or are implemented by aspects of the wireless communications system 100. For example, the sensing network architectures 501 through 504 illustrate network functions and devices connected via network interfaces and signaling protocols as described with reference to FIG. 1. ISAC systems may enhance 5G core architecture by introducing a sensing function (SF) as shown in the sensing network architectures 501 through 504 to support sensing operations while maintaining communication services across wireless networks.

With reference to FIG. 5A, the sensing network architecture 501 illustrates a tight coupling ISAC network architecture, which may provide comprehensive integration between sensing functions and core network components through dedicated network interfaces and signaling protocols. The sensing network architecture 501 may include an access node, such as a RAN 508, that connects to the UE 104 through a first network interface N1 to provide wireless access services and coordinate sensing operations between network elements and UE. A user plane function (UPF) 510 may handle data traffic routing and processing for both communication and sensing data flows. An access mobility function (AMF) 512 may coordinate mobility management and access control procedures for UEs participating in sensing operations. The AMF 512 may connect to the RAN 508 through a second network interface N2 to manage UE registration, authentication, and mobility procedures that affect sensing operation continuity. The AMF 512 may also connect to the UE 104 through the first network interface N1 to provide direct signaling capabilities for sensing configuration and measurement reporting procedures. The AMF 512 may further interface with a unified data management (UDM) 516 to enable access to UE capability information, subscription data, and sensing service authorization parameters that influence sensing operation configuration and execution.

In the tight coupling ISAC network architecture, a sensing function (SF) 514 may serve as a dedicated network function that handles both sensing control plane aspects and sensing radio signal processing for analysis and prediction operations that determine sensing target characteristics and environmental conditions. The sensing function 514 may connect to other network functions through sensing interfaces (e.g., NS3, NS4, etc.) to enable coordination of sensing operations and information exchange across the sensing network architecture 501. For example, the SF 514 may gather UE information from the AMF 512, the UDM 516, a network data analytics function (NWDAF) 518, a location management function (LMF) 520, and a policy control function (PCF) 522. For example, via the AMF 512, the UDM 516, and the LMF 520, the SF 514 may access UE location information, UE capability information, sensing service subscriptions, and authentication data that influence sensing operation configuration. The SF 514 may access UE-related policies from the PCF 522 and analytics from the NWDAF 518.

A network exposure function (NEF) 524 may provide external interface capabilities that enable the SF 514 to interact with sensing consumers, such as third-party applications and services, to access sensing information, configure sensing operations, and enable sensing service exposure and external sensing operation requests. Additionally, an application function (AF) 526 may connect to the NEF 524 to enable sensing applications to request sensing services, configure sensing parameters, and receive sensing measurement results.

With reference to FIG. 5B, the sensing network architecture 502 illustrates a tight coupling ISAC network architecture with control plane (CP) and user plane (UP) split, which may provide enhanced scalability and performance optimization for sensing operations through functional separation of control and data processing responsibilities. In this example, the sensing function has two dedicated network function counterparts: an SF control node (SF-C) 514-a and a sensing function user node (SF-U) 514-b. The SF-C 514-a may handle sensing control plane aspects including sensing operation configuration, measurement coordination, and interaction with other network functions through dedicated sensing interfaces, e.g., as described with reference to FIG. 5A. The SF-U 514-b may handle sensing radio signal collection and processing through user plane channels (e.g., via the RAN 508 and the UPF 510). The sensing network architecture 502 enables offloading of high-volume sensing data flows to the user plane to ensure light traffic in the control plane. For example, the SF-U 514-b may connect to the UPF 510 to enable sensing data collection and processing through user plane channels that provide high-bandwidth data transport capabilities for sensing measurements and signal processing results. The SF-C 514-a may configure sensing operation parameters and measurement procedures, while the SF-U 514-b may report sensing measurement results and processing status information to support sensing operation management and optimization.

With reference to FIG. 5C, the sensing network architecture 503 illustrates an architecture in which the SF 514 is embedded in the LMF 520. The sensing network architecture 504 further includes a gateway mobile location center (GMLC) 528. By collocating the SF 514 with the LMF 520, the SF 514 may perform and manage sensing operations while taking advantage of knowledge of UE locations, e.g., via the LMF 520.

With reference to FIG. 5D, the sensing network architecture 504 illustrates a loose coupling ISAC network architecture in which the SF 514 is independent of the 5G core. This architecture may support sensing capabilities that operate independently of core network functions while maintaining selective integration with network services through minimal interface connections. Here, sensing operations via the SF 514 may be deployed close to the RAN 508, e.g., such that collection and processing of sensing radio signals is performed locally. The SF 514 may interact with the 5G core for the purpose of exposure via the NEF 524, for obtaining UE locations from the AMF 512, and for analytics via the NWDAF 518. The loose coupling architecture may enable sensing operations to be deployed in private networks, local area networks, or edge computing environments where full core network integration may not be available or desired.

In another example of controlling a sensing operation, a sensing controller entity or function, referred to herein as SensMF, may be defined to control sensing operations within a network architecture. The SensMF may include one or multiple components including a UE, a RAN node, an NE (e.g., a gNB/gNB-CU, a gNB/DU), an LMF, an SF, or a combination thereof, which each may be examples of corresponding devices as described herein. The SensMF may perform one or more functions including, but not limited to, receiving requests for sensing information from service consumers such as requesting third party applications; determining selection and configuration of sensing operations including configuration of sensing TX nodes and sensing RX nodes; selecting and configuring involved nodes for sensing transmission and sensing reception and sensing measurement and reporting of conducted measurements; collecting sensing measurements; performing or configuring or requesting computation of sensing measurements to determine required sensing information based on obtained sensing measurements; and reporting or exposing obtained sensing information to entities requesting the sensing information.

When the SensMF includes multiple nodes or entities, different parts of the sensing control functions may be distributed among the constituent components. For example, a first portion of sensing control steps may be implemented by a first part of the SensMF while a second portion of sensing control steps may be implemented by a second part of the SensMF, such as implementation distributed between an SF and an NE. Communication among SensMF entities may be transparent to outside entities, with communication among SensMF entities assumed to be implicit to the overall sensing procedure. In implementations where the SensMF includes an SF and an NE, such as a serving NE of a UE related to the sensing task or a selected serving NE for a sensing task, the SF may perform functions including receiving sensing requests, reporting sensing information, computing sensing measurements, and collecting sensing measurements, while the NE may perform configuration and selection functions for sensing nodes.

The distribution of sensing control functions may vary across different implementations. As another example, configuration determination and sensing measurement collection may be jointly performed by the SF and the selected serving NE, where a first part of configuration determination is performed by the SF and a second part is performed by the selected serving NE. The SF may support the serving NE with recommendations while the serving NE decides and configures involved nodes, or alternatively the serving NE may support the SF with recommendations while the SF decides among possible configurations. The SensMF may be implemented as a RAN node such as a selected NE acting as serving NE of a sensing task, as a sensing function residing in the core network, as a UE, or as a combination of these components.

The sensing network architectures 501 through 504 described in FIGS. 5A through 5D provide a foundational infrastructure for implementing ISAC operations across various deployment scenarios. These architectures enable coordination between network functions and UEs to support sensing measurements while maintaining communication services according to the techniques described herein. For example, the SF 514 and/or the SensMF may implement the described techniques in sensing procedures performed by one or more NEs and/or UEs. For example, to ensure isolation of sensing signals from interfering paths, a sensing TX may perform time-domain shaping of a sensing signal such that a time window or period of a NZP portion of the sensing signal is followed and/or preceded by a ZP or reduced-power period or time window, generating a pulse-shaped (e.g., rectangular) signal in the time-domain.

The sensing TX (e.g., and/or a separate node acting as a configuration entity (e.g., the SF 514, the SensMF, an NE, a UE)) may determine shaping parameters and/or sensing signal parameters for shaping the sensing signal according to (e.g., based on) a sensing procedure configuration. For example, the sensing TX may determine a time-domain shaping pattern that represents a desired shape (e.g., in the time-domain) of the sensing signal subsequent to IFFT processing. The desired shape may be one that provides temporal isolation between the sensing signal (e.g., between paths associated with a target channel, a sensing target, or a potential target area) and background path signals and/or environmental clutter. The time-domain shaping pattern defines consecutive portions of the sensing signal including at least a first time period associated with a ZP or reduced-power transmission state (e.g., energy level), a second time period associated with a NZP or high-power transmission state, and a third time period associated with a ZP or reduced-power transmission state (which may be the same as or different from that defined for the first period).

To perform shaping of the sensing signal in order to obtain the desired (e.g., target, selected) time-domain shaping pattern, the sensing TX (or configuration entity) determines shaping parameters and/or sensing signal parameters. Sensing signal parameters include, but are not limited to, respective time-domain positions, durations, and energy levels of the three periods. The shaping parameters, including the target time-domain shaping pattern, are determined based on the sensing procedure configuration, such as based on scenario geometry including sensing TX positions, sensing RX positions, and expected or potential target areas, as well as receiver dynamic range or processing capability. Parameter determination utilizes a priori known geometrical information or exchanging of measurement reports among nodes participating in the sensing. In some examples, the parameters can be adjusted after determination. The parameters are determined to establish sufficiently small non-zero or low-energy period durations and sufficiently large energy level differences between NZP and zero- or low-power periods such that reception of interfering paths associated with relatively high power levels ends prior to reception of paths from sensing targets.

The sensing TX may multiplex the shaped sensing signal with other reference signals and/or data. For example, the shaped sensing signal and the NZP and/or ZP periods may be assigned to different or distinct NFFT blocks, symbols, cyclic prefixes, or guard-intervals according to frame structures assumed by the sensing TX and/or the sensing RX. The shaped sensing signal and the NZP and/or ZP periods may be multiplexed with other or co-existing signals within an NFFT block during a same symbol duration. This multiplexing may be accomplished by assigning a set of REs (e.g., frequency domain resources) at the pre-IFFT stage as “time-domain shaping REs” (e.g., frequency domain resources that do not carry data and are solely used to shape the sensing signal in the time-domain) and adjusting values associated with the time-domain shaping REs to produce a sensing signal having the target time-domain shaping pattern (e.g., having values, shapes, and/or behavior corresponding to the time-domain shaping pattern) at the outcome of the IFFT block. The values associated with the time-domain shaping REs are determined based on values of other REs, at the pre-IFFT stage to be multiplexed with the sensing signal, such as REs containing data or other reference signal types. In some examples, the time-domain pattern may be produced via a DFT-spreading stage prior to the IFFT block at REs assigned to the sensing signal.

It is to be understood that the techniques described herein encompass multiple embodiments and implementation elements that may be combined in various configurations. Elements from different implementations and embodiments may be combined to construct new embodiments that incorporate features from multiple approaches. The procedures, measurements, and other elements defined for specific sensing signal properties are not restricted to particular sensing signal types and are to be understood as representing examples applicable to general sensing signal types and structures. For example, the defined first, second, and third periods of the shaped sensing signal are not to be interpreted restrictively, and any combination of any quantity of these periods may be interpreted as a signal for which defined properties, procedures, measurements, reporting, or configuration approaches as described herein are applicable.

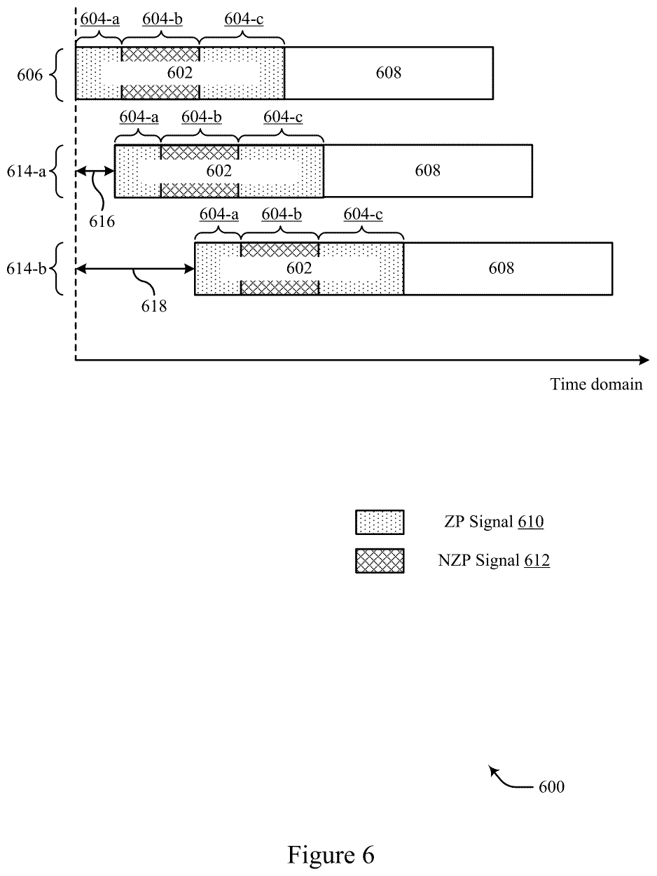

FIG. 6 illustrates an example of a timing diagram 600 in accordance with aspects of the present disclosure. In some examples, the timing diagram 600 implements or is implemented by aspects of the wireless communications system 100. For example, the timing diagram 600 illustrates timing of a sensing signal transmitted 602 by a sensing TX and received by a sensing RX, each of which may include or be an example of a UE 104 or an NE 102 as described with reference to FIG. 1. The timing diagram 600 differs from the timing diagram 300 illustrated in FIG. 3 in that the sensing signal transmitted in the timing diagram 600 is shaped, prior to transmission, in the time-domain according to the techniques described herein. For example, by configuring a sensing signal with three consecutive time periods that have distinct power characteristics, a sensing TX can create temporal separation between interfering signals and desired sensing target reflections at a sensing RX.

The timing diagram 600 illustrates an example in which a sensing signal 602, shaped in the time-domain according to a time-domain shaping pattern, is transmitted by a sensing TX and received at a sensing RX via a background path and via a sensing target path. Specifically, sensing TX timing 606 illustrates timing (e.g., a temporal pattern) of the sensing signal 602 and one or more subsequent signals 608 (e.g., additional transmissions or data signals that occur after the sensing signal 602) transmitted by a sensing TX. The sensing TX shapes the sensing signal 602 as described herein such that the sensing signal 602 has a time-domain signal pattern having a first period 604-a, a second period 604-b, and a third period 604-c. The first period 604-a and the third period 604-c carry ZP signals 610, while the second period 604-b carries a NZP signal 612. In some examples, the ZP signals 610 may contain zeros. It is to be understood that the ZP signals 610 may additionally or alternatively include or be an example of low-power signals, where low-power signals are defined as having a transmission power that is a threshold level below a transmission power associated with the NZP signal(s) 612. That is, although signals transmitted during the first and/or third periods 604-a and 604-c are referred to herein as having a zero-value transmission power, the techniques described herein apply equally to low-power transmission signals defined relative to NZP signal(s) 612 transmitted during the second period 604-b. The respective durations and power levels of each period 604 may be configured based on the specific geometry of the sensing scenario, including the positions of the sensing TX and the sensing RX and the expected location of sensing target(s).

The three-period structure of the time-domain signal pattern may create a pulse-shaped signal pattern in the time-domain that enables sensing RXs to process target reflections (e.g., reflections of the sensing signal 602 from a sensing target) during periods when background interference is minimized. As such, the three-period structure may reduce or eliminate inter-path interference, such as the inter-path interference 314 and the inter-path interference 316 described with reference to FIG. 3, that occur in conventional sensing implementations. For example, the three-period structure may eliminate these interference conditions by coordinating transmission timing with expected propagation delays and respective transmission powers of each period 604 to prevent simultaneous arrival of interfering signals (e.g., high-power background channel signals and sensing target path signals) at the sensing RX. As illustrated, sensing RX timing 614-a depicts timing of the sensing signal 602 and the subsequent signal 608 received at the sensing RX via the background channel after a background path delay 616. Sensing RX timing 614-b depicts timing of the sensing signal 602 and the subsequent signal 608 received at the sensing RX via the target channel after a target path delay 618.

In contrast to FIG. 3, the sensing RX simultaneously receives a NZP signal 612 in a second period 604-b of the sensing signal 602 via the background channel and a ZP signal 610 in a first period 604-a of the sensing signal 602 via the target path. Subsequently, the sensing RX receives a ZP signal 610 in a third period 604-c of the sensing signal 602 via the background channel and a NZP signal 612 in a second period 604-b of the sensing signal 602 via the target path. The sensing RX then receives a ZP signal 610 in a third period 604-c of the sensing signal 602 via the target path and a subsequent signal 608 via the background path. Due to the power differences between the first and second periods 604, the second and third periods 604, and the third period 604 and the subsequent signal 608, the sensing RX can easily distinguish between the sensing signal 602 received via the target path and undesired signals, such as the sensing signal 602 received via the background channel and/or the subsequent signal 608. Accordingly, time-domain shaping of the sensing signal 602 may improve sensing measurement accuracy by reducing the dynamic range requirements of receiver hardware and enabling more effective signal processing of target reflections in the presence of strong background interference.

The sensing TX and/or a configuration entity (e.g., a configuring NE 102, a configuring UE 104, SF, SMC, SensMF, a RAN node associated with the sensing TX, or the like) may determine and/or indicate (e.g., to the sensing TX and/or the sensing RX) respective parameters for each period 604 of the sensing signal 602. The respective parameters for each period 604 may include one or more of a start time, a duration, a power level, or a time-domain sequence that define the temporal and energy characteristics of each period 604 and, subsequently, of the three-period structure (e.g., the time-domain shaping pattern). The sensing signal 602 may be generated by the sensing TX according to a sensing signal configuration and the respective parameters, and may be transmitted during the first, second, and third periods 604 according to the respective power levels. In some examples, the power level of the first period 604-a and the third period 604-c may be the same and may be defined jointly according to a ratio relative to the power level of the second period 604-b to provide consistent interference mitigation characteristics.

In some examples, each period 604 may be configured to have the same or different parameters as one or more of the other periods 604. Additionally, or alternatively, each of the NZP and/or ZP portions of the sensing signal 602 (e.g., the NZP signal 612 and/or the ZP signal(s) 610, respectively) may be configured to have the same or different parameters. That is, parameterization of the sensing signal 602 may be determined (e.g., selected, configured) on a per-period 604 basis and/or on a per-NZP signal 612 and per-ZP signal 610 basis. For example, separate time-domain parameters, patterns, occasions, durations, and/or or resources may be defined or determined for each of the three periods 604. Here, each period 604 may include one or more time-domain symbols, portions of symbols, slots, subframes, or combinations thereof. As such, the periods 604 are separated into different symbols, slots, or subframes. The time-domain parameters may be determined according to a frame structure assumed, defined, or known at the sensing TX. Additionally, or alternatively, the time-domain parameters may be defined with respect to an offset provided (e.g., indicated, determined) relative to one or more slots, subframes, frames, and/or similar time references, e.g., of the sensing signal 602, one or more of the periods 604, or another time-domain signal (e.g., the subsequent signal 608 or a signal transmitted or received prior to the sensing signal 602).

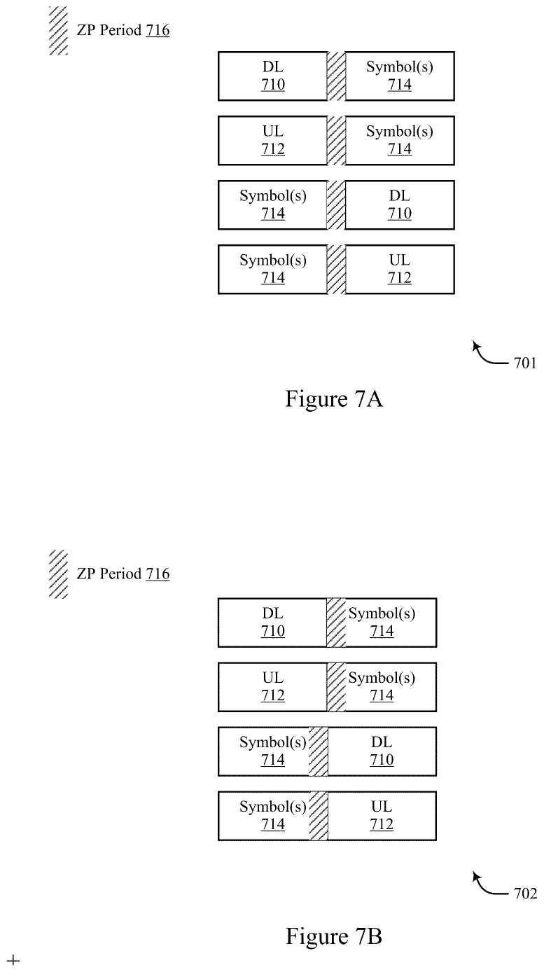

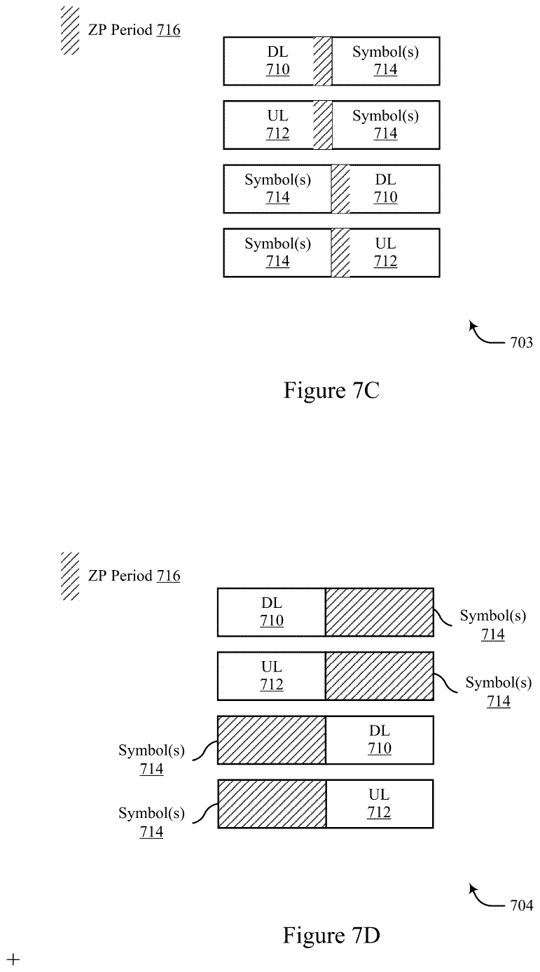

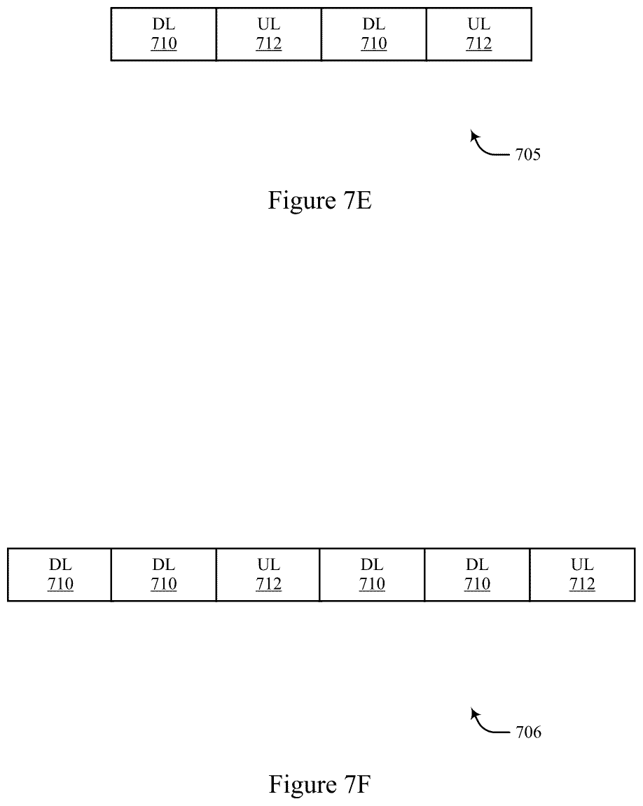

For example, the first period 604-a, the second period 604-b, and the third period 604-c may each include one or more distinct time-domain symbols, guard intervals, slots, subframes, or a combination thereof, according to a sensing signal frame structure (e.g., a slot format, a subframe format, a frame format, a symbol format, or a combination thereof, among other examples) as described with reference to FIGS. 7A through 7F. In some cases, the first period 604-a and the third period 604-c may be embedded within a same symbol, within a same cyclic prefix, or a combination thereof, to enable efficient resource utilization and timing coordination. Additionally, or alternatively, at least one of the first period 604-a or the third period 604-c may be defined, as part of the sensing signal frame structure, as ZP periods within a symbol, a guard band, or a zero-interval outside of a symbol or guard-band period. In some cases, a cyclic prefix, a guard band, or a unique word may be defined as a ZP or low-power sequence and may be utilized as the first period 604-a or the third period 604-c.

In some examples, the duration of the first period 604-a may be based on a threshold delay difference from a first arrival path (e.g., a sensing target path) for a target decibel (dB) isolation value to ensure adequate separation between transmission events and sensing target path reception windows. Additionally, or alternatively, the duration of the third period 604-c may be equal to the duration of the second period 604-b plus a threshold expected delay of a sensing target path, such as the sensing target path delay 618, to provide sufficient time for sensing target reflection processing at the sensing RX.

The first period 604-a prior to the second period 604-b may include zeros and/or a ZP, reduced-power, or low-power sensing signal transmission, such as the ZP signal 610, from one or more antenna ports or beams of the sensing TX that are associated with sensing signal transmission. The ZP signal 610 may be multiplexed (e.g., through frequency- or code-domain multiplexing), within the same time frame, with other NZP or ZP transmissions. The ZP or low-power transmission state applies to the sensing TX for any or all transmissions within the first period 604-a.

The third period 604-c subsequent to the second period 604-b may include zeros and/or a ZP, reduced-power, or low-power sensing signal transmission, such as the ZP signal 610, from one or more antenna ports or beams of the sensing TX that are associated with sensing signal transmission. Similar to the first period, the ZP signal 610 in the third period 604-c may be multiplexed with other NZP transmissions (e.g., through frequency- or code-domain multiplexing within the same time frame). The ZP or low-power transmission state applies to the sensing TX node for any or all transmissions within the third period 604-c.

When defining (e.g., determining, configuring, indicating) the first and/or third periods 604-a and 604-c including the ZP signals 610, the sensing TX implements ZP or low-power transmission conditions according to a priori-defined absolute or relative power levels or power level ratios. Similarly, the sensing RX assumes that any signals from the sensing TX received during the first and/or third periods 604-a and 604-c are ZP or low-power transmissions. The definition, configuration, and/or indication of ZP or low-power time periods such as the first and third periods 604-a and 604-c may be associated with all transmissions of the sensing TX during the corresponding time periods and/or all transmissions of the sensing TX associated with specific resources, such as frequency resources and/or antenna ports or beams. Additionally, or alternatively, separate and/or different power levels may be defined, indicated, configured, or determined for each of the three periods 604. The three periods 604 may be allocated various combinations of same or different power levels. For example, the first and third periods 604-a and 604-c may be allocated the same power level while the second period 604-b may be allocated a different (e.g., greater) power level.

The respective power levels for the periods 604 may be defined as absolute transmission power values or as relative levels describing ratios between known transmission power levels and/or measured or received power levels from previous occasions, other periods, or previously indicated or defined transmission power levels or measurement power quantities. For example, the transmission power level of a NZP or high-power period, such as the period 604-b, may be defined or indicated explicitly or as an absolute power level, while the power levels associated with the first and third periods 604-a and 604-c may be defined relative to the power level of the second period 604-b. In some cases, the first and third periods 604-a and 604-c may share the same power level and may be defined, indicated, configured, or reported jointly, such as according to a single ratio relative to the transmission power level of the second period 604-b or as a single absolute power level.

In some cases, the respective power levels for each of the periods 604 may be defined or indicated through an index from a codebook or table, where the codebook or table includes one or more defined absolute power levels and/or power level ratios, such as the ratio by which the power level of the first and/or third periods 604-a and 604-c differ from the second period 604-b. The respective power levels may be determined and indicated by the configuration entity. Alternatively, the transmission power levels may be autonomously determined by the sensing TX, such as according to a previously indicated or determined configuration or strategy. In such scenarios, the determined power level may be reported or indicated by the sensing TX to a SensMF node such as an SF, SMC, an LMF, or a gNB (e.g., NE 102) or RAN node or UE 104 controlling the sensing operation, among other examples.

The NZP portion of the sensing signal 602 corresponding to the second period 604-b may include a quantity K2 of consecutive symbols, while the first period 604-a corresponds to a quantity K1 of symbols prior to the second period 604-b and the third period 604-c corresponds to a quantity K3 of symbols subsequent to the second period 604-b. The position or time-occasion of the periods 604 may be defined as absolute or relative times. For example, the starting symbol of the second period 604-b may be defined according to a system frame number, subframe number, slot number, symbol number, or other timing reference (e.g., a first symbol of a subframe S within a current frame). In some examples, the first and/or third periods 604-a and 604-c are defined as one or more dedicated symbols for sensing, and the properties of these dedicated symbols may be defined separately and differently from default assumed or defined symbol properties. For example, a symbol duration, cyclic prefix duration, NFFT size, or subcarrier spacing of a dedicated symbol may be defined or dedicated for the first and/or third periods 604-a and 604-c and may differ from a defined duration in the default slot format.

In some examples, the first and third periods 604-a and 604-c may be defined or configured as part of the definition of the sensing signal 602. That is, the sensing signal 602 may be defined as including all or a portion of the first period 604-a and/or the third period 604-c in addition to the (entire) second period 604-b). In such examples, all or a portion of the first, second, and third periods 604 are thus defined (e.g., configured) within the same configuration that defines the sensing signal 602. Alternatively, the sensing signal 602 may be defined or configured separately from the first and/or third periods 604-a and 604-c. For example, the first period 604-a and/or the third period 604-c may be defined or configured as part of a separately configured signal from the second period 604-b.

In some cases, the first period 604-a and the third period 604-c are embedded within a same symbol, within a same cyclic prefix, or both (e.g., within a same symbol and adjacent cyclic prefix). In some examples, the first and third periods 604-a and 604-c may be generated as additional extended guard bands of the same or adjacent symbol that carries the NZP signal 612, or generated as an extra or additionally inserted guard interval between two consecutive symbols.

In some cases, the first period 604-a and/or the third period 604-c may not be defined or associated with a symbol or with a configured symbol timing. Instead, the first period 604-a and/or the third period 604-c may be separately defined or configured transmission periods, implemented as dedicated ZP (or low-power) transmission periods defined between two symbols. Additionally, or alternatively, the dedicated ZP transmission periods may be defined as part of a sensing signal frame structure (e.g., a slot format, a subframe format, a frame format, a symbol format, or a combination thereof, among other examples) as described with reference to FIGS. 7A through 7F.

These dedicated ZP transmission periods may not be defined according to default symbol and guard-interval or cyclic prefix durations. To compensate for the addition of such dedicated ZP transmission periods within a time structure (e.g., within a same slot, subframe, or frame duration as default symbols, slots, or subframes), durations of a default symbol, cyclic prefix, slot, or subframe may be adjusted (e.g., by the sensing TX and/or the sensing RX). In some cases, the adjustment may be pre-configured or predefined. For instance, when one or more ZP transmission periods such as the first period 604-a and/or the third period 604-c are indicated as associated with a sensing signal transmission, the sensing TX and/or sensing RX may adjust the slot, symbol, or subframe structure by a preconfigured amount (e.g., in the time-domain) and/or according to a preconfigured pattern. The preconfigured amount or pattern may correspond to a quantity of symbols and/or durations of a symbol, guard-interval, or cyclic prefix that are shortened or reduced according to a ratio or factor to accommodate the dedicated ZP transmission periods. The pattern, ratio, and/or factor may be determined and/or indicated by the sensing TX, sensing RX, and/or configuration entity.

In some examples, a cyclic prefix, a unique word, and/or a guard band may be defined as a ZP or low-power sequence and may be utilized as the first period 604-a and/or the third period 604-c. For instance, a cyclic prefix duration, unique word, or guard band duration of the sensing signal 602 may be generated by the sensing TX with ZP or low power by setting the unique word of a unique word OFDM to zero, or by generating zeros at the cyclic prefix segment of a cyclic prefix OFDM or DFT-s-OFDM waveform. Additionally, or alternatively, a dedicated ZP guard interval corresponding to the first period 604-a and/or the third period 604-c may be inserted between two adjacent symbols. The dedicated ZP guard interval may be different from a defined or default guard interval and/or symbol. The dedicated ZP guard interval may, for example, have a different position, duration, and/or NFFT size than the defined or default guard interval and/or symbol and may be inserted by the sensing TX according to the sensing signal frame structure.

FIGS. 7A through 7F illustrate examples of sensing signal frame structures 701 through 706 in accordance with aspects of the present disclosure. In some examples, the sensing signal frame structures 701 through 706 implement or are implemented by aspects of the wireless communication system 100. For example, a sensing TX and a sensing RX may transmit and receive sensing signals according to one or more of the sensing signal frame structures 701 through 706 as described with reference to FIG. 1.

A sensing signal frame structure may be defined to accommodate shaping of sensing signals in the time-domain. A sensing signal frame structure may refer to or be understood as a time-domain resource format that is dedicated for sensing procedures and/or that includes or otherwise supports one or more of the first, second, and third periods of a shaped sensing signal. For example, the position and duration of one or more of the first, second, and third periods may be defined as part of a sensing slot format. A sensing signal frame structure may include, but is not limited to, a slot format, a frame format, a subframe format, a symbol format, or the like, among other examples. In some examples, a sensing signal frame structure may be defined or configured separately from a default frame structure (e.g., a default slot format, a default subframe format, etc.).

A sensing TX may determine (e.g., generate) or receive an indication of a sensing signal frame structure. For example, the sensing TX may allocate respective portions of a sensing signal frame structure to one or more of the first period, the second period, or the third period of the sensing signal. Additionally, or alternatively, a sensing TX may transmit the indication of the sensing signal frame structure to a sensing RX, which may compute or otherwise determine the duration and location of one or more of the first, second, and third periods of the sensing signal based on the received indication.

The sensing signal frame structures 701 through 706 may include one or more downlink (DL) symbols 710 and/or one or more uplink (UL) symbols 712. Additional symbol(s) 714 may be included, which can include or be an example of uplink symbols, downlink symbols, full duplex (FD) symbols, subband full duplex (SBFD) symbols, sidelink symbols, transmission-reception point (TRP) to TRP symbols (e.g., a symbol where transmission by a TRP and reception by a TRP is expected according to a specific frame timing). ZP periods 716 correspond to the first time period and/or the third time period of the sensing signal. The second time period of the sensing signal may be included within one or more of the Downlink symbols 710, Uplink symbols 712, and/or additional symbols 714.

In the example of FIG. 7A, the sensing signal frame structure 701 includes a ZP period 716 inserted as a guard interval between consecutive symbols. In such examples, the ZP periods 716 are defined as a separate (e.g., dedicated) guard interval associated with sensing procedures and different from default guard intervals. The ZP periods 716 may thus be inserted as additional or extended guard periods (e.g., in addition to or extending a default guard interval) between a symbol (e.g., a downlink symbol 710, an uplink symbol 712) that includes the second period (e.g., the NZP period) of the sensing signal and a subsequent symbol (e.g., a symbol 714).

In some examples, when the ZP periods 716 are inserted as dedicated additional guard intervals, symbol durations of other symbols in the sensing signal frame structure 701 are updated (e.g., by the sensing TX and/or the sensing RX) with a predefined value or ratio to compensate for a total slot or subframe duration. This ensures that slots or subframes including the ZP periods 716 maintain a same total duration as slots or subframes without the ZP periods 716.

In the example of FIG. 7B, the sensing signal frame structure 702 includes a ZP period 716 as part of each symbol 714 that is adjacent (e.g., in the time-domain) to a symbol (e.g., a downlink symbol 710, an uplink symbol 712) containing the NZP period of the sensing signal. Here, the presence of the NZP period 716 as part of a downlink symbol 710 and/or an uplink symbol 712 may be defined as part of the sensing signal frame structure 702 or may be separately (e.g., dynamically) configured based on the sensing signal frame structure 702.

In the example of FIG. 7C, the sensing signal frame structure 703 includes a ZP period 716 as part of the same symbol (e.g., a downlink symbol 710, an uplink symbol 712) that contains the NZP period. Here, the presence of the NZP period 716 as part of a downlink symbol 710 and/or an uplink symbol 712 may be defined as part of the sensing signal frame structure 702 or may be separately (e.g., dynamically) configured based on the sensing signal frame structure 703.

In the example of FIG. 7D, the sensing signal frame structure 704 includes a ZP period 716 allocated to each adjacent symbol 714 (e.g., to an entire adjacent symbol 714 or to multiple consecutive adjacent symbols) to a symbol (or symbol group) that includes the NZP period. Here, the presence of the NZP period 716 as part of a downlink symbol 710 and/or an uplink symbol 712 may be defined as part of the sensing signal frame structure 702 or may be separately (e.g., dynamically) configured based on the sensing signal frame structure 702.

In some examples, configuration of the first, second, and third periods and their respective durations may be performed dynamically. Additionally, or alternatively, the configuration may be performed as separate (e.g., from default) resource allocation signaling mechanisms than the default slot format or subframe format, or in addition to a default slot format or subframe format.

In the example of FIG. 7E, the sensing signal frame structure 705 may implement alternating transmission patterns of Downlink symbols 710 and Uplink symbols 712, where a transition between each consecutive pair of DL/Uplink symbols is used (e.g., by a sensing TX) to implement a combination of the first and second periods or a combination of the second and third transmission periods. That is, a ZP period 716 is implemented as part of a symbol having an opposite communication direction than a symbol that includes the NZP period. For example, at an NE acting as a sensing TX, a Downlink symbol 710 that includes the NZP period of the sensing signal may be followed by an Uplink symbol 712 in which no transmission (or a ZP transmission) is scheduled for the NE, and the third period of the sensing signal can be implemented as part of the Uplink symbol 712 subsequent to the Downlink symbol 710 that includes the NZP period. Thus, the sensing signal frame structure 705 having repeated alternating communication directions creates frequent opportunities for sensing operations.

The sensing signal frame structure 705 may be defined by indicating transition patterns and repetition parameters that specify how the alternating structure is implemented across multiple transmission intervals. For example, the sensing signal frame structure 705 may be associated with configuration parameters that define the repetition characteristics of the downlink symbol(s) 710 and the uplink symbol(s) 712. A set of Downlink symbols 710 (e.g., a quantity of symbols configured for downlink transmissions) may be repeated N1 times and then transition to the other direction (e.g., uplink), and a set of Uplink symbols 712 (e.g., a quantity of symbols configured for uplink transmissions) may be repeated for N2 symbols. In the example of FIG. 7F, the sensing signal frame structure 706 is associated with N1=2 repetitions of downlink symbols 710 and N2=1 repetitions of uplink symbols 712.

Additionally, or alternatively, the configuration may include a starting position of a starting (e.g., initial) symbol having an indicated communication direction (e.g., downlink or uplink), a number of repetitions (e.g., in which the transition is repeated M times with a separation of L symbols) within a slot or subframe, and the number of occasions or time-pattern of the slot or subframe for which a defined structure is repeated. For example, the repetition parameters may specify patterns such as the first slot of each subframe, every third slot or subframe within a frame starting from an indicated position, or the like, among other examples.

The sensing signal frame structures 701 through 706 may support various sensing signal types including downlink sensing signals, uplink sensing signals, sidelink sensing signals, and network-to-network sensing signals that utilize the configured symbol arrangements and ZP periods 716. The sensing signals may include reference signals specifically designed for sensing operations or existing communication signals that are adapted for dual-purpose sensing and communication functionality. Additionally, the sensing signal frame structures 701 through 706 may be implemented via on-demand or dynamic configuration and/or semi-static configuration signaling, such as via DCI, MAC-CEs, RRC signaling, or a dedicated sensing protocol. For instance, a sensing TX or a configuration entity may indicate a configuration for a sensing signal frame structure to a sensing RX to adapt or override an existing sensing signal configuration in order to dynamically insert the additional guard intervals (e.g., the ZP periods 716), such as by updating a subcarrier spacing (SCS) configuration of a slot or subframe to accommodate the additional guard intervals. The sensing RX may additionally or alternatively request such an update from the sensing TX or the configuration entity. In any of the examples described herein, a configuration entity may additionally or alternatively indicate the configuration to the sensing TX or the sensing TX may autonomously determine the configuration.

In some cases, the sensing TX and/or the sensing RX, subsequent to receiving a configuration for a sensing signal (such as a sensing signal frame structure configuration or other configuration or parameters associated with the sensing signal), the sensing TX and/or the sensing RX may assume a predefined, configured, or known slot format for a slot upon transmission or reception of the sensing signal.

In some examples, a first and second slot format can be configured for the sensing TX, the sensing RX, or a UE that transmits or receives a physical data or control channel or PRACH (also referred to as a data RX) according to the received slot format. The first slot format applies when the sensing signal and the corresponding first, second, and third periods are not expected to be present. The second slot format applies to slots where the sensing signal and one or more of the first, second, or third periods are present. Thus, the sensing TX, sensing RX, and UE can recognize the presence of the first, second, and third signal periods when a previously defined slot format is indicated or activated. Similarly, the sensing TX, sensing RX, and UE can assume a previously defined slot format (e.g., a sensing signal frame structure) is active when the first, second, and third periods of a sensing signal are configured or indicated.

In any of the approaches described herein, the three-period structure (or parts of it) is not limited to any particular examples. The proposed low- or ZP periods may be implemented as an inherent property of a defined sensing signal, or as an additional shaping or configuration step that creates these low- or ZP periods in addition to an initially defined sensing signal.

In some examples, the ZP periods of a sensing signal may be understood as a muting of signals (e.g., a muting of a sensing signal) for sensing purposes. That is, the sensing signal can be understood as having one or more (e.g., the first and/or third periods) muted portions. A muted sensing signal corresponds to a ZP transmission of a signal used for sensing purposes during one or more configured sensing occasions (for example, from a time T1 to a time T2). A sensing occasion can be defined as a set of contiguous time resources during which a sensing signal is transmitted, with a time granularity measured in sub-symbols, symbols, sub-slots, slots, subframes, frames, etc. A sensing occasion may be fully muted or partially muted to enable differential processing between the background channel and sensing target channel. A low power may be defined relative to the NZP transmission, subject to specified limits, implementation choices, or specified thresholds.

The ZP or low-energy periods relative to the NZP periods for sensing can be signaled in various formats. One example format is a bitmap, where there is a relationship between a bitmap and a time unit such as a symbol, slot or subframe. This mapping between bitmap and time-domain granularity can be configurable based on the configuration type. For example, a ‘0’ value can indicate when to insert a ZP or low powered period, while a ‘1’ value can indicate when to insert a NZP period. The bitmap may be signaled by a sensing TX or a configuration entity, e.g., to a sensing RX or the sensing TX.

In addition to configuring and/or indicating parameters and/or a corresponding configuration for a sensing signal frame structure, sensing nodes participating in a sensing procedure can determine (e.g., configure, select, calculate, identify) one or more sensing signal parameters and/or one or more shaping parameters (e.g., for use in generation/shaping of the sensing signal). Sensing signal parameters include, but are not limited to, the duration, energy level, power level, energy shaping, attenuation factor of each or the first, second, or third periods, and repetition or periodicity of the sensing signal instances. Each sensing signal instance may include one or more periods with specific energy shaping features. Shaping parameters include parameters used in shaping the sensing signal in the time-domain, e.g., to achieve a target time-domain signal pattern, such as values, locations, quantities, etc. of time-domain shaping REs.

All or a subset of the sensing signal parameters and/or shaping parameters for a sensing signal procedure may be determined at a sensing node and, if applicable, communicated to one or more other sensing nodes. For instance, one or more sensing signal parameters and/or shaping parameters may be carried in one or more information elements (IEs), such as existing IEs or dedicated sensing IEs. Sensing signal parameters and shaping parameters may be determined, selected, defined, indicated, etc. as absolute values or relative values (for example, increases or decreases in duration/signal power for one or more durations). In some cases, the sensing signal parameters and/or shaping parameters are determined at the sensing TX, at the sensing RX (and reported to the configuration entity or sensing TX), or at the configuration entity (and configured based on/for the sensing TX and/or sensing RX). In some examples, the sensing signal parameters and/or shaping parameters are signaled to the SensMF or sensing TX node or determined at the SensMF or sensing TX node before finalizing the duration, energy level, power level, or attenuation of the first, second, or third periods of the sensing signal. Additionally, or alternatively, a sensing TX and/or configuration entity may determine parameters based on received information, such as capability information or indicated parameters received from a sensing RX. For instance, the sensing TX may determine parameters based on measurements performed, by the sensing TX, on a signal (e.g., different from the shaped time-domain sensing signal) received from a sensing RX. The sensing RX may transmit the signal using a same beam that the sensing RX expects to use to receive the sensing signal. The sensing TX may, for example, determine the duration of the second period using a delay difference (e.g., between an LoS path between the sensing TX and the sensing RX and one or more sensing target paths associated with the target channel) calculated based on receiving the signal from the sensing RX.

Table 1 below delineates sensing signal parameters and shaping parameters and provides acquisition examples. It is to be understood that any combination of sensing nodes may determine any combination of one or more parameters of a sensing procedure, including shaping parameters, and the examples discussed herein are not to be construed as limiting.

TABLE 1
Sensing procedure parameters

| | | Example acquisition |
|---|---|---|
| Parameter/quantity | Description | type |
| Processing dynamic range | This includes the number of | Capability information |
| at sensing RX node | quantization bits or steps, and the | provided by the sensing |
| | difference (in dB) between the | RX node (e.g., an IE |
| | strongest and weakest path that can be | defining the dynamic |
| | processed at the sensing RX node or | range information). |
| | resolved by an RX radio. | This capability |
| | In some cases, this dynamic range | information may be |
| | varies with angle, delay, or doppler | provided to any entity |
| | characteristics (such as the difference | that requests it. |
| | between strongest and weakest paths | |
| | that can be separately processed based | |
| | on their arrival angles, path delays, or | |
| | doppler shifts). | |
| | Alternatively, the dynamic range may | |
| | be indicated by maximum and | |
| | minimum values of the strongest and | |
| | weakest paths. | |
| Energy, delay, angle, | This includes delay, angle, and energy | From a report from the |
| and/or Doppler difference | characteristics of paths associated with | sensing RX node |
| between a sensing target | the sensing target. It may also include | (where the sensing RX |
| path and environment | minimum, maximum, or mean | node estimates the |
| clutter or a LoS sensing | differences between paths associated | parameter based on |
| target path | with the target channel and paths | measurement) |
| | associated with the background | |
| | channel (such as the direct path | |
| | between sensing TX and sensing RX, | |
| | or a strong non-direct path from the | |
| | background channel). | |
| Observed ST-SNR at | The observed or measured SNR of | Based on measurement |
| sensing RX | paths associated with the sensing target | at the sensing RX node |
| | (“ST-SNR”). This is the received SNR | and upon reporting by |
| | based on reception from the target | the sensing RX node |
| | channel at the sensing RX node and | |
| | may be based on transmission of a | |
| | sensing signal known to the sensing | |
| | RX node. | |
| Threshold ST-SNR at | The required (e.g., threshold) ST-SNR | Determined at the |
| sensing RX | level at the sensing RX node needed to | sensing TX or SensMF |
| | obtain measurement quantity type or | based on the |
| | accuracy as required. | measurement type and |
| | | indicated capability of |
| | | the sensing RX node |
| | | Determined at the |
| | | sensing RX node based |
| | | on the sensing |
| | | measurement quantity |
| | | type, required |
| | | measurement accuracy, |
| | | reliability, resolution, |
| | | sensing signal time- |
| | | duration, pattern, |
| | | resources, bandwidth, |
| | | or resource pattern |
| | | As a pre-known value |
| | | corresponding to a |
| | | sensing measurement |
| | | type, quantity, or |
| | | accuracy |
| | | As feedback from the |
| | | sensing RX node |
| | | indicating a higher ST- |
| | | SNR value is needed |
| | | with a specific delta or |
| | | ratio for a configured |
| | | measurement |
| | | As a value determined |
| | | by the sensing RX node |
| | | for delivering a |
| | | requested measurement |
| Delay/angle of interfering | Average delay, delay spread, average | Measured at the |
| paths | angle, or angle spread of the interfering | sensing RX node based |
| | paths to the sensing RX sensing of the | on transmission from |
| | target channel (e.g., interfering paths or | the sensing TX node |
| | dominant paths as part of the | and reported to the |
| | background channel observed by the | sensing TX node or |
| | sensing RX) | SensMF |
| Geometry information of | Information including actual or | Obtained via SensMF |
| the sensing scenario | hypothetical position of the sensing TX | (e.g., from assisting |
| | and RX nodes, potential area, position, | information of a |
| | velocity, or mobility pattern of a | sensing service request) |
| | sensing RX node, expected | |
| | propagation 3D distance associated | |
| | with a path of the target channel, and | |
| | expected, effective, maximum, or | |
| | minimum propagation 3D distance | |
| | associated with a path of the | |
| | background channel. | |
| RCS | Information related to RCS of the | Obtained via SensMF |
| | sensing target, such as RCS value, | (e.g., from assisting |
| | target type, shape, or size | information of a |
| | | sensing service request) |
| | | Obtained by the |
| | | sensing RX node via |
| | | measurement and |
| | | reported to the sensing |
| | | TX node or SensMF |
| TX-RX switching time | The time duration required by a | Capability information |
| | sensing measurement node acting as | provided by the sensing |
| | both sensing TX and sensing RX to | RX node (e.g., an IE |
| | start reception (as a sensing RX node) | defining the dynamic |
| | of signal samples after concluding a | range information) |
| | transmission of a sensing signal. This | |
| | can be defined as absolute time | |
| | information or as a function or table | |
| | dependent on the TX signal power and | |
| | RX signal energy. | |
| Required measurement | The required measurement quantity | Determined by the |
| quantity | type to be generated by the sensing RX | SensMF or sensing TX |
| | node based on the received sensing | node based on the |
| | signal | sensing service type or |
| | | required key |
| | | performance indicators |
| | | (KPIs) of a sensing |
| | | service or task |
| Required measurement | The required measurement quantity | Determined by the |
| quantity accuracy and/or | accuracy, resolution, reliability, or | SensMF or sensing TX |
| resolution | maximum error measure to be | node based on the |
| | generated by the sensing RX node | sensing service type or |
| | based on the received sensing signal | required KPIs of a |
| | | sensing service or task |
| Power-delay profile/ | The observed power-delay profile of | A priori known (based |
| | the TX-RX channel, which can be | on channel statistics) |
| | relative to the first arrived path | Measured at the |
| | | sensing RX node |
| | | Measured at the |
| | | sensing TX node based |
| | | on reciprocity of the |
| | | TX-RX channel |
| Minimum relative path | The minimum delay required from the | A priori known (based |
| delay (delay difference) | first arrived path for the power-delay | on channel statistics) |
| for target dB isolation | density to drop at least X-dB below the | Measured at the |
| | first arrival path or the average path | sensing RX node |
| | energy. This ensures the signal | Measured at the |
| | associated with the sensing target can | sensing TX node based |
| | be reliably processed by the sensing | on reciprocity of the |
| | RX node. The value of X may be | TX-RX channel |
| | determined by the sensing RX node | |
| | (based on node capability or sensing | |
| | setup geometry) or indicated by the | |
| | network. | |
| Self-interference isolation | The separation or isolation level | Capability information |
| | between a transmitted signal and an | provided by the sensing |
| | observable received signal power when | RX node (e.g., an IE |
| | the sensing TX and sensing RX are co- | defining the self- |
| | located | interference related |
| | | information) |

In some cases, an initial transmission power (e.g., energy level) of the second period may be adjusted by a sensing node based on an initial transmission (e.g., between the sensing TX and the sensing RX) and measurement. The sensing node (e.g., sensing TX, sensing RX) may receive a signal (e.g., other than the shaped time-domain signal) and perform one or more measurements to obtain a first SNR value, referred to as an observed received SNR, associated with the sensing target channel. To obtain the adjusted transmission power, the sensing node may compare the observed received SNR to a threshold SNR associated with the sensing target channel. The threshold SNR may be equal to an SNR value needed to achieve a desired (e.g., target) sensing performance (e.g., KPI). The comparison may take the form of a ratio as shown in Equation 1 below.

$${P}_{T , new} = min \{ {P}_{T , max} , \frac{S N {R}_{T h r e shold}}{S N {R}_{O b s e r v e d}} \times β \times {P}_{T , o l d} \} \qquad ( 1 )$$

In Equation 1, P_{T,new} and P_{T,old} may be defined as the adjusted transmission power (e.g., for the second period) and the initial transmission power, respectively. SNR_{Threshold} SNR_{Observed} correspond to the observed ST-SNR at the sensing RX and the threshold ST-SNR at the sensing RX, e.g., as defined with reference to Table 1. β may be determined based on a radar processing gain, such as a total quantity of REs and time-domain symbols that can be coherently combined for a sensing task and/or defined within a sensing signal compared to the measured signal used in the initial transmission. For example, when the sensing signal includes twice as many REs or time-domain repetitions compared to the initial transmission, the value of β may be equal to 2. In some cases, the value of β may be determined by the sensing TX by incorporating additional factors, including mismatches between the sensing TX and sensing RX (e.g., beam reciprocity, coordinate system, synchronization accuracy, etc.).

In some examples, a sensing RX determines the value of P_{T,new} and transmits an indication of the determined value to the sensing RX, which adjusts the transmission power of a subsequent shaped sensing signal accordingly. Alternatively, the value of

$$\frac{{SNR}_{Threshold}}{{SNR}_{Observed}}$$

or the value of

$$\frac{{SNR}_{Threshold}}{{SNR}_{Observed}} \times β$$

may be determined at the sensing Rx node and reported to the sensing Tx node, which then uses this information to determine the value of P_{T,new}.

In some examples, a respective transmission power and/or duration for each of the first, second, and/or third periods of the shaped sensing signal are determined such that the sensing signal received at the sensing RX via one or more sensing target paths can be resolved (e.g., separated/distinguished from background paths/clutter), enabling the sensing RX to generate measurement quantities over the one or more sensing target paths. Thus, the respective transmission power(s) may be determined according to one or more of a dynamic range of the sensing RX; an energy, delay, angle, or Doppler difference between target channel paths and background channel paths; or a minimum relative path delay for a target dB isolation.

In some cases, for instance, the duration of the second period D₂ may be determined according to Equation 2 below.

D₂=Δ_{PathDelay}−MinDelay (2)

In Equation 2, Δ_{PathDelay} represents the path delay difference between a sensing target path and a first background path (e.g., corresponding to Energy, delay, angle, and/or Doppler difference between a sensing target path and environment clutter or a LoS sensing target path as defined in Table 1), while MinDelay represents a minimum path delay needed to achieve the target dB isolation level (e.g., corresponding to Minimum relative path delay (delay difference) for target dB isolation as defined in Table 1). The target dB isolation level may be determined by the sensing TX or the sensing RX to ensure that clutter interference remains below the supported processing dynamic range of the sensing RX.

Additionally, or alternatively, the duration of the first period D₁ may be determined according to a power-delay profile and/or MinDelay, where MinDelay is within the background channel. In such examples, D₁ may be greater than (e.g., by a threshold amount, such as by a minimum supported value) a difference between MinDelay and the delay difference associated with the sensing target channel (e.g., to the first arrival path at the sensing RX). The target dB level may be determined based on a power level of the signal prior to the first duration, the power level of the second duration; a difference in energy, delay, angle, and/or Doppler needed for separation (e.g., between the target channel and the background channel) at the sensing RX; and/or a difference in energy, delay, angle, and/or Doppler between a sensing target path and environment clutter. That is, D₁ may be selected to be equal to the minimum delay needed to ensure that paths (of the background environment/clutter) containing signal energy arriving at the sensing RX before the first period of the sensing signal are weaker than the expected received sensing signal via the target channel, e.g., by a target margin.

In some cases, for instance, the duration of the first period D₁ may be determined according to Equation 3 below.

D₁=max{MinDelay−Δ_{PathDelay},0} (3)

In equation 3, MinDelay corresponds to a minimum delay difference from a first arrival path for a target dB isolation, while Δ_{PathDelay} represents the delay difference between a sensing target path and a first arrival path at the sensing RX.

In some cases, a ratio of the transmission power of the first period to the transmission power of the second period is determined based on the difference in energy, delay, angle, and/or Doppler needed for separation at the sensing RX. Additionally, or alternatively, a ratio of the transmission power of the third period to the transmission power of the second period (or to the received sensing signal of the second period corresponding to the strongest path or the total received signal energy) is determined based on one or more of the Self-interference Isolation and Energy, delay, angle, and/or Doppler difference between a sensing target path and environment clutter or a LoS sensing target path parameters defined in Table 1. The transmission power of the third period, T₃, may be determined according to Equation 4 below.

T₃=min{P_{T,max},Self-interference Isolation+NP−AdditionalMargin} (4)

In Equation 4, NP corresponds to a noise power in dBm, P_{T,max} is in dBm, Self-interference Isolation is in dB, and AdditionalMargin is in dB. The variable AdditionalMargin accounts for estimation or Tx/Rx mismatches and the difference to the noise floor by which the interference should be suppressed for reliable Rx processing. This may be determined by the sensing node performing measurements (e.g., of the initial signal different from the sensing signal) or by the SensMF (e.g., according to the sensing node capability information).

In some cases, the third period and/or the first period include transmissions other than the sensing signal, such as physical data or control channel transmissions containing modulated data.

In some examples, the duration of the first and/or third periods is selected to be greater than the duration of the second period to allow for complete reception, by the sensing RX, of the NZP portion of the sensing signal. In some cases, the duration of the third period (“third period duration”) is calculated as the duration of the second period (“second period duration”) plus an extra margin. This extra margin is determined according to the expected spread of the sensing target location or path delays associated with the expected sensing target locations (e.g., corresponding to the difference between the maximum and minimum potential delay associated with a path of a sensing target/target channel). That is, the extra margin may be equal to a maximum expected delay of a path associated with a sensing target. In some cases, this extra margin also includes the switching time between transmission and reception.

In some cases, the second period duration is determined based on the difference between the expected delay of strong (e.g., high-power) interfering paths (e.g., of the background channel), such as the direct/LOS path and/or strong reflective paths, and the expected minimum or Y-percentile delay of the target channel (e.g., the minimum delay that 100−Y % paths of the target channel are expected to exceed for a Tx-Rx channel). In some cases, an additional delay margin is included for the second period duration, such as extra margin needed for reliable separation of target and background paths at the sensing Rx node in a correlation-based RX, or due to sensing Rx capabilities.

In scenarios where a same sensing signal is received/measured by multiple sensing Rx nodes, all or some parameters defined in Table 1 may be obtained for each sensing TX-sensing RX pair and jointly used to determine corresponding sensing signal/shaping parameters. For example, a sensing TX may determine one or more parameters based on a group report, group capability information, or location information of a group of sensing RX nodes. In one such example, the second period duration of the sensing signal is set to a minimum duration of a set of calculated second period durations when considering each Tx-Rx pair, ensuring that the second period duration remains above the difference between the expected delay of strong interfering paths (of the background channel) and the expected minimum or Y-percentile delay of the target channel for all Tx-Rx pairs associated with the sensing Tx node that transmits the sensing signal.

In some examples, a configuring entity may select one or more sensing nodes (e.g., from among a set of candidate sensing nodes) to participate in the sensing procedure. This selection may be based on one or more of the parameters described herein, such as parameters associated with the sensing procedure/configuration, sensing signal parameters, shaping parameters, etc. For example, Reducing the second period duration may, in turn, reduce an effective SNR associated with a sensing target (e.g., of the target channel). As such, sensing RX nodes and/or sensing TX nodes (or both) may be selected for participation such that the sensing procedure can support a relatively large second period duration (e.g., larger than a threshold duration, or among the K-largest in the group of sensing nodes). For example, the configuring entity may select sensing RX nodes that are sufficiently close (e.g., within a threshold distance) to a sensing Tx node such that the effective 3D-distance difference between a target channel and a strong background channel paths exceeds a desired minimum duration of the second period.

In some examples, sensing signal parameters may be configured (e.g., as absolute values or relative values, such as increases or decreases in duration/signal power for one or more durations) using an index from a table and/or codebook. An example is shown below as Table 2.

TABLE 2
Sensing procedure parameters

| Index | 1 | 2 | 3 | 4 | 5 |
|---|---|---|---|---|---|
| 1^{st} period | 1 symbol | ¼ symbol | 0 | 10 microseconds | . . . |
| duration | | | | | |
| 2^{nd} period | 1 symbol | ¼ symbol | 20 micro- | 30 microseconds | . . . |
| duration | | | seconds | | |
| 3^{rd} period | 2 symbols | ½ symbol + | ½ symbol + | 0 [does not exist] | . . . |
| duration | | CP | CP | | |
| 1^{st} period | ZP | ZP | −20 dB of the | ZP | . . . |
| energy | | | max TX power | | |
| 2^{nd} period | Max TX | Max TX | Max TX power | Max average TX | . . . |
| energy | power | power | | power + 3 dB | |
| 3^{rd} period | ZP | ZP | −20 dB of the | — | . . . |
| energy | | | max TX power | | |
| Start time | Start of the | Third | . . . | Starting symbol | . . . |
| | slot | symbol of | | of a frame | |
| | | every | | | |
| | | subframe | | | |
| Periodicity | Every 2 | . . . | . . . | Every subframe | . . . |
| | slots | | | | |
| End time | After 1000 | . . . | . . . | . . . | . . . |
| | subframes | | | | |

In some examples, time-domain shaping of one or more sensing signals includes determining one or more of a repetition count, duration, and periodicity in the time-domain. A shaped sensing signal may repeat for a quantity of instances and according to a specified periodicity. For example, a sensing signal may be configured to repeat three times (e.g., three repetitions) with defined durations of each of the first, second, and third periods. The specified periodicity may be, for example, every N symbols, within X microseconds in a same symbol, or with a periodicity defined based on a cyclic prefix, guard-interval, absolute time duration, or symbol. In some embodiments, these repetition and periodicity parameters are included in the codebook describing the sensing signal, and an index from this codebook jointly describes the sensing signal time-domain shaping (e.g., a corresponding time-domain signal pattern), quantity, timing, and periodicity of repetitions.

In the codebook, the quantity of repetitions may be paired with the duration of the NZP period (e.g., the second period) of the sensing signal and/or the duration of the third period (e.g., the low- or ZP period subsequent to the second period). In a scenario in which a first sensing target is positioned at a first location that is relatively far from a sensing node and a second sensing node is positioned at a second location that is closer to the sensing node, the energy of a sensing signal reflection received via the first sensing target may be expected to be lower (e.g., less) than that of the second sensing target due to the distance difference to the sensing node. However, a delay difference between the sensing signal reflection and the direct (e.g., LoS) path of the sensing signal to the sensing node may be greater for the first sensing target than the second sensing target. In such scenarios, both the repetition count and the duration of the second and/or third period may be defined together, such as by indicating a distance-dependent parameter (such as distance index “d”). This parameter increases both the repetition count and the duration of second and third periods according to the indicated distance value “d” via a single row in the codebook, making the repetition count and durations greater than those used in the case of a single pulse repetition. In other examples, the durations, repetition count, and repetition gap—or some subset of these parameters—are defined separately from one another, such as via explicit parameters.

In some examples, when the sensing TX and sensing RX are co-located at the same entity or node (e.g., at a gNB/TRP or at a UE), the node is considered to perform monostatic sensing operations and/or measurements and may be referred to as a monostatic sensing node. In some such scenarios, the shaping of the sensing signal may include only the first and the second periods (e.g., may exclude a third period), where the second period is located at the end of a symbol (or other time duration) dedicated (e.g., according to the slot format) for transmission by the node, and prior to the start of the symbol (or other time duration). As another example, when the node is a gNB/TRP/RAN node, the second period of the sensing signal may be located at the end of a last symbol assigned as a downlink symbol (or an SBFD symbol when the sensing signal is located within a downlink subband) and before (e.g., immediately prior to) a start of an UL symbol (or an SBFD symbol when the sensing signal is located within an uplink subband). In some such examples, the second period may coincide with the last portion of an NFFT block of the node and the third period may occupy part of a subsequent symbol in which the node can perform reception and/or may not perform transmission. In some such examples, the configuration of the sensing signal (e.g., including the second period at the end of the NFFT block) may further imply one or more of muting or sub-symbol muting (e.g., setting the transmission power of the signal to zero or a low-power energy state at part of a symbol) of any configured uplink transmission at the subsequent symbol coinciding with the third period (e.g., the period in which a reflection of the sensing signal transmitted in the second period is expected from a sensing target); or adjustment of the AGC of the node according to an expected received power level of the sensing signal (e.g., reflected/scattered from the expected target) and not based on the expected received uplink signal power (e.g., when the uplink transmission within the expected reception time/third period are muted or switched into the low-energy state).

As another example, when the node is a UE, the second period of the sensing signal may be located at the end of the last symbol assigned as one of an uplink symbol or sidelink symbol (or an SBFD symbol where the sensing signal is located within the uplink subband) assigned for sidelink transmission by the node and before (e.g., immediately prior to) the start of a downlink symbol (or an SBFD symbol where the sensing signal is located within the uplink subband) or a sidelink symbol assigned for reception by the node. In some such examples, the second period may coincide with the last part of the NFFT block of the node and the third period may occupy a portion of a subsequent symbol in which the node can perform reception and/or may not perform transmission. In some such examples, configuration of the sensing signal (including the second period at the end of the NFFT block) may further imply one or more of muting or sub-symbol muting (e.g., setting the transmission power of the signal to zero or a low-power energy state at part of a symbol) of any configured downlink or sidelink transmission at the subsequent symbol coinciding with the third period (e.g., the period in which a reflection of the sensing signal transmitted in the second period is expected from a sensing target); or adjustment of the AGC of the UE according to an expected received power level of the sensing signal (e.g., reflected/scattered from the expected target) and not based on the expected received downlink signal power (e.g., when the downlink transmission within the expected reception time/third period are muted or switched into the low-energy state).

In some examples, a low-energy/low-power transmission state of a signal (e.g., a low-power signal) from a node is associated with one or more of a transmission power of the node having an indicated power level reduction/difference compared to a normal or default or average or maximum or maximum average power level; or a modified modulation and coding scheme class/level/index corresponding to transmission of the low-power signal (e.g., when the transmission includes a data/control physical channel). In some examples, selection and/or configuration parameters for operation (e.g., for sensing signal, measurements and reporting) of the node for monostatic sensing is associated with the node's capabilities, including a minimum switching time needed by the node (e.g., between an end of a sensing signal transmission and a start of the sensing signal reception). In some cases, the minimum switching time may be that needed to achieve at least a target level of isolation (e.g., a target self-interference cancellation level) in dB. In such cases, this can be defined based on an absence or presence of the sensing target as part of the environment/channel. Additionally, or alternatively, the node's capabilities may include observability regions/areas for which a sensing measurement quantity (e.g., of a point cloud data, object detection and/or tracking, or other path measurements described herein) can be obtained, and in some examples with a given accuracy/reliability. In some examples, the observability regions/areas describe geographical areas and/or positions according to a global coordinate system (GCS) or a local coordinate system (LCS) of the node. In some such examples, the observation regions/areas may be defined with an observable angle (e.g., azimuth, elevation) range, and/or a distance/radius range.

In some examples, observability regions/areas include an indication of LoS and/or non-LoS (NLoS) states towards the observability regions/areas (e.g., as collection of potential target positions) from the node. In some such examples, a same LoS/NLoS status is indicated for both TX-potential target position/sensing area and RX-potential target position/sensing area. In some other examples, a different LoS/NLoS status is indicated for both TX-potential target position/sensing area and RX-potential target position/sensing area. In some such examples, the collection of the points/sensing area for which the same LoS/NLoS condition holds is indicated as being associated with a same LoS/NLoS status, and further, the points/areas with different LoS/NLoS statuses towards the TX and RX are reported differently. In one such example, a node reports the points/areas for which sensing/observability capability shall be reported via indices describing one or more of:
a LoS condition towards the point/area via TX and RX (e.g., meaning that both TX and RX antenna panels share the same LoS status towards the associated point/area);
a NLoS condition towards the point/area via TX and RX (e.g., meaning that TX and RX antenna panels share the same NLoS status towards the associated point/area);
a LoS condition towards the point/area via TX (e.g., meaning that a TX antenna panel has the LoS status towards the associated point/area). In some examples, this means that the status of the RX (towards the point/area) is NLoS. In some examples, this is interpreted as the status of the RX being undeclared or undecided. In some other examples, both variations (of being declared or being determined as LoS) are presented via separate indices of the codebook; or
a NLoS condition towards the point/area via TX (e.g., meaning that a TX antenna panel has the NLoS status towards the associated point/area). In some examples, this means that the status of the RX (towards the point/are) is LoS. In some examples, this is interpreted as the status of the RX being undeclared or undecided. In some other examples, both variations (of being declared or being determined as LoS) are presented via separate indices of the codebook.

In some examples, the observable range/area at which a sensing node may provide sensing measurement quantities is associated with additional radio parameters, such as SCS, frequency range, and the like, among other examples. As such, one capability information may be provided for a combination of the bandwidth, SCS, frequency range/carrier frequency supported by a sensing node, and another combination of the bandwidth, SCS, frequency range/carrier frequency supported by the sensing node.

A sensing RX may derive and/or report one or more measurement quantities for use in the sensing procedure. Each measurement can be based on uplink signals, downlink signals, sidelink signals, TRP-to-TRP signals, or remote interference management signals. Timing-based measurements may include delay, path delay, relative delay between paths, time or delay difference of arrival such as a reference signal time difference, relative time-of-arrival, or receiver-to-transmitter time difference of paths such as UE receiver-transmitter time difference or gNB receiver-transmitter time difference, or transmitter-to-receiver time difference of a path. The transmitter-to-receiver time difference may represent the difference between a starting point for transmission of a symbol, slot, or subframe, and the estimated timing of the received signal associated with returned path. These measurements may be measured or reported jointly with one or more of an observed relative or absolute path delay, energy, azimuth or elevation angle information, may be reported only for a shortest observed delay for the same angle of arrival, or may be reported upon determination that the received reflection is associated with single-bounce reflection or propagation.

Doppler-based measurements may include frequency or doppler frequency shift, path doppler shift, relative doppler shift, relative frequency or doppler shift of paths, frequency-difference of arrival of paths, or receiver-to-transmitter frequency difference of paths. Phase-based measurements may include carrier phase of arrival of a path. Angle-based measurements may include azimuth or zenith or elevation of arrival or of departure, azimuth or zenith or elevation of a path, or relative angle of arrival of paths.

Energy or power-based measurements may include received power of a signal via a path, total received power of a signal, total received power of signals at a given resource, or power within a filtered signal domain such as a delay, angle of arrival, zenith of arrival, or doppler filter. Micro-doppler or vibration rate measurements may include observed or received path vibration rate or micro-doppler shift, or vibration rate or micro Doppler shift difference of paths. Information describing sensing results of a sensing target may include presence, position, velocity or speed, heading, orientation, or vibration rate of a sensing target.

In some examples, the measurement quantities generated at the sensing RX based on reception of a transmitted signal from the sensing TX may include the raw signal received at the baseband in the time domain (e.g., before cyclic prefix removal) or in the frequency domain (e.g., after cyclic prefix removal and FFT calculation) across the antenna arrays in one or more of the array dimensions. In some examples, the calculation of a reported measurement quantity further includes one or more steps of:
generating the estimate of the channel at different delay or doppler taps (e.g., correlating the received signal with the delay and/or frequency-shifted versions of the known transmitted signal for estimating channel at different frequency point, delay, doppler (or combined) taps, taking FFT over the estimated channel in the time domain across different symbols);
taking FFT across the signal or the estimated channel of antenna elements in the horizontal direction of the planar array and/or in the vertical direction of the planar array or a 2-D FFT jointly for both dimensions;
choosing a set of points in the post-FFT/2-D FFT calculation (representing different channel taps at different delay, doppler, azimuth, elevation taps), e.g., based on a priori known or indicated absolute or relative range of azimuth/elevation/delay/doppler (e.g., according to an LoS path or a known AoA/ZoA, delay, doppler, etc.), based on an absolute or relative energy/power threshold (e.g., only keeping the paths above an indicated energy threshold), based on a (maximum) number of paths to be chosen, etc. In some examples, the selection of the post-FFT points (of the channel taps) is done according to the parameters inferred from a detected path, e.g., the channel taps within an indicated distance to the parameters of the detected path delay/doppler/angle are chosen to be reported; or
compressing the obtained signal values or channel taps according to a given vector quantization strategy. In one such strategy, the group of channel taps t across different AoA/ZoA, delay, doppler taps or corresponding to the calculated FFT (e.g., 4D or 2D FFT outputs) are quantized, such as by scaling the obtained values according to a given matrix which defines the weights of the different vector components. This is represented by M*t where M is the weighting matrix indicated for performing vector quantization over the to-be-reported value t. The transformed values are then quantized using a uniform quantization, which is defined via the maximum value, minimum value, and the number of quantization steps. In some examples, the transformation matrix M is indicated to the sensing RX node according to a set of parameters or according to an index from a codebook. In some embodiments, the matrix M is determined, at least in part, based on the parameters of a detected path. That is, upon detection of a path at a delay/doppler value, the path parameters are estimated and the matrix M is chosen based on the estimated parameters of the detected path, e.g., weighting in favor of the path parameters such that the channel taps with parameters closer to the detected path are quantized with less quantization error.

In some examples of sensing measurements performed based on the shaped time-domain sensing signal, assistance information for generation of the sensing measurement quantities and/or the expected measurement quantity to be reported and/or another measurement reporting configuration is associated with or determined, at least in part, based on the configured sensing signal parameters, e.g., based on a respective energy and/or duration of the one or more of the first, second, and third periods of the sensing signal. In one such example, an expected relative delay of the path associated with a sensing target (e.g., an expected delay difference of the path associated with a single bounce sensing target reflection and an LoS/direct path towards the sensing RX, e.g., upon a prior detection of the LoS status between sensing TX and a sensing RX), for which the sensing RX is requested to perform sensing and/or generate measurement results, is inferred from the duration of the second period (e.g., a pulse duration of the sensing signal), e.g., as a minimum expected delay difference, and/or the duration of the third period, e.g., as a maximum expected delay difference. In some such examples, the expected delay difference is assumed to be the range given by the duration of the second period as a minimum and the duration of the third period as a maximum delay difference. In some examples, the measurement reporting configurations, e.g., the delay reporting codebook/steps, are defined according to the sensing signal parameters, e.g., the path delay values to be reported are defined within a codebook according to the minimum and maximum delay/delay difference determined according to the duration of the second and/or third period as described above.

FIG. 8 illustrates an example of a multiplexing procedure 800, in accordance with aspects of the present disclosure. In some examples, the multiplexing procedure 800 implements or is implemented by aspects of the wireless communication system 100. For example, a sensing TX may utilize the multiplexing procedure 800 to generate a shaped time-domain sensing signal for use in a sensing procedure as described with reference to FIG. 1. The sensing TX multiplexes the time-domain sensing signal and a frequency domain signal (e.g., a set of frequency domain REs) within a same time-domain symbol. The time-domain symbol may also be referred to or understood as an FFT block.

Transmission of data using CP-OFDM waveforms while performing energy shaping within a sensing symbol may be achieved through coordinated frequency domain resource allocation and time-domain signal shaping techniques. Conventional reference signals such as SRSs, PRSs, and CSI-RSs are defined in the frequency domain, where, at a transmitter, predefined sequence values and energy levels are assigned to corresponding REs in the frequency domain prior to IFFT processing. The conventional approach focuses on loading RE values into frequency domain resources without consideration of the resulting time-domain signal characteristics after IFFT processing, e.g., except for PAPR considerations. Receiver processing for conventional signals follows the inverse procedure by removing the cyclic prefix, performing parallelization, applying FFT processing, and extracting information from the RE domain to recover reference signals or data embedded within QAM symbols. The techniques described herein differ from conventional processing by intentionally shaping the symbol according to a target time-domain pattern while maintaining the ability to transmit data using CP-OFDM within the same time-domain symbol structure.

Time-domain patterns of a sensing signal may be defined as target signal characteristics achieved after IFFT processing. A time-domain symbol contains multiple REs which contain data, but a portion of the symbol may be intentionally shaped according to the time-domain signal pattern for the sensing signal while the remaining portion of the symbol is used for CP-OFDM-based data transmission and reception. Computational blocks, such as those illustrated in FIG. 8, may compute a set of time-domain shaping REs, which are identified similar to reference signal patterns such as CSI-RS patterns or DMRS patterns that define sets of REs in the frequency domain. Time-domain shaping REs may be defined as REs having values computed based on the time-domain signal pattern, e.g., that do not carry data. In the following examples, a “first set” of REs refers to REs that contain data (e.g., data symbols, modulation symbols, constellation points), while a “second set” of REs refers to a set of time-domain shaping REs. The second set of REs serve as input to the IFFT block. The second set of REs may be shaped (e.g., loaded with values) such that after applying the IFFT jointly on both the first set of REs and the second set of REs, the resulting output sensing signal exhibits characteristics, such as a pulse signal shape, that match the time-domain signal pattern. Put another way, the values of the second set of REs are selected based on the first set of REs, e.g., based on values of a set of data-containing REs. The values of the time-domain shaping REs are thus calculated as data-dependent values that coordinate with existing data transmission parameters and content. This approach enables simultaneous data transmission and sensing signal generation within a same symbol.

The multiplexing procedure 800 thus involves determining the values of the second set of REs based on the first set of REs such that after the combined resources pass through IFFT processing, the resulting time-domain signal includes the first, second, and third periods of the sensing signal. This procedure may be implemented using computational logic such as second-order cone programming, which may simplify the calculations required for RE value determination. Additionally, second-order cone programming may reduce (e.g., minimize) a PAPR resulting from the time-domain shaping process, as time-domain signal shaping operations may increase the PAPR of the transmitted signal.

For example, one or more of the first, second, and third periods of a sensing signal can be multiplexed with another signal, e.g., within a same symbol. This other signal may be a physical data channel, a physical control channel, another reference signal, or another signal containing data symbols modulated from the frequency domain through an IFFT stage. In these implementations, the multiplexing of the sensing signal (within one or more of the first, second, or third periods) can be performed completely or partially according to multiplexing procedure 800.

For example, the sensing TX may utilize one or more spatial precoders that transform input signals into precoded signals for transmission through multiple antenna ports or transmission layers (e.g., MIMO layers), such as a set of M MIMO transmission layers. The spatial precoders may include an M-by-N spatial precoder that processes data-containing REs (e.g., the first set of REs) and an L-by-N spatial precoder that processes time-domain sensing signals to enable coordinated transmission of both signal types through the same transmission infrastructure. d_{1,S1}, . . . , d_{M,S1}∈C^{|S1|} represent the first set of REs (e.g., data-containing REs) to be transmitted via the M MIMO transmission layers. The first set of REs may be represented as a set S1 of the total quantity of REs that can be transmitted within a time-domain symbol. That is, the input signals d_{1,S1} through d_{M,S1} represent data symbols (e.g., modulation symbols, constellation points) allocated to frequency domain resources using data modulation schemes such as quadrature amplitude modulation (QAM) or phase shift keying (PSK). In the current example, the REs describe transmission resources in the frequency domain assuming an IFFT- or OFDM-based processing. However, this example does not restrict the type of the processing matrix and any other linear orthonormal or non-orthonormal transformation (e.g., other than the Fourier transform) can be as well applied to the data-containing symbols to be transformed to the time-domain signal sequence.

The M-by-N spatial precoder may receive the input signals d_{1,S1} through d_{M,S1} and transform them into precoded signals \tilde{d}_{1,S1} through \tilde{d}_{N,S1} that are distributed across N antenna ports or transmission layers. That is, the data-containing REs are transformed into resources defined (within the S1 frequency/RE resource set) for each N antenna port, denoted as \tilde{d}_{1,S1}, . . . , \tilde{d}_{N,S1}∈C^{|S1|}. The behavior of the M-by-N spatial precoder can be modeled as multiplication of the input signal with the (frequency-dependent) precoder matrix at each subband, RE, or frequency point.

s₁(t), . . . , s_{L}(t) denote L time-domain signals (such as sensing signals including the three periods), each expected to be transmitted via a MIMO layer (or beam) corresponding to the respective sensing signal. These L time-domain signals define a target (e.g., desired) time-domain sequence/signal at the post-IFFT stage, within a previously known time-window (for example, within [T1 . . . T2]). The target time-domain sequence/signal is also referred to as the target time-domain signal pattern.

The L-by-N spatial precoder may process the time-domain signals s₁(t) through s_{L}(t), which represent sensing signals with specific temporal characteristics designed for sensing target illumination and reflection generation. The L-by-N spatial precoder thus transforms the time-domain sensing signals into precoded time-domain signals \tilde{s}₁(t), . . . , \tilde{s}_{N} (t) that are distributed across the same N antenna ports or transmission layers as those used for data signal transmission. The behavior of the L-by-N spatial precoder can be modeled as a time-domain convolution of the input signal (e.g., the time-domain signals s₁(t) through s_{L} (t)) with the precoder matrix. The precoded time-domain signals [symbol] (t), . . . , [symbol] (t) act as reference points to shape, according to the target time-domain signal pattern, the time-domain characteristics of the IFFT output (that is, the time-domain signal transmitted from the corresponding antenna port) within a shaping time-period [T₁, T₂] within the symbol. The shaping time period [T₁, T₂] defines a time window within the symbol (e.g., within the time-domain FFT block) for which the output signal (e.g., the sensing signal) is intended to be shaped according to \tilde{s}₁(t), . . . , \tilde{s}_{N}(t), i.e., is to be equal to the value(s) defined by \tilde{s}₁(t), . . . , \tilde{s}_{N}(t) within [T₁, T₂].

\tilde{d}_{1,S2}, . . . , \tilde{d}_{N,S2}∈ [symbol] ^{|S2|} denote REs of the second set of REs (also referred to as the second resource set S2 of the total quantity of REs that can be transmitted within the time-domain symbol) which are shaped in order to generate a time-domain signal, post-IFFT block, in accordance with the pre-coded time-domain signal \tilde{s}₁(t), . . . , \tilde{s}_{N} (t) within the corresponding antenna port. The second resource set S2 may represent frequency domain resources allocated for generation of the time-domain signal pattern that defines signal characteristics subsequent to IFFT processing of frequency domain resources.

The computation blocks may calculate values for the second resource set S2 to produce the time-domain signal pattern based on the data symbols in the first set of REs, the time-domain signal pattern, IFFT block dimensions, a location of the second resource set S2 within the IFFT input, or some combination thereof. Thus, the computation blocks are responsible for shaping and determining the values of the second set of REs such that the output of the IFFT blocks follow the time-domain signal pattern within the time window [T₁, T₂]. Calculation of these values may additionally or alternatively depend on the time window [T₁, T₂] (e.g., on the value of T₁ and/or T₂), the first resource set S1, the second resource set S2, the size and placement of the first and/or second resource sets within the resource grid or IFFT block input(s), the value(s) of \tilde{s}₁(t), . . . , \tilde{s}_{N}(t) for the corresponding antenna port, the value(s) of \tilde{d}_{1,S2}, . . . , \tilde{d}_{N,S2}∈C^{|S2|} for the corresponding antenna port, or the like, among other examples.

The first and second resource sets may be defined, determined, selected, or configured as a resource allocation pattern in frequency domain, such as a starting RE, a comb or jump size, distance, length of the resources in the frequency domain, and/or a quantity of REs. The resource allocation pattern may include a starting RE position or PRB position that defines where the time-domain REs begin within the frequency domain resource grid. The resource allocation pattern may specify a quantity of consecutive REs or PRBs that are allocated for time-domain signal shaping purposes. A frequency domain spacing between REs or PRBs may be configured to create comb-like patterns or distributed allocation strategies. Additionally, or alternatively, the first and second resource sets may be determined at the sensing TX (e.g., on a device-specific basis) based on local measurements or conditions, or the resource sets may be defined via a bitmap over the resources that does not follow a comb structure pattern. In some examples, the first and second resource sets can be defined by granularity, such as a block or quantity of adjacent REs (e.g., one PRB, two PRBs, one half of a PRB). A bitmap may define the set membership of the first and second resource sets for the corresponding blocks. In some cases, the first resource set may be defined initially, while the second resource set may be defined or assumed as a complement to the first resource set, or alternatively, the second resource set may be defined first and the first resource set may be determined as the complement.

The IFFT blocks process the precoded signals from both spatial precoders to generate the shaped time-domain sensing signal having the time-domain signal pattern and carrying the data associated with the first set of REs. That is, the IFFT blocks transform the first set of REs and the second set of REs into time-domain samples of the sensing signal. In some examples, the IFFT blocks or matrices can be replaced by any other linear transformation or matrix, or can represent other orthonormal or non-orthonormal basis. Examples include an over-sampled IFFT transform or an IFFT block combined with a spreading matrix or transformation. In such cases, the defined S1 and S2 resource sets are the resources input to the transformed IFFT matrix (IFFT*E, or E*IFFT, where E is a known transformation or spreading matrix).

Subsequent to IFTT processing, serial-to-parallel (S2P) conversion blocks and cyclic prefix addition (CP-addition) blocks prepare the processed signal for wireless transmission. The S2P conversion blocks may transform the time-domain output signals from the IFFT blocks into parallel data streams that can be transmitted simultaneously over the M layers. The CP-addition blocks may insert guard intervals at the beginning of transmission symbols to provide protection against inter-symbol interference caused by multipath propagation effects. The CP-addition blocks may also enable the time-domain sensing signal characteristics to be preserved during transmission and reception while maintaining compatibility with frequency domain equalization techniques.

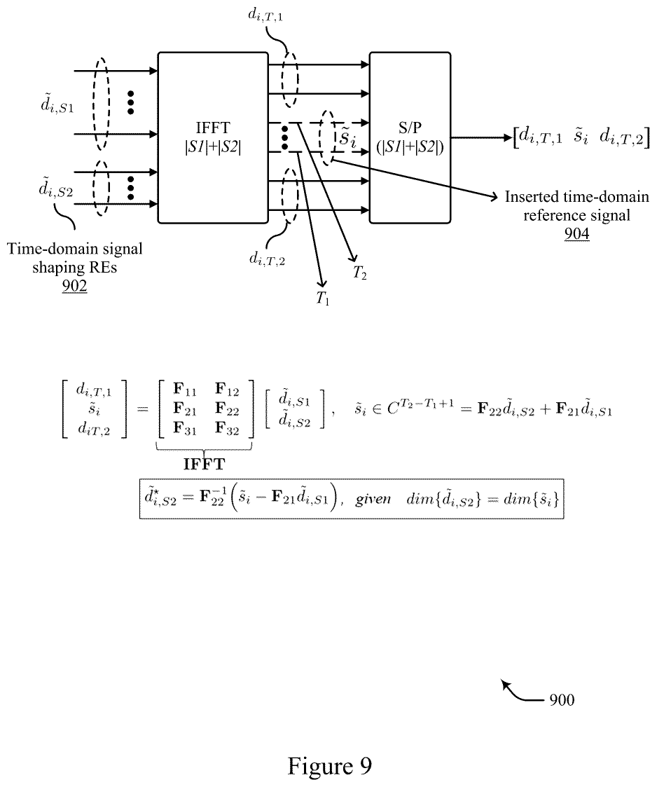

FIG. 9 illustrates an example of a multiplexing computation logic 900, in accordance with aspects of the present disclosure. The multiplexing computation logic 900 may be implemented as part of the multiplexing procedure 800 as described with reference to FIG. 8. Specifically, the multiplexing computation logic 900 illustrates a method for obtaining the frequency domain REs belonging to the second set of resources S2.

Time-domain shaping REs 902, represented as \tilde{d}_{i,S2}, correspond to the second set of resources S2 as described with reference to FIG. 8. The time-domain shaping REs 902 are processed through an IFFT block that transforms frequency domain inputs into time-domain output signals with temporal characteristics corresponding to the time-domain signal pattern. The IFFT block may be labeled as “|S1|+|S2|” to indicate that the IFFT processing operates on both data-containing REs from the first resource set S1 and the time-domain shaping REs 902 from the second resource set S2. The IFFT block dimensions may influence the calculation of values for the time-domain shaping REs 902, as the transform size determines the relationship between frequency domain inputs and time-domain outputs. The location of the time-domain shaping REs 902 within the IFFT input may affect the temporal positioning of the resulting time-domain signal pattern within the output symbol. The time-domain shaping REs 902 may thus be positioned at various locations within the frequency resource grid, such as at the end, middle, or beginning of the IFFT input, depending on the desired temporal characteristics of the output signal.

Additionally, or alternatively, the quantity of REs in the time-domain shaping REs 902 may correspond to a quantity of time-domain samples defining the time-domain signal pattern, enabling a one-to-one correspondence between each time-domain shaping RE and each time-domain sample. The correspondence between frequency domain REs and time-domain samples may be determined by the IFFT block dimensions and the desired temporal resolution of the time-domain signal pattern. In some cases, the quantity of time-domain shaping REs 902 may equal the number of time-domain samples that define the time-domain signal pattern, enabling direct mapping between frequency domain allocation and time-domain signal characteristics. The resource allocation may alternatively utilize more or fewer time-domain shaping REs 902 than the number of time-domain samples. In some examples, an index referencing preconfigured frequency domain resources may be utilized to specify the allocation of the time-domain shaping REs 902.

In the example of FIG. 9, the quantity of the time-domain shaping REs 902 (e.g., the quantity of REs in the second set of resources S2) is equal to a quantity of time-domain signal samples associated with the time-domain signal pattern. Here, the time-domain shaping REs 902 may be located at the end of the frequency resource grid of the IFFT block. Thus, the frequency domain REs belonging to set S2 may be obtained by inverting the IFFT sub-block, as shown in FIG. 9.

Subsequent to the IFFT block, the time-domain shaping REs 902 are processed via serial-to-parallel conversion through an S/P block that transforms the IFFT output into parallel data streams suitable for wireless transmission. The S/P block may be labeled as “(|S1|+S2|)” to indicate that the serial-to-parallel conversion processes the combined output from both the data-containing REs (e.g., the first resource set S1), represented as \tilde{d}_{i,S1}, and the time-domain shaping REs 902. The serial-to-parallel conversion may distribute the time-domain signal samples across multiple transmission paths or antenna ports to enable MIMO transmission. The processing chain from the time-domain shaping REs 902 through the IFFT block and S/P conversion may generate an inserted time-domain reference signal 904 that has the time-domain signal pattern. The inserted time-domain reference signal 904 may represent the final time-domain signal output, e.g., as the sensing signal multiplexed with data.

In some cases, the inserted time-domain reference signal 904 may be generated at the end of CP-OFDM symbol samples with length corresponding to cyclic prefix duration, creating dual time-domain reference symbols within one symbol. The positioning of the inserted time-domain reference signal 904 at the end of the symbol duration may enable the signal to be copied as part of the cyclic prefix when the cyclic prefix is generated from the end portion of the symbol. The dual time-domain reference symbol may provide two instances of the same sensing signal within one transmission symbol, with one instance appearing at the end of the symbol and another instance appearing at the beginning as part of the cyclic prefix. The cyclic prefix duration may be configured to accommodate the length of the inserted time-domain reference signal 904, enabling the sensing signal to be fully contained within the cyclic prefix portion of the transmission symbol.

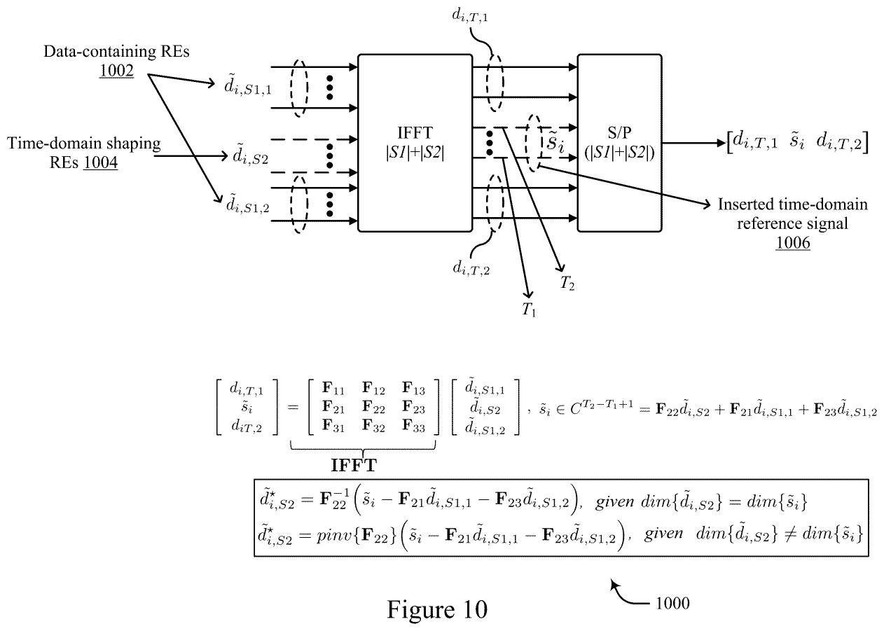

FIG. 10 illustrates another example of a multiplexing computation logic 1000, in accordance with aspects of the present disclosure. The multiplexing computation logic 1000 may be implemented as part of the multiplexing procedure 800 as described with reference to FIG. 8. Specifically, the multiplexing computation logic 1000 illustrates a method for obtaining the frequency domain REs belonging to the second set of resources S2.

The multiplexing computation logic 1000 includes data-containing REs 1002 that carry communication data using conventional modulation schemes and time-domain shaping REs 1004 that are computed to produce the time-domain signal pattern after IFFT processing. The data-containing REs 1002 correspond to the first resource set S1 and are represented as \tilde{d}_{i,S1,1} and \tilde{d}_{i,S1,2}. The time-domain shaping REs 1004, represented as \tilde{d}_{i,S2}, correspond to the second set of resources S2 as described with reference to FIG. 8. The processing chain from the time-domain shaping REs 1004 through the IFFT block and S/P conversion may generate an inserted time-domain reference signal 1006 that has the time-domain signal pattern. The inserted time-domain reference signal 1006 may represent the final time-domain signal output, e.g., as the sensing signal multiplexed with data.

In comparison to FIG. 9, the quantity of assigned time-domain shaping REs 1004 illustrated in FIG. 10 may be less than or greater than the length of the time-domain samples to be shaped within the [T₁, T₂] time window. Additionally, the time-domain signal samples may be located anywhere within the symbol duration (not just at the beginning or end), and the time-domain shaping REs 1004 may be positioned anywhere within the frequency resource grid of the IFFT block. In the example of FIG. 10, the time-domain shaping REs 1004 may be obtained by inverting the IFFT sub-block or using the pseudo-inverse matrix when the IFFT sub-block matrix isn't square.

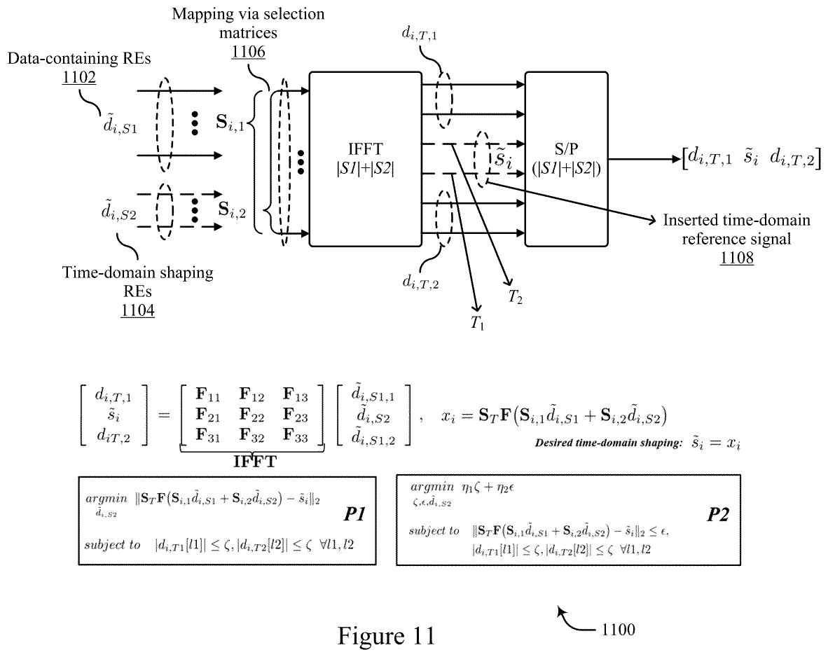

FIG. 11 illustrates another example of a multiplexing computation logic 1100, in accordance with aspects of the present disclosure. The multiplexing computation logic 1100 may be implemented as part of the multiplexing procedure 800 as described with reference to FIG. 8. Specifically, the multiplexing computation logic 1100 illustrates a method for obtaining the frequency domain REs belonging to the second set of resources S2.

The multiplexing computation logic 1100 includes data-containing REs 1102 that carry communication data using conventional modulation schemes and time-domain shaping REs 1104 that are computed to produce the time-domain signal pattern after IFFT processing. The data-containing REs 1102 correspond to the first resource set S1 and are represented as \tilde{d}_{1,S1}. The time-domain shaping REs 1104, represented as \tilde{d}_{i,S2}, correspond to the second set of resources S2 as described with reference to FIG. 8. The data-containing REs 1102 and the time-domain shaping REs 1104 are processed within the time window defined by an initial time point T1 and a final time point T2 to generate the shaped sensing signal. The time window between the initial time point T 1 and the final time point T2 may correspond to the portion of the transmission symbol where sensing signal shaping is applied. Thus, the first, second, and third periods of the sensing signal are within the time window [T₁, T₂].

The quantity of the time-domain shaping REs 1104 may or may not be equal to the quantity of time-domain signal samples associated with the time-domain signal pattern. The time-domain shaping REs 1104 can be positioned anywhere in the frequency resource grid of the IFFT block, such as in the middle, end, or start. Prior to IFFT processing, mapping via selection matrices 1106 is performed via selection matrices. The selection matrices S_{i,1}∈{0,1}^{(|S1|+|S2|)×|S1|} and S_{i,2}∈{0,1}^{(|S1|+|S2|)×|S2|} map the input symbols \tilde{d}_{i,S1} and \tilde{d}_{i,S2} symbols to the sets S1 and S2, respectively, within the input IFFT space. The selection matrix S_{T}∈{0,1}^{(|S1|+|S2|)×(T}^{₂}^{-T}^{₁}⁾ maps the output of the IFFT space to the vector of the time-domain signal samples intended for shaping between the time instances T₁ and T₂.

The processing chain from the time-domain shaping REs 1104 through the IFFT block and S/P conversion may generate an inserted time-domain reference signal 1108 that has the time-domain signal pattern. The inserted time-domain reference signal 1108 may represent the final time-domain signal output, e.g., as the sensing signal multiplexed with data.

FIG. 11 further illustrates two approaches for computing the \tilde{d}_{i,S2} symbols to shape the time-domain signal at the desired instances while minimizing the PAPR of the resulting time-domain signal sequence. In a first approach P1, a strategy is utilized that minimizes the Euclidean difference between resulting time-domain samples and the desired samples in the time window [T₁, T₂], while keeping the resulting time-domain samples below a given threshold amplitude to reduce PAPR. This problem follows the structure of a second-order cone program (SoCP) and can be solved optimally in polynomial time using interior point methods. In a second approach P2, a strategy is utilized that minimizes the Euclidean difference between resulting time-domain samples and the desired samples in the time window [T₁, T₂] with a significance weight η₁, while simultaneously minimizing the amplitude of the resulting time-domain samples with a significance weight η₂. This approach shapes the time-domain signal according to the desired values while reducing PAPR. The problem follows the structure of a second-order cone program (SoCP) and can be solved optimally in polynomial time using interior point methods.

In some examples, a sensing TX may determine which frequency domain resources are allocated to the data-containing REs 1102 and which resources are allocated to the time-domain shaping REs 1104 based on channel measurements, capability information, and/or system performance requirements. In some examples, the sensing TX may select the time-domain shaping REs 1104 according to one or more channel measurements that identify REs having channel responses that satisfy quality thresholds. The identified REs may, for example, have a relatively low channel quality. By selecting these identified REs as the time-domain shaping REs 1104, the sensing TX can utilize frequency domain resources with poor communication channel characteristics for sensing signal generation purposes. In some cases, the sensing TX may select the time-domain shaping REs 1104 based on one or more reports received from one or more sensing RXs that include channel quality indications corresponding to one or more candidate time-domain shaping REs 1104, or indications of candidate sets of frequency domain REs determined by the sensing RX (e.g., according to predefined selection criteria). Additionally, or alternatively, the sensing TX selects the time-domain shaping REs 1104 based on capability information associated with the sensing TX and/or the sensing RX, such as the sensing TX's computational capacity for time-domain shaping, the sensing TX's processing latency associated with time-domain shaping, or one or more threshold quantities of time-domain shaping REs 1104.

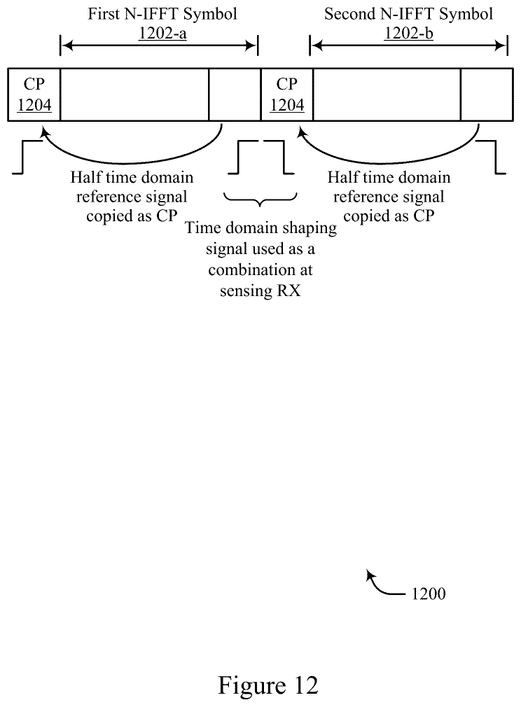

FIG. 12 illustrates an example of a symbol diagram 1200, in accordance with aspects of the present disclosure. In some examples, the symbol diagram 1200 implements or is implemented by aspects of the wireless communication system 100. For example, the symbol diagram 1200 illustrates an example of time-domain shaping of a sensing signal as described herein. The symbol diagram 1200 may include a first NFFT symbol 1202-a and a second NFFT symbol 1202-b that are arranged sequentially in time. A cyclic prefix 1204 may be associated with each NFFT symbol to provide protection against inter-symbol interference caused by multipath propagation effects in wireless channels.

The symbol diagram 1200 illustrates an example of a sensing signal deployment scenario. In some cases, the sensing signal is always generated at the end of time-domain samples of a CP-OFDM symbol, such as the first NFFT symbol 1202-a, where the length corresponds to a duration of the corresponding cyclic prefix 1204. In this case, the time-domain symbol carrying the sensing signal will also be copied at the start of the NFFT symbol 1202-a as the cyclic prefix 1204. This enables the sensing signal to be copied as part of the cyclic prefix 1204 of the second NFFT symbol 1202-b, which, in turn, provides two instances of the same sensing signal within the symbol diagram 1200, with one instance appearing at the end of the first NFFT symbol 1202-a and another instance appearing at the beginning of the second NFFT symbol 1202-b as part of the corresponding cyclic prefix 1204. Such a configuration may enhance sensing measurement reliability and accuracy by providing multiple opportunities for sensing target detection and measurement within each transmission interval while maintaining compatibility with existing cyclic prefix generation procedures and symbol timing requirements, e.g., without requiring a sensing node to adjust a slot/subframe format. Moreover, the cyclic prefix 1204 is no longer redundant, due to its use as the sensing signal.

In another example, when at least two adjacent CP-OFDM symbols—such as the N-IFFT symbols 1202—carry a shaped sensing signal, the time-domain symbol carrying the sensing signal can be generated so that half of the time-domain symbol is generated in the first N-IFFT symbol 1202-a and the other half in the adjacent symbol, e.g., in the second N-IFFT symbol 1202-b. When combined at a sensing RX, the N-IFFT symbols 1202 become a combination of two sensing signals generated across two CP-OFDM symbols. This can improve spectral efficiency by allowing longer sensing signals to be generated by dividing the corresponding resources across two symbols. The sensing TX may need to configure which portion of the sensing signal is generated for which N-IFFT symbol 1202. Alternatively, the sensing TX may generate the sensing signal according to a pre-defined pattern.

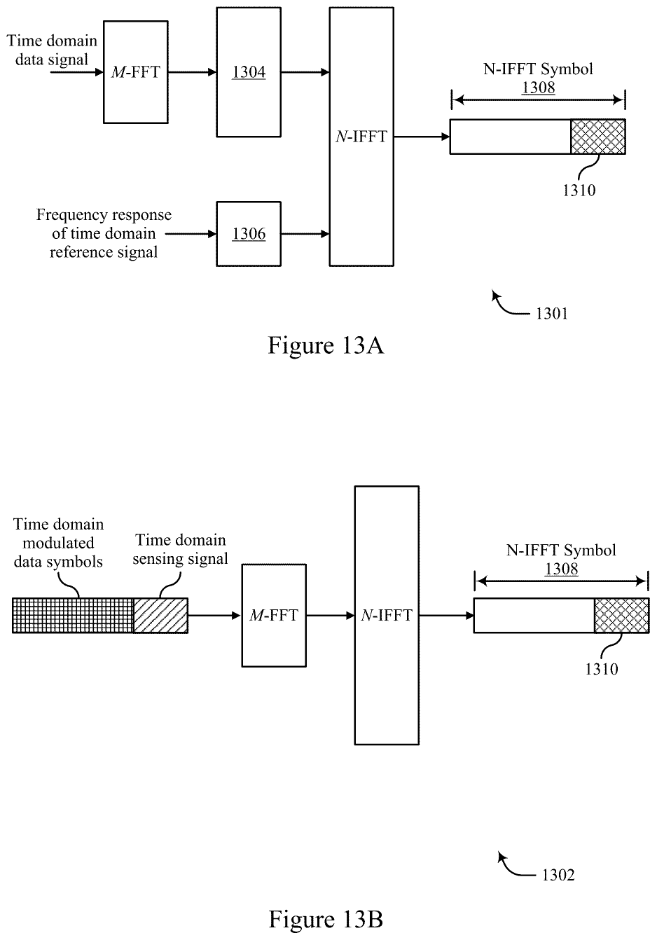

FIGS. 13A and 13B illustrate examples of waveform processing diagrams 1301 and 1302, respectively, in accordance with aspects of the present disclosure. The waveform processing diagrams 1301 and 1302 illustrate examples of time-domain shaping of a sensing signal, as described herein, via DFT-s-OFDM waveform processing. Specifically, FIG. 13A illustrates an example in which the sensing signal is shaped via frequency domain REs (e.g., time-domain shaping REs) at the pre-IFFT stage, while FIG. 13B illustrates an example in which the sensing signal is shaped at the pre-DFT stage, e.g., directly in the time-domain.

In the waveform processing diagrams 1301 and 1302, data to be multiplexed with the sensing signal is used as part of the optimization algorithm (e.g., as described with reference to FIGS. 8-11) to generate the weights for the sensing signal. For example, the data, generated in the time-domain, is converted to the frequency domain by applying FFT processing. The optimization algorithm is solved based on the frequency domain data, a frequency response of the time-domain sensing signal, and a selection matrix defining the mapping of data and sensing signal in the frequency domain. The resulting weights obtained from the optimization algorithm are applied to the frequency response of the sensing signal in the frequency domain. The data in the frequency domain and the weighted frequency-domain sensing signal are multiplexed (e.g., mapped) to the respective with the help of the selection matrix. IFFT processing is then applied, and the data samples and the sensing signal are generated in the time-domain.

For example, as illustrated in FIG. 13A, the waveform processing diagram 1301 may include a data selection mapping matrix 1304 that controls the allocation and mapping of data-containing frequency domain resources within the overall transmission symbol structure. The data selection mapping matrix 1304 may define which frequency domain REs are allocated for data symbols using data modulation schemes. A reference signal selection mapping matrix 1306 may control the allocation and mapping of frequency domain resources that are specifically computed to generate time-domain sensing signal characteristics after IFFT processing, e.g., time-domain shaping REs. The reference signal selection mapping matrix 1306 may coordinate with the data selection mapping matrix 1304 to ensure that data transmission resources and sensing signal generation resources are properly allocated within the same transmission symbol, e.g., the N-IFFT symbol 1308. As illustrated, the sensing signal occupies a portion 1310 of the N-IFFT symbol 1308.

The waveform processing diagram 1301 transforms time-domain data signals through FFT processing before applying the mapping matrices and IFFT processing to generate the final transmission symbol, e.g., the N-IFFT symbol 1308. Time-domain data signals may be input to an M-FFT block that performs FFT processing to convert the time-domain data signals into frequency domain representations suitable for mapping and resource allocation. The M-FFT block may process multiple input signals simultaneously to support MIMO transmission capabilities and spatial diversity techniques. The processed signals from the M-FFT block may be provided to an N-IFFT block that performs IFFT processing to generate time-domain transmission symbols according to a time-domain signal pattern. The N-IFFT block may process the combined frequency domain resources that include the both data-containing REs and the time-domain shaping REs (e.g., as determined by the data selection mapping matrix 1304 and the reference signal selection mapping matrix 1306). The IFFT processing may transform the frequency domain resource allocation into time-domain signal samples matching the time-domain signal pattern. The N-IFFT block generates the N-IFFT symbol 1308, which represents the final transmission symbol transmitted by the sensing TX. The N-IFFT symbol 1308 may contain both communication data and sensing signal components that are distributed across different portions of the symbol duration according to the resource allocation patterns defined by the mapping matrices.

In some examples, a time-domain signal pattern (e.g., corresponding to a sensing signal) may be associated with a first spatial transmission pattern while data signals to be multiplexed with the sensing signal may be associated with a second spatial transmission pattern different from the first spatial transmission pattern. This may provide independent beamforming control for sensing and communication functions. That is, multiplexed sensing signals and data signals may be transmitted with different beam directions, polarizations, or spatial characteristics. For example, when beamforming is performed in the baseband or digital domain, different spatial patterns may be applied to different portions of a single IFFT output. The process may begin by determining the time-domain shaping pattern, such as a pulse signal at the end of the IFFT block. A beam direction for precoding may be determined, such as an index of the discrete Fourier transform codebook for beamforming, for the determined time-domain signal pattern.

Precoding of the time-domain signal may be performed according to a desired or determined precoder or beam, where the beamforming is applied over the time-domain signal. Following this precoding operation, the desired time-domain signal at each antenna port becomes known. Separately, the values of the first set of frequency domain resources at each MIMO layer for transmission may be determined according to the data modulated for a data receiver, such as a downlink user equipment. Precoding may be performed over the MIMO layers of the first set of frequency resources to direct the data transmissions toward the optimal paths to data receivers via beamforming applied on each MIMO layer. After precoding, the values and content of the first set of frequency resources are known at each sensing TX antenna port.

Based on the computational logic, the desired time-domain pattern or shape may be generated for each antenna port by calculating the values of the REs of the second set of frequency domain resources as well as the values and content of the first set of REs. After this final stage, the desired time-domain signal has been generated and transmitted from each antenna port, where the desired time-domain signal at each port is the result of beamforming of the desired time-domain signal or shape. The transmission maintains both properties of beamforming of the desired portion of the time-domain signal and beamforming of the REs belonging to the first set of frequency domain resources for data transmission.

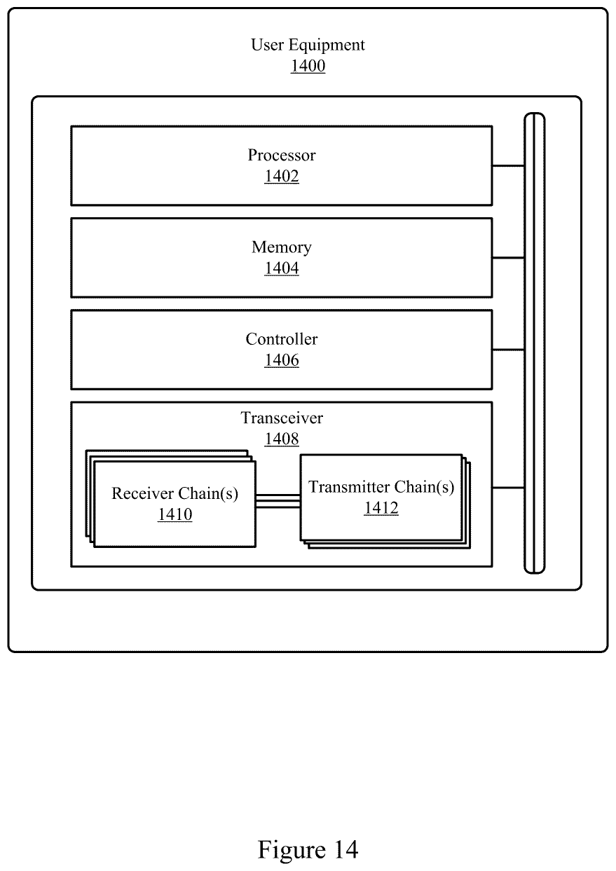

FIG. 14 illustrates an example of a UE 1400 in accordance with aspects of the present disclosure. The UE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a central processing unit (CPU), an ASIC, a field-programmable gate-array (FPGA), or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the UE 1400 to perform various functions of the present disclosure.

The memory 1404 may include volatile or non-volatile memory. The memory 1404 may store computer-readable, computer-executable code including instructions when executed by the processor 1402 cause the UE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the UE 1400 to perform one or more of the functions described herein (e.g., executing, by the processor 1402, instructions stored in the memory 1404). For example, the processor 1402 may support wireless communication at the UE 1400 in accordance with examples as disclosed herein. The UE 1400 may be configured to or operable to support a means for receiving a configuration for a sensing measurement procedure associated with a sensing signal having a first time period and a third time period that are associated with a low-power or ZP transmission state and a second time period that is associated with a high-power or NZP transmission state, receiving, in accordance with the configuration, the sensing signal during the first, second, and third time periods, and performing at least one sensing measurement on the sensing signal received during the second time period.

Additionally, the UE 1400 may be configured to support any one or combination of determining a ratio of an observed received SNR associated with a sensing target channel to a threshold SNR and transmitting a report indicating the ratio. Additionally, or alternatively, the UE 1400 may be configured to support determining one or more parameters for the sensing signal based on performing one or more measurements associated with the sensing measurement procedure and transmitting a report indicating the one or more parameters, where the configuration is received based on the report.

Additionally, or alternatively, the UE 1400 may be configured to or operable to support a means for determining one or more parameters of a time-domain signal pattern of a sensing signal, where the time-domain signal pattern defines signal characteristics subsequent to IFFT processing of frequency domain resources, selecting a first set of REs of the frequency domain resources allocated for transmission, by the device, of data symbols using a data modulation scheme, selecting a second set of REs of the frequency domain resources allocated for generation of the time-domain signal pattern, calculating values for the second set of REs to produce the time-domain signal pattern based on the data symbols in the first set of REs, the time-domain signal pattern, IFFT block dimensions, a location of the second set of REs within an IFFT input, or some combination thereof, generating the sensing signal having the time-domain signal pattern by performing the IFFT processing of the frequency domain resources including the first set of REs and the second set of REs, and transmitting the sensing signal.

Additionally, the UE 1400 may be configured to support any one or combination of determining a resource allocation pattern that includes one or more of a starting RE position or PRB position, a quantity of consecutive REs or PRBs, a frequency domain spacing between REs or PRBs, a bitmap indicating the second set of REs, or an index referencing preconfigured frequency domain resources. Additionally, or alternatively, the UE 1400 may be configured to support performing one or more channel measurements and selecting, for the second set of REs, REs having channel responses that satisfy a quality threshold. Additionally, or alternatively, the UE 1400 may be configured to support selecting the second set of REs based on capability information of the device, the capability information including one or more of a computational capacity for time-domain shaping, a processing latency associated with time-domain shaping, or a threshold quantity of time-domain shaping REs. Additionally, or alternatively, the UE 1400 may be configured to support transmitting, to a sensing configuration entity, the capability information and receiving, from the sensing configuration entity, an indication of the one or more parameters. Additionally, or alternatively, the UE 1400 may be configured to support transmitting, to a receiver device or a configuration node, an indication of the one or more parameters, an indication of the second set of REs, or both. Additionally, or alternatively, the UE 1400 may be configured to support receiving, from a receiver device, a report that includes a channel quality indication corresponding to the second set of REs or an indication of a candidate set of frequency domain REs determined by the receiver device according to predefined selection criteria and selecting the second set of REs based on the report. Additionally, or alternatively, the UE 1400 may be configured to support a quantity of REs in the second set of REs corresponding to a quantity of time-domain samples defining the time-domain signal pattern. Additionally, or alternatively, the UE 1400 may be configured to support the time-domain signal pattern including one or more of a pulse pattern having one or more ZP periods and at least one NZP period, an isolated ZP period, a pattern associated with reduction of a PAPR of the sensing signal, or some combination thereof. Additionally, or alternatively, the UE 1400 may be configured to support the sensing signal being transmitted within a portion of a symbol and having a QCL relationship with frequency domain resources of a second signal that are precoded according to a same spatial pattern as the portion of the symbol. Additionally, or alternatively, the UE 1400 may be configured to support the frequency domain resources of the second signal including data REs or DMRS REs, and transmitting an indication of the QCL relationship to a receiver device. Additionally, or alternatively, the UE 1400 may be configured to support the time-domain signal pattern being associated with a first spatial transmission pattern and the first set of REs being associated with a second spatial transmission pattern different from the first spatial transmission pattern. Additionally, or alternatively, the UE 1400 may be configured to support the time-domain signal pattern spanning one or more transmission symbols or a portion of a transmission symbol.

Additionally, or alternatively, the UE 1400 may be configured to or operable to support a means for receiving a sensing signal having a time-domain signal pattern that defines signal characteristics subsequent to IFFT processing of frequency domain resources of the sensing signal, where the frequency domain resources include at least a first set of REs allocated for data symbols using a data modulation scheme and a second set of REs allocated for generation of the time-domain signal pattern, obtaining the data symbols from the first set of REs by performing FFT processing on the sensing signal, and performing one or more measurements using the sensing signal based on the time-domain signal pattern.

Additionally, the UE 1400 may be configured to support any one or combination of receiving a configuration indicating the second set of REs and one or more time-domain shaping parameters associated with the sensing signal. Additionally, or alternatively, the UE 1400 may be configured to support performing CSI estimation based on the configuration. Additionally, or alternatively, the UE 1400 may be configured to support the sensing signal including one or more ZP time periods and at least one NZP time period, and applying different AGC states during different time periods of the sensing signal according to the time-domain signal pattern. Additionally, or alternatively, the UE 1400 may be configured to support performing rate matching around the second set of REs. Additionally, or alternatively, the UE 1400 may be configured to support transmitting a report that includes a channel quality indication corresponding to the second set of REs or an indication of a candidate set of frequency domain REs determined according to predefined selection criteria.

Additionally, or alternatively, the UE 1400 may support at least one memory (e.g., the memory 1404) and at least one processor (e.g., the processor 1402) coupled with the at least one memory and configured to cause the UE to receive a configuration for a sensing measurement procedure associated with a sensing signal having a first time period and a third time period that are associated with a low-power or ZP transmission state and a second time period that is associated with a high-power or NZP transmission state, receive, in accordance with the configuration, the sensing signal during the first, second, and third time periods, and perform at least one sensing measurement on the sensing signal received during the second time period.

Additionally, the UE 1400 may be configured to support any one or combination of determining a ratio of an observed received SNR associated with a sensing target channel to a threshold SNR and transmitting a report indicating the ratio. Additionally, or alternatively, the UE 1400 may be configured to support determining one or more parameters for the sensing signal based on performing one or more measurements associated with the sensing measurement procedure and transmitting a report indicating the one or more parameters, where the configuration is received based on the report.

Additionally, or alternatively, the UE 1400 may support at least one memory (e.g., the memory 1404) and at least one processor (e.g., the processor 1402) coupled with the at least one memory and configured to cause the UE to determine one or more parameters of a time-domain signal pattern of a sensing signal, where the time-domain signal pattern defines signal characteristics subsequent to IFFT processing of frequency domain resources, select a first set of REs of the frequency domain resources allocated for transmission, by the device, of data symbols using a data modulation scheme, select a second set of REs of the frequency domain resources allocated for generation of the time-domain signal pattern, calculate values for the second set of REs to produce the time-domain signal pattern based on the data symbols in the first set of REs, the time-domain signal pattern, IFFT block dimensions, a location of the second set of REs within an IFFT input, or some combination thereof, generate the sensing signal having the time-domain signal pattern by performing the IFFT processing of the frequency domain resources including the first set of REs and the second set of REs, and transmit the sensing signal.

Additionally, the UE 1400 may be configured to support any one or combination of determining a resource allocation pattern that includes one or more of a starting RE position or PRB position, a quantity of consecutive REs or PRBs, a frequency domain spacing between REs or PRBs, a bitmap indicating the second set of REs, or an index referencing preconfigured frequency domain resources. Additionally, or alternatively, the UE 1400 may be configured to support performing one or more channel measurements and selecting, for the second set of REs, REs having channel responses that satisfy a quality threshold. Additionally, or alternatively, the UE 1400 may be configured to support selecting the second set of REs based on capability information of the device, the capability information including one or more of a computational capacity for time-domain shaping, a processing latency associated with time-domain shaping, or a threshold quantity of time-domain shaping REs. Additionally, or alternatively, the UE 1400 may be configured to support transmitting, to a sensing configuration entity, the capability information and receiving, from the sensing configuration entity, an indication of the one or more parameters. Additionally, or alternatively, the UE 1400 may be configured to support transmitting, to a receiver device or a configuration node, an indication of the one or more parameters, an indication of the second set of REs, or both. Additionally, or alternatively, the UE 1400 may be configured to support receiving, from a receiver device, a report that includes a channel quality indication corresponding to the second set of REs or an indication of a candidate set of frequency domain REs determined by the receiver device according to predefined selection criteria and selecting the second set of REs based on the report. Additionally, or alternatively, the UE 1400 may be configured to support a quantity of REs in the second set of REs corresponding to a quantity of time-domain samples defining the time-domain signal pattern. Additionally, or alternatively, the UE 1400 may be configured to support the time-domain signal pattern including one or more of a pulse pattern having one or more ZP periods and at least one NZP period, an isolated ZP period, a pattern associated with reduction of a PAPR of the sensing signal, or some combination thereof. Additionally, or alternatively, the UE 1400 may be configured to support the sensing signal being transmitted within a portion of a symbol and having a QCL relationship with frequency domain resources of a second signal that are precoded according to a same spatial pattern as the portion of the symbol. Additionally, or alternatively, the UE 1400 may be configured to support the frequency domain resources of the second signal including data REs or DMRS REs, and transmitting an indication of the QCL relationship to a receiver device. Additionally, or alternatively, the UE 1400 may be configured to support the time-domain signal pattern being associated with a first spatial transmission pattern and the first set of REs being associated with a second spatial transmission pattern different from the first spatial transmission pattern. Additionally, or alternatively, the UE 1400 may be configured to support the time-domain signal pattern spanning one or more transmission symbols or a portion of a transmission symbol.

Additionally, or alternatively, the UE 1400 may support at least one memory (e.g., the memory 1404) and at least one processor (e.g., the processor 1402) coupled with the at least one memory and configured to cause the UE to receive a sensing signal having a time-domain signal pattern that defines signal characteristics subsequent to IFFT processing of frequency domain resources of the sensing signal, where the frequency domain resources include at least a first set of REs allocated for data symbols using a data modulation scheme and a second set of REs allocated for generation of the time-domain signal pattern, obtain the data symbols from the first set of REs by performing FFT processing on the sensing signal, and perform one or more measurements using the sensing signal based on the time-domain signal pattern.

Additionally, the UE 1400 may be configured to support any one or combination of receiving a configuration indicating the second set of REs and one or more time-domain shaping parameters associated with the sensing signal. Additionally, or alternatively, the UE 1400 may be configured to support performing CSI estimation based on the configuration. Additionally, or alternatively, the UE 1400 may be configured to support the sensing signal including one or more ZP time periods and at least one NZP time period, and applying different AGC states during different time periods of the sensing signal according to the time-domain signal pattern. Additionally, or alternatively, the UE 1400 may be configured to support performing rate matching around the second set of REs. Additionally, or alternatively, the UE 1400 may be configured to support transmitting a report that includes a channel quality indication corresponding to the second set of REs or an indication of a candidate set of frequency domain REs determined according to predefined selection criteria.

The controller 1406 may manage input and output signals for the UE 1400. The controller 1406 may also manage peripherals not integrated into the UE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the UE 1400 may include at least one transceiver 1408. In some other implementations, the UE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

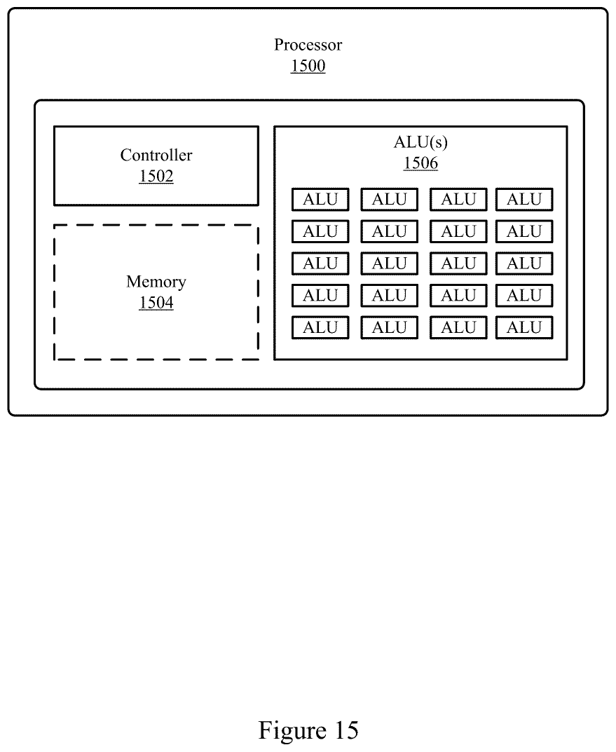

FIG. 15 illustrates an example of a processor 1500 in accordance with aspects of the present disclosure. The processor 1500 may be an example of a processor configured to perform various operations in accordance with examples as described herein. The processor 1500 may include a controller 1502 configured to perform various operations in accordance with examples as described herein. The processor 1500 may optionally include at least one memory 1504, which may be, for example, an L1/L2/L3 cache. Additionally, or alternatively, the processor 1500 may optionally include one or more arithmetic-logic units (ALUs) 1506. One or more of these components may be in electronic communication or otherwise coupled (e.g., operatively, communicatively, functionally, electronically, electrically) via one or more interfaces (e.g., buses).

The processor 1500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1502 may be configured to manage and coordinate various operations (e.g., signaling, receiving, obtaining, retrieving, transmitting, outputting, forwarding, storing, determining, identifying, accessing, writing, reading) of the processor 1500 to cause the processor 1500 to support various operations in accordance with examples as described herein. For example, the controller 1502 may operate as a control unit of the processor 1500, generating control signals that manage the operation of various components of the processor 1500. These control signals include enabling or disabling functional units, selecting data paths, initiating memory access, and coordinating timing of operations.

The controller 1502 may be configured to fetch (e.g., obtain, retrieve, receive) instructions from the memory 1504 and determine subsequent instruction(s) to be executed to cause the processor 1500 to support various operations in accordance with examples as described herein. The controller 1502 may be configured to track memory addresses of instructions associated with the memory 1504. The controller 1502 may be configured to decode instructions to determine the operation to be performed and the operands involved. For example, the controller 1502 may be configured to interpret the instruction and determine control signals to be output to other components of the processor 1500 to cause the processor 1500 to support various operations in accordance with examples as described herein. Additionally, or alternatively, the controller 1502 may be configured to manage flow of data within the processor 1500. The controller 1502 may be configured to control transfer of data between registers, ALUs 1506, and other functional units of the processor 1500.

The memory 1504 may include one or more caches (e.g., memory local to or included in the processor 1500 or other memory, such as RAM, ROM, DRAM, SDRAM, SRAM, MRAM, flash memory, etc. In some implementations, the memory 1504 may reside within or on a processor chipset (e.g., local to the processor 1500). In some other implementations, the memory 1504 may reside external to the processor chipset (e.g., remote to the processor 1500).

The memory 1504 may store computer-readable, computer-executable code including instructions that, when executed by the processor 1500, cause the processor 1500 to perform various functions described herein. The code may be stored in a non-transitory computer-readable medium such as system memory or another type of memory. The controller 1502 and/or the processor 1500 may be configured to execute computer-readable instructions stored in the memory 1504 to cause the processor 1500 to perform various functions. For example, the processor 1500 and/or the controller 1502 may be coupled with or to the memory 1504, the processor 1500, and the controller 1502, and may be configured to perform various functions described herein. In some examples, the processor 1500 may include multiple processors and the memory 1504 may include multiple memories. One or more of the multiple processors may be coupled with one or more of the multiple memories, which may, individually or collectively, be configured to perform various functions herein.

The one or more ALUs 1506 may be configured to support various operations in accordance with examples as described herein. In some implementations, the one or more ALUs 1506 may reside within or on a processor chipset (e.g., the processor 1500). In some other implementations, the one or more ALUs 1506 may reside external to the processor chipset (e.g., the processor 1500). One or more ALUs 1506 may perform one or more computations such as addition, subtraction, multiplication, and division on data. For example, one or more ALUs 1506 may receive input operands and an operation code, which determines an operation to be executed. One or more ALUs 1506 may be configured with a variety of logical and arithmetic circuits, including adders, subtractors, shifters, and logic gates, to process and manipulate the data according to the operation. Additionally, or alternatively, the one or more ALUs 1506 may support logical operations such as AND, OR, exclusive-OR (XOR), not-OR (NOR), and not-AND (NAND), enabling the one or more ALUs 1506 to handle conditional operations, comparisons, and bitwise operations.

The processor 1500 may support wireless communication in accordance with examples as disclosed herein. The processor 1500 may be configured to or operable to support at least one controller (e.g., the controller 1502) coupled with at least one memory (e.g., the memory 1504) and configured to cause the processor to determine a configuration for a sensing measurement procedure associated with a sensing signal having a first time period and a third time period that are associated with a low-power or ZP transmission state and a second time period that is associated with a high-power or NZP transmission state, select, based on the configuration, respective parameters for each of the first time period, the second time period, and the third time period, the respective parameters including one or more of a start time, a duration, a power level, or a time-domain sequence, generate the sensing signal according to the configuration and the respective parameters, and transmit the sensing signal during the first, second, and third time periods according to the respective power levels.

Additionally, the processor 1500 may be configured to support any one or combination of receiving an indication of one or more of the respective parameters from at least one second device that is acting as a sensing RX node or a sensing controller entity. Additionally, or alternatively, the processor 1500 may be configured to support the respective parameters being selected based on one or more of capability information associated with at least one second device that is acting as a sensing RX node, an energy, delay, angle, or doppler difference between a sensing target and environment clutter, an observed sensing target SNR at the at least one second device, a threshold sensing target SNR at the at least one second device, a delay or angle of one or more paths interfering with the sensing signal, geometry information that includes positions of one or more sensing TX devices and the at least one second device, radar cross-section information of a sensing target, a transmitter-receiver switching time associated with the at least one second device, a measurement quantity type or a measurement quantity resolution or accuracy to be generated by the at least one second device upon reception of the sensing signal, channel statistics of a channel of the sensing signal, a type of the sensing measurement procedure, or a self-interference isolation level associated with a sensing TX node and a sensing RX node. Additionally, or alternatively, the processor 1500 may be configured to support transmitting the respective parameters to a second device that is acting as a sensing TX node. Additionally, or alternatively, the processor 1500 may be configured to support performing reception and measurement of the sensing signal according to the respective parameters. Additionally, or alternatively, the processor 1500 may be configured to support the configuration including at least one of a sensing target area, a sensing target type, a sensing TX node location, or a sensing RX node location. Additionally, or alternatively, the processor 1500 may be configured to support the power level of the first time period and the third time period being the same and being defined jointly according to a ratio relative to the power level of the second time period, or the first time period, the second time period, and the third time period each including one or more distinct time-domain symbols, guard intervals, slots, subframes, or a combination thereof, according to a sensing signal frame structure. Additionally, or alternatively, the processor 1500 may be configured to support the first time period and the third time period being embedded within a same symbol, within a same cyclic prefix, or a combination thereof, the duration of the first time period being based on a threshold delay difference from a first arrival path for a target decibel isolation value, the duration of the third time period being equal to the duration of the second time period plus a threshold expected delay of a path associated with a sensing target, at least one of the first time period or the third time period being defined, as part of a slot format or a subframe format, as ZP periods within a symbol, a guard band, or a zero-interval outside of a symbol or guard-band period, or a cyclic prefix, a guard band, or a unique word being defined as a ZP or low-power sequence and being utilized as the first time period or the third time period. Additionally, or alternatively, the processor 1500 may be configured to support updating at least one of a symbol format, a cyclic prefix format, or a slot format according to a predefined pattern based on the respective parameters. Additionally, or alternatively, the processor 1500 may be configured to support allocating, when the second time period is within an uplink symbol or a cyclic prefix of an uplink symbol, the third time period to a downlink symbol, or allocating, when the second time period is within a downlink symbol or a cyclic prefix of a downlink symbol, the third time period to an uplink symbol. Additionally, or alternatively, the processor 1500 may be configured to support the power level of the second time period being based on a previous transmission instance and an associated measurement, an associated processing gain value, and a target SNR value, or the duration of the second time period being based on a delay difference between a sensing target path and a background channel, minus a threshold relative path delay for a target decibel isolation value. Additionally, or alternatively, the processor 1500 may be configured to support determining signal shaping parameters based on a group report, group capability information, or location information of a group of sensing RX nodes. Additionally, or alternatively, the processor 1500 may be configured to support one or more of the signal shaping parameters corresponding to one or more indexes of a codebook. Additionally, or alternatively, the processor 1500 may be configured to support rows of the codebook indicating repetition patterns for repetitions of the sensing signal, each repetition pattern associated with a respective periodicity and a respective quantity of repetitions. Additionally, or alternatively, the processor 1500 may be configured to support each repetition pattern including a distance-dependent signal shaping parameter that jointly defines at least one of the duration of the second time period or the duration of the third time period and at least one of the quantity of repetitions or the periodicity. Additionally, or alternatively, the processor 1500 may be configured to support adjusting the power level of the second time period based on feedback indicating a ratio between an observed SNR and a threshold SNR for the sensing measurement procedure.

Additionally, or alternatively, the processor 1500 may be configured to or operable to support at least one controller (e.g., the controller 1502) coupled with at least one memory (e.g., the memory 1504) and configured to cause the processor to receive a configuration for a sensing measurement procedure associated with a sensing signal having a first time period and a third time period that are associated with a low-power or ZP transmission state and a second time period that is associated with a high-power or NZP transmission state, receive, in accordance with the configuration, the sensing signal during the first, second, and third time periods, and perform at least one sensing measurement on the sensing signal received during the second time period.

Additionally, the processor 1500 may be configured to support any one or combination of determining a ratio of an observed received SNR associated with a sensing target channel to a threshold SNR and transmitting a report indicating the ratio. Additionally, or alternatively, the processor 1500 may be configured to support determining one or more parameters for the sensing signal based on performing one or more measurements associated with the sensing measurement procedure and transmitting a report indicating the one or more parameters, where the configuration is received based on the report.

Additionally, or alternatively, the processor 1500 may be configured to or operable to support at least one controller (e.g., the controller 1502) coupled with at least one memory (e.g., the memory 1504) and configured to cause the processor to determine one or more parameters of a time-domain signal pattern of a sensing signal, where the time-domain signal pattern defines signal characteristics subsequent to IFFT processing of frequency domain resources, select a first set of REs of the frequency domain resources allocated for transmission, by the device, of data symbols using a data modulation scheme, select a second set of REs of the frequency domain resources allocated for generation of the time-domain signal pattern, calculate values for the second set of REs to produce the time-domain signal pattern based on the data symbols in the first set of REs, the time-domain signal pattern, IFFT block dimensions, a location of the second set of REs within an IFFT input, or some combination thereof, generate the sensing signal having the time-domain signal pattern by performing the IFFT processing of the frequency domain resources including the first set of REs and the second set of REs, and transmit the sensing signal.

Additionally, the processor 1500 may be configured to support any one or combination of determining a resource allocation pattern that includes one or more of a starting RE position or PRB position, a quantity of consecutive REs or PRBs, a frequency domain spacing between REs or PRBs, a bitmap indicating the second set of REs, or an index referencing preconfigured frequency domain resources. Additionally, or alternatively, the processor 1500 may be configured to support performing one or more channel measurements and selecting, for the second set of REs, REs having channel responses that satisfy a quality threshold. Additionally, or alternatively, the processor 1500 may be configured to support selecting the second set of REs based on capability information of the device, the capability information including one or more of a computational capacity for time-domain shaping, a processing latency associated with time-domain shaping, or a threshold quantity of time-domain shaping REs. Additionally, or alternatively, the processor 1500 may be configured to support transmitting, to a sensing configuration entity, the capability information and receiving, from the sensing configuration entity, an indication of the one or more parameters. Additionally, or alternatively, the processor 1500 may be configured to support transmitting, to a receiver device or a configuration node, an indication of the one or more parameters, an indication of the second set of REs, or both. Additionally, or alternatively, the processor 1500 may be configured to support receiving, from a receiver device, a report that includes a channel quality indication corresponding to the second set of REs or an indication of a candidate set of frequency domain REs determined by the receiver device according to predefined selection criteria and selecting the second set of REs based on the report. Additionally, or alternatively, the processor 1500 may be configured to support a quantity of REs in the second set of REs corresponding to a quantity of time-domain samples defining the time-domain signal pattern. Additionally, or alternatively, the processor 1500 may be configured to support the time-domain signal pattern including one or more of a pulse pattern having one or more ZP periods and at least one NZP period, an isolated ZP period, a pattern associated with reduction of a PAPR of the sensing signal, or some combination thereof. Additionally, or alternatively, the processor 1500 may be configured to support the sensing signal being transmitted within a portion of a symbol and having a QCL relationship with frequency domain resources of a second signal that are precoded according to a same spatial pattern as the portion of the symbol. Additionally, or alternatively, the processor 1500 may be configured to support the frequency domain resources of the second signal including data REs or DMRS REs, and transmitting an indication of the QCL relationship to a receiver device. Additionally, or alternatively, the processor 1500 may be configured to support the time-domain signal pattern being associated with a first spatial transmission pattern and the first set of REs being associated with a second spatial transmission pattern different from the first spatial transmission pattern. Additionally, or alternatively, the processor 1500 may be configured to support the time-domain signal pattern spanning one or more transmission symbols or a portion of a transmission symbol.

Additionally, or alternatively, the processor 1500 may be configured to or operable to support at least one controller (e.g., the controller 1502) coupled with at least one memory (e.g., the memory 1504) and configured to cause the processor to receive a sensing signal having a time-domain signal pattern that defines signal characteristics subsequent to IFFT processing of frequency domain resources of the sensing signal, where the frequency domain resources include at least a first set of REs allocated for data symbols using a data modulation scheme and a second set of REs allocated for generation of the time-domain signal pattern, obtain the data symbols from the first set of REs by performing FFT processing on the sensing signal, and perform one or more measurements using the sensing signal based on the time-domain signal pattern.

Additionally, the processor 1500 may be configured to support any one or combination of receiving a configuration indicating the second set of REs and one or more time-domain shaping parameters associated with the sensing signal. Additionally, or alternatively, the processor 1500 may be configured to support performing CSI estimation based on the configuration. Additionally, or alternatively, the processor 1500 may be configured to support the sensing signal including one or more ZP time periods and at least one NZP time period, and applying different AGC states during different time periods of the sensing signal according to the time-domain signal pattern. Additionally, or alternatively, the processor 1500 may be configured to support performing rate matching around the second set of REs. Additionally, or alternatively, the processor 1500 may be configured to support transmitting a report that includes a channel quality indication corresponding to the second set of REs or an indication of a candidate set of frequency domain REs determined according to predefined selection criteria.

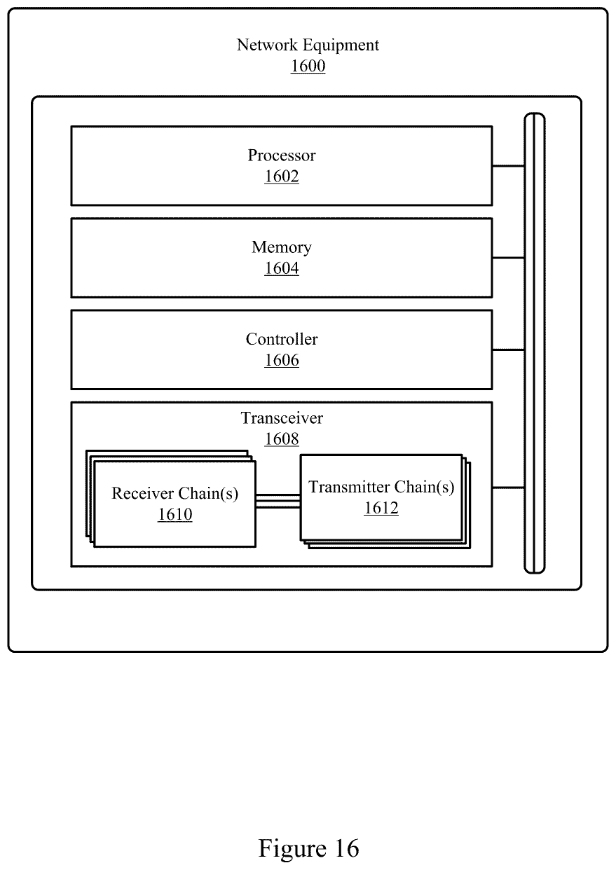

FIG. 16 illustrates an example of an NE 1600 in accordance with aspects of the present disclosure. The NE 1600 may include a processor 1602, a memory 1604, a controller 1606, and a transceiver 1608. The processor 1602, the memory 1604, the controller 1606, or the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, or the transceiver 1608, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the NE 1600 to perform various functions of the present disclosure.

The memory 1604 may include volatile or non-volatile memory. The memory 1604 may store computer-readable, computer-executable code including instructions when executed by the processor 1602 cause the NE 1600 to perform various functions described herein. The code may be stored in a non-transitory computer-readable medium such as the memory 1604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1602 and the memory 1604 coupled with the processor 1602 may be configured to cause the NE 1600 to perform one or more of the functions described herein (e.g., executing, by the processor 1602, instructions stored in the memory 1604). For example, the processor 1602 may support wireless communication at the NE 1600 in accordance with examples as disclosed herein. The NE 1600 may be configured to or operable to support a means for determining a configuration for a sensing measurement procedure associated with a sensing signal having a first time period and a third time period that are associated with a low-power or ZP transmission state and a second time period that is associated with a high-power or NZP transmission state, selecting, based on the configuration, respective parameters for each of the first time period, the second time period, and the third time period, the respective parameters including one or more of a start time, a duration, a power level, or a time-domain sequence, generating the sensing signal according to the configuration and the respective parameters, and transmitting the sensing signal during the first, second, and third time periods according to the respective power levels.

Additionally, the NE 1600 may be configured to support any one or combination of receiving an indication of one or more of the respective parameters from at least one second device that is acting as a sensing RX node or a sensing controller entity. Additionally, or alternatively, the NE 1600 may be configured to support the respective parameters being selected based on one or more of capability information associated with at least one second device that is acting as a sensing RX node, an energy, delay, angle, or doppler difference between a sensing target and environment clutter, an observed sensing target SNR at the at least one second device, a threshold sensing target SNR at the at least one second device, a delay or angle of one or more paths interfering with the sensing signal, geometry information that includes positions of one or more sensing TX devices and the at least one second device, radar cross-section information of a sensing target, a transmitter-receiver switching time associated with the at least one second device, a measurement quantity type or a measurement quantity resolution or accuracy to be generated by the at least one second device upon reception of the sensing signal, channel statistics of a channel of the sensing signal, a type of the sensing measurement procedure, or a self-interference isolation level associated with a sensing TX node and a sensing RX node. Additionally, or alternatively, the NE 1600 may be configured to support transmitting the respective parameters to a second device that is acting as a sensing TX node. Additionally, or alternatively, the NE 1600 may be configured to support performing reception and measurement of the sensing signal according to the respective parameters. Additionally, or alternatively, the NE 1600 may be configured to support the configuration including at least one of a sensing target area, a sensing target type, a sensing TX node location, or a sensing RX node location. Additionally, or alternatively, the NE 1600 may be configured to support the power level of the first time period and the third time period being the same and being defined jointly according to a ratio relative to the power level of the second time period, or the first time period, the second time period, and the third time period each including one or more distinct time-domain symbols, guard intervals, slots, subframes, or a combination thereof, according to a sensing signal frame structure. Additionally, or alternatively, the NE 1600 may be configured to support the first time period and the third time period being embedded within a same symbol, within a same cyclic prefix, or a combination thereof, the duration of the first time period being based on a threshold delay difference from a first arrival path for a target decibel isolation value, the duration of the third time period being equal to the duration of the second time period plus a threshold expected delay of a path associated with a sensing target, at least one of the first time period or the third time period being defined, as part of a slot format or a subframe format, as ZP periods within a symbol, a guard band, or a zero-interval outside of a symbol or guard-band period, or a cyclic prefix, a guard band, or a unique word being defined as a ZP or low-power sequence and being utilized as the first time period or the third time period. Additionally, or alternatively, the NE 1600 may be configured to support updating at least one of a symbol format, a cyclic prefix format, or a slot format according to a predefined pattern based on the respective parameters. Additionally, or alternatively, the NE 1600 may be configured to support allocating, when the second time period is within an uplink symbol or a cyclic prefix of an uplink symbol, the third time period to a downlink symbol, or allocating, when the second time period is within a downlink symbol or a cyclic prefix of a downlink symbol, the third time period to an uplink symbol. Additionally, or alternatively, the NE 1600 may be configured to support the power level of the second time period being based on a previous transmission instance and an associated measurement, an associated processing gain value, and a target SNR value, or the duration of the second time period being based on a delay difference between a sensing target path and a background channel, minus a threshold relative path delay for a target decibel isolation value. Additionally, or alternatively, the NE 1600 may be configured to support determining signal shaping parameters based on a group report, group capability information, or location information of a group of sensing RX nodes. Additionally, or alternatively, the NE 1600 may be configured to support one or more of the signal shaping parameters corresponding to one or more indexes of a codebook. Additionally, or alternatively, the NE 1600 may be configured to support rows of the codebook indicating repetition patterns for repetitions of the sensing signal, each repetition pattern associated with a respective periodicity and a respective quantity of repetitions. Additionally, or alternatively, the NE 1600 may be configured to support each repetition pattern including a distance-dependent signal shaping parameter that jointly defines at least one of the duration of the second time period or the duration of the third time period and at least one of the quantity of repetitions or the periodicity. Additionally, or alternatively, the NE 1600 may be configured to support adjusting the power level of the second time period based on feedback indicating a ratio between an observed SNR and a threshold SNR for the sensing measurement procedure.

Additionally, or alternatively, the NE 1600 may be configured to or operable to support a means for receiving a configuration for a sensing measurement procedure associated with a sensing signal having a first time period and a third time period that are associated with a low-power or ZP transmission state and a second time period that is associated with a high-power or NZP transmission state, receiving, in accordance with the configuration, the sensing signal during the first, second, and third time periods, and performing at least one sensing measurement on the sensing signal received during the second time period.

Additionally, the NE 1600 may be configured to support any one or combination of determining a ratio of an observed received SNR associated with a sensing target channel to a threshold SNR and transmitting a report indicating the ratio. Additionally, or alternatively, the NE 1600 may be configured to support determining one or more parameters for the sensing signal based on performing one or more measurements associated with the sensing measurement procedure and transmitting a report indicating the one or more parameters, where the configuration is received based on the report.

Additionally, or alternatively, the NE 1600 may be configured to or operable to support a means for determining one or more parameters of a time-domain signal pattern of a sensing signal, where the time-domain signal pattern defines signal characteristics subsequent to IFFT processing of frequency domain resources, selecting a first set of REs of the frequency domain resources allocated for transmission, by the device, of data symbols using a data modulation scheme, selecting a second set of REs of the frequency domain resources allocated for generation of the time-domain signal pattern, calculating values for the second set of REs to produce the time-domain signal pattern based on the data symbols in the first set of REs, the time-domain signal pattern, IFFT block dimensions, a location of the second set of REs within an IFFT input, or some combination thereof, generating the sensing signal having the time-domain signal pattern by performing the IFFT processing of the frequency domain resources including the first set of REs and the second set of REs, and transmitting the sensing signal.

Additionally, the NE 1600 may be configured to support any one or combination of determining a resource allocation pattern that includes one or more of a starting RE position or PRB position, a quantity of consecutive REs or PRBs, a frequency domain spacing between REs or PRBs, a bitmap indicating the second set of REs, or an index referencing preconfigured frequency domain resources. Additionally, or alternatively, the NE 1600 may be configured to support performing one or more channel measurements and selecting, for the second set of REs, REs having channel responses that satisfy a quality threshold. Additionally, or alternatively, the NE 1600 may be configured to support selecting the second set of REs based on capability information of the device, the capability information including one or more of a computational capacity for time-domain shaping, a processing latency associated with time-domain shaping, or a threshold quantity of time-domain shaping REs. Additionally, or alternatively, the NE 1600 may be configured to support transmitting, to a sensing configuration entity, the capability information, and receiving, from the sensing configuration entity, an indication of the one or more parameters. Additionally, or alternatively, the NE 1600 may be configured to support transmitting, to a receiver device or a configuration node, an indication of the one or more parameters, an indication of the second set of REs, or both. Additionally, or alternatively, the NE 1600 may be configured to support receiving, from a receiver device, a report that includes a channel quality indication corresponding to the second set of REs or an indication of a candidate set of frequency domain REs determined by the receiver device according to predefined selection criteria, and selecting the second set of REs based on the report. Additionally, or alternatively, the NE 1600 may be configured to support a quantity of REs in the second set of REs corresponding to a quantity of time-domain samples defining the time-domain signal pattern. Additionally, or alternatively, the NE 1600 may be configured to support the time-domain signal pattern including one or more of a pulse pattern having one or more ZP periods and at least one NZP period, an isolated ZP period, a pattern associated with reduction of a PAPR of the sensing signal, or some combination thereof. Additionally, or alternatively, the NE 1600 may be configured to support the sensing signal being transmitted within a portion of a symbol and having a QCL relationship with frequency domain resources of a second signal that are precoded according to a same spatial pattern as the portion of the symbol. Additionally, or alternatively, the NE 1600 may be configured to support the frequency domain resources of the second signal including data REs or DMRS REs, and transmitting an indication of the QCL relationship to a receiver device. Additionally, or alternatively, the NE 1600 may be configured to support the time-domain signal pattern being associated with a first spatial transmission pattern and the first set of REs being associated with a second spatial transmission pattern different from the first spatial transmission pattern. Additionally, or alternatively, the NE 1600 may be configured to support the time-domain signal pattern spanning one or more transmission symbols or a portion of a transmission symbol.

Additionally, or alternatively, the NE 1600 may be configured to or operable to support a means for receiving a sensing signal having a time-domain signal pattern that defines signal characteristics subsequent to IFFT processing of frequency domain resources of the sensing signal, where the frequency domain resources include at least a first set of REs allocated for data symbols using a data modulation scheme and a second set of REs allocated for generation of the time-domain signal pattern, obtaining the data symbols from the first set of REs by performing FFT processing on the sensing signal, and performing one or more measurements using the sensing signal based on the time-domain signal pattern.

Additionally, the NE 1600 may be configured to support any one or combination of receiving a configuration indicating the second set of REs and one or more time-domain shaping parameters associated with the sensing signal. Additionally, or alternatively, the NE 1600 may be configured to support performing CSI estimation based on the configuration. Additionally, or alternatively, the NE 1600 may be configured to support the sensing signal including one or more ZP time periods and at least one NZP time period, and applying different AGC states during different time periods of the sensing signal according to the time-domain signal pattern. Additionally, or alternatively, the NE 1600 may be configured to support performing rate matching around the second set of REs. Additionally, or alternatively, the NE 1600 may be configured to support transmitting a report that includes a channel quality indication corresponding to the second set of REs or an indication of a candidate set of frequency domain REs determined according to predefined selection criteria.

Additionally, or alternatively, the NE 1600 may support at least one memory and at least one processor coupled with the at least one memory and configured to cause the NE to determine a configuration for a sensing measurement procedure associated with a sensing signal having a first time period and a third time period that are associated with a low-power or ZP transmission state and a second time period that is associated with a high-power or NZP transmission state, select, based on the configuration, respective parameters for each of the first time period, the second time period, and the third time period, the respective parameters including one or more of a start time, a duration, a power level, or a time-domain sequence, generate the sensing signal according to the configuration and the respective parameters, and transmit the sensing signal during the first, second, and third time periods according to the respective power levels.

Additionally, the NE 1600 may be configured to support any one or combination of receiving an indication of one or more of the respective parameters from at least one second device that is acting as a sensing RX node or a sensing controller entity. Additionally, or alternatively, the NE 1600 may be configured to support the respective parameters being selected based on one or more of capability information associated with at least one second device that is acting as a sensing RX node, an energy, delay, angle, or doppler difference between a sensing target and environment clutter, an observed sensing target SNR at the at least one second device, a threshold sensing target SNR at the at least one second device, a delay or angle of one or more paths interfering with the sensing signal, geometry information that includes positions of one or more sensing TX devices and the at least one second device, radar cross-section information of a sensing target, a transmitter-receiver switching time associated with the at least one second device, a measurement quantity type or a measurement quantity resolution or accuracy to be generated by the at least one second device upon reception of the sensing signal, channel statistics of a channel of the sensing signal, a type of the sensing measurement procedure, or a self-interference isolation level associated with a sensing TX node and a sensing RX node. Additionally, or alternatively, the NE 1600 may be configured to support transmitting the respective parameters to a second device that is acting as a sensing TX node. Additionally, or alternatively, the NE 1600 may be configured to support performing reception and measurement of the sensing signal according to the respective parameters. Additionally, or alternatively, the NE 1600 may be configured to support the configuration including at least one of a sensing target area, a sensing target type, a sensing TX node location, or a sensing RX node location. Additionally, or alternatively, the NE 1600 may be configured to support the power level of the first time period and the third time period being the same and being defined jointly according to a ratio relative to the power level of the second time period, or the first time period, the second time period, and the third time period each including one or more distinct time-domain symbols, guard intervals, slots, subframes, or a combination thereof, according to a sensing signal frame structure. Additionally, or alternatively, the NE 1600 may be configured to support the first time period and the third time period being embedded within a same symbol, within a same cyclic prefix, or a combination thereof, the duration of the first time period being based on a threshold delay difference from a first arrival path for a target decibel isolation value, the duration of the third time period being equal to the duration of the second time period plus a threshold expected delay of a path associated with a sensing target, at least one of the first time period or the third time period being defined, as part of a slot format or a subframe format, as ZP periods within a symbol, a guard band, or a zero-interval outside of a symbol or guard-band period, or a cyclic prefix, a guard band, or a unique word being defined as a ZP or low-power sequence and being utilized as the first time period or the third time period. Additionally, or alternatively, the NE 1600 may be configured to support updating at least one of a symbol format, a cyclic prefix format, or a slot format according to a predefined pattern based on the respective parameters. Additionally, or alternatively, the NE 1600 may be configured to support allocating, when the second time period is within an uplink symbol or a cyclic prefix of an uplink symbol, the third time period to a downlink symbol, or allocating, when the second time period is within a downlink symbol or a cyclic prefix of a downlink symbol, the third time period to an uplink symbol. Additionally, or alternatively, the NE 1600 may be configured to support the power level of the second time period being based on a previous transmission instance and an associated measurement, an associated processing gain value, and a target SNR value, or the duration of the second time period being based on a delay difference between a sensing target path and a background channel, minus a threshold relative path delay for a target decibel isolation value. Additionally, or alternatively, the NE 1600 may be configured to support determining signal shaping parameters based on a group report, group capability information, or location information of a group of sensing RX nodes. Additionally, or alternatively, the NE 1600 may be configured to support one or more of the signal shaping parameters corresponding to one or more indexes of a codebook. Additionally, or alternatively, the NE 1600 may be configured to support rows of the codebook indicating repetition patterns for repetitions of the sensing signal, each repetition pattern associated with a respective periodicity and a respective quantity of repetitions. Additionally, or alternatively, the NE 1600 may be configured to support each repetition pattern including a distance-dependent signal shaping parameter that jointly defines at least one of the duration of the second time period or the duration of the third time period and at least one of the quantity of repetitions or the periodicity. Additionally, or alternatively, the NE 1600 may be configured to support adjusting the power level of the second time period based on feedback indicating a ratio between an observed SNR and a threshold SNR for the sensing measurement procedure.

Additionally, or alternatively, the NE 1600 may support at least one memory and at least one processor coupled with the at least one memory and configured to cause the NE to receive a configuration for a sensing measurement procedure associated with a sensing signal having a first time period and a third time period that are associated with a low-power or ZP transmission state and a second time period that is associated with a high-power or NZP transmission state, receive, in accordance with the configuration, the sensing signal during the first, second, and third time periods, and perform at least one sensing measurement on the sensing signal received during the second time period.

Additionally, the NE 1600 may be configured to support any one or combination of determining a ratio of an observed received SNR associated with a sensing target channel to a threshold SNR and transmitting a report indicating the ratio. Additionally, or alternatively, the NE 1600 may be configured to support determining one or more parameters for the sensing signal based on performing one or more measurements associated with the sensing measurement procedure and transmitting a report indicating the one or more parameters, where the configuration is received based on the report.

Additionally, or alternatively, the NE 1600 may support at least one memory and at least one processor coupled with the at least one memory and configured to cause the NE to determine one or more parameters of a time-domain signal pattern of a sensing signal, where the time-domain signal pattern defines signal characteristics subsequent to IFFT processing of frequency domain resources, select a first set of REs of the frequency domain resources allocated for transmission, by the device, of data symbols using a data modulation scheme, select a second set of REs of the frequency domain resources allocated for generation of the time-domain signal pattern, calculate values for the second set of REs to produce the time-domain signal pattern based on the data symbols in the first set of REs, the time-domain signal pattern, IFFT block dimensions, a location of the second set of REs within an IFFT input, or some combination thereof, generate the sensing signal having the time-domain signal pattern by performing the IFFT processing of the frequency domain resources including the first set of REs and the second set of REs, and transmit the sensing signal.

Additionally, the NE 1600 may be configured to support any one or combination of determining a resource allocation pattern that includes one or more of a starting RE position or PRB position, a quantity of consecutive REs or PRBs, a frequency domain spacing between REs or PRBs, a bitmap indicating the second set of REs, or an index referencing preconfigured frequency domain resources. Additionally, or alternatively, the NE 1600 may be configured to support performing one or more channel measurements and selecting, for the second set of REs, REs having channel responses that satisfy a quality threshold. Additionally, or alternatively, the NE 1600 may be configured to support selecting the second set of REs based on capability information of the device, the capability information including one or more of a computational capacity for time-domain shaping, a processing latency associated with time-domain shaping, or a threshold quantity of time-domain shaping REs. Additionally, or alternatively, the NE 1600 may be configured to support transmitting, to a sensing configuration entity, the capability information, and receiving, from the sensing configuration entity, an indication of the one or more parameters. Additionally, or alternatively, the NE 1600 may be configured to support transmitting, to a receiver device or a configuration node, an indication of the one or more parameters, an indication of the second set of REs, or both. Additionally, or alternatively, the NE 1600 may be configured to support receiving, from a receiver device, a report that includes a channel quality indication corresponding to the second set of REs or an indication of a candidate set of frequency domain REs determined by the receiver device according to predefined selection criteria, and selecting the second set of REs based on the report. Additionally, or alternatively, the NE 1600 may be configured to support a quantity of REs in the second set of REs corresponding to a quantity of time-domain samples defining the time-domain signal pattern. Additionally, or alternatively, the NE 1600 may be configured to support the time-domain signal pattern including one or more of a pulse pattern having one or more ZP periods and at least one NZP period, an isolated ZP period, a pattern associated with reduction of a PAPR of the sensing signal, or some combination thereof. Additionally, or alternatively, the NE 1600 may be configured to support the sensing signal being transmitted within a portion of a symbol and having a QCL relationship with frequency domain resources of a second signal that are precoded according to a same spatial pattern as the portion of the symbol. Additionally, or alternatively, the NE 1600 may be configured to support the frequency domain resources of the second signal including data REs or DMRS REs, and transmitting an indication of the QCL relationship to a receiver device. Additionally, or alternatively, the NE 1600 may be configured to support the time-domain signal pattern being associated with a first spatial transmission pattern and the first set of REs being associated with a second spatial transmission pattern different from the first spatial transmission pattern. Additionally, or alternatively, the NE 1600 may be configured to support the time-domain signal pattern spanning one or more transmission symbols or a portion of a transmission symbol.

Additionally, or alternatively, the NE 1600 may support at least one memory and at least one processor coupled with the at least one memory and configured to cause the NE to receive a sensing signal having a time-domain signal pattern that defines signal characteristics subsequent to IFFT processing of frequency domain resources of the sensing signal, where the frequency domain resources include at least a first set of REs allocated for data symbols using a data modulation scheme and a second set of REs allocated for generation of the time-domain signal pattern, obtain the data symbols from the first set of REs by performing FFT processing on the sensing signal, and perform one or more measurements using the sensing signal based on the time-domain signal pattern.

Additionally, the NE 1600 may be configured to support any one or combination of receiving a configuration indicating the second set of REs and one or more time-domain shaping parameters associated with the sensing signal. Additionally, or alternatively, the NE 1600 may be configured to support performing CSI estimation based on the configuration. Additionally, or alternatively, the NE 1600 may be configured to support the sensing signal including one or more ZP time periods and at least one NZP time period, and applying different AGC states during different time periods of the sensing signal according to the time-domain signal pattern. Additionally, or alternatively, the NE 1600 may be configured to support performing rate matching around the second set of REs. Additionally, or alternatively, the NE 1600 may be configured to support transmitting a report that includes a channel quality indication corresponding to the second set of REs or an indication of a candidate set of frequency domain REs determined according to predefined selection criteria.

The controller 1606 may manage input and output signals for the NE 1600. The controller 1606 may also manage peripherals not integrated into the NE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the NE 1600 may include at least one transceiver 1608. In some other implementations, the NE 1600 may have more than one transceiver 1608. The transceiver 1608 may represent a wireless transceiver. The transceiver 1608 may include one or more receiver chains 1610, one or more transmitter chains 1612, or a combination thereof.

A receiver chain 1610 may be configured to receive signals (e.g., control information, data, packets) over a wireless medium. For example, the receiver chain 1610 may include one or more antennas to receive a signal over the air or wireless medium. The receiver chain 1610 may include at least one amplifier (e.g., an LNA) configured to amplify the received signal. The receiver chain 1610 may include at least one demodulator configured to demodulate the receive signal and obtain the transmitted data by reversing the modulation technique applied during transmission of the signal. The receiver chain 1610 may include at least one decoder for decoding the demodulated signal to receive the transmitted data.

A transmitter chain 1612 may be configured to generate and transmit signals (e.g., control information, data, packets). The transmitter chain 1612 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

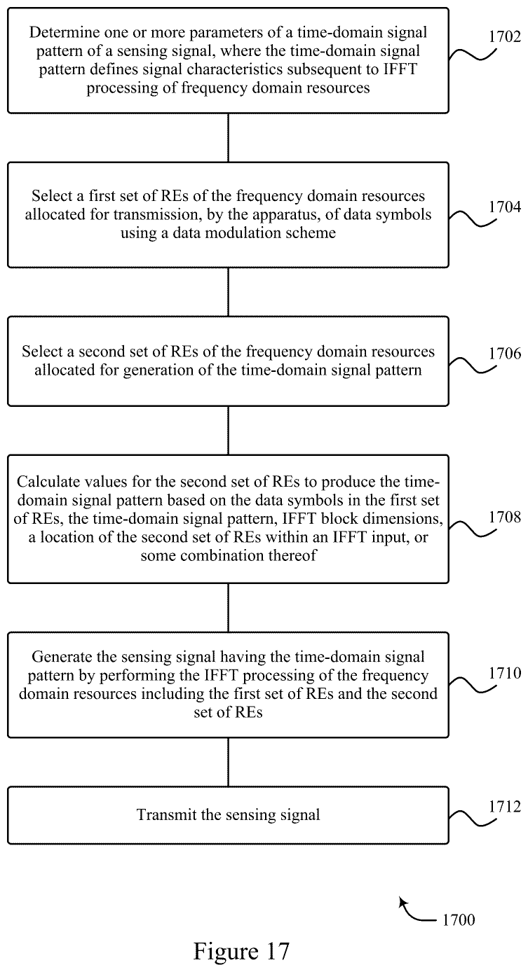

FIG. 17 illustrates a flowchart of a method 1700 in accordance with aspects of the present disclosure. The operations of the method may be implemented by a UE or an NE as described herein. In some implementations, the UE or an NE may execute a set of instructions to control the function elements of the UE or an NE to perform the described functions. It should be noted that the method described herein describes a possible implementation, and that the operations and the steps may be rearranged or otherwise modified and that other implementations are possible.

At 1702, the method may include determining one or more parameters of a time-domain signal pattern of a sensing signal, where the time-domain signal pattern defines signal characteristics subsequent to IFFT processing of frequency domain resources. The operations of 1702 may be performed in accordance with examples as described herein. In some implementations, aspects of the operations of 1702 may be performed by a UE as described with reference to FIG. 14 and/or an NE as described with reference to FIG. 16.

At 1704, the method may include selecting a first set of REs of the frequency domain resources allocated for transmission of data symbols using a data modulation scheme. The operations of 1704 may be performed in accordance with examples as described herein. In some implementations, aspects of the operations of 1704 may be performed by a UE as described with reference to FIG. 14 and/or an NE as described with reference to FIG. 16.

At 1706, the method may include selecting a second set of REs of the frequency domain resources allocated for generation of the time-domain signal pattern. The operations of 1706 may be performed in accordance with examples as described herein. In some implementations, aspects of the operations of 1706 may be performed a UE as described with reference to FIG. 14 and/or an NE as described with reference to FIG. 16.

At 1708, the method may include calculating values for the second set of REs to produce the time-domain signal pattern based on the data symbols in the first set of REs, the time-domain signal pattern, IFFT block dimensions, a location of the second set of REs within an IFFT input, or some combination thereof. The operations of 1708 may be performed in accordance with examples as described herein. In some implementations, aspects of the operations of 1708 may be performed by a UE as described with reference to FIG. 14 and/or an NE as described with reference to FIG. 16.

At 1710, the method may include generating the sensing signal having the time-domain signal pattern by performing the IFFT processing of the frequency domain resources including the first set of REs and the second set of REs. The operations of 1710 may be performed in accordance with examples as described herein. In some implementations, aspects of the operations of 1710 may be performed by a UE as described with reference to FIG. 14 and/or an NE as described with reference to FIG. 16.

At 1712, the method may include transmitting the sensing signal. The operations of 1712 may be performed in accordance with examples as described herein. In some implementations, aspects of the operations of 1712 may be performed by a UE as described with reference to FIG. 14 and/or an NE as described with reference to FIG. 16.

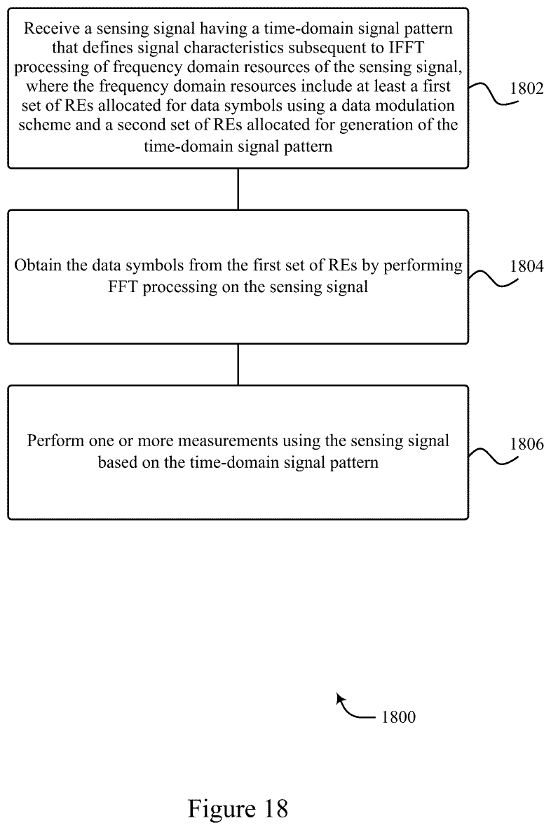

FIG. 18 illustrates a flowchart of a method 1800 in accordance with aspects of the present disclosure. The operations of the method may be implemented by a UE or an NE as described herein. In some implementations, the UE or the NE may execute a set of instructions to control the function elements of the UE or the NE to perform the described functions. It should be noted that the method described herein describes a possible implementation, and that the operations and the steps may be rearranged or otherwise modified and that other implementations are possible.

At 1802, the method may include receiving a sensing signal having a time-domain signal pattern that defines signal characteristics subsequent to IFFT processing of frequency domain resources of the sensing signal, where the frequency domain resources include at least a first set of REs allocated for data symbols using a data modulation scheme and a second set of REs allocated for generation of the time-domain signal pattern. The operations of 1802 may be performed in accordance with examples as described herein. In some implementations, aspects of the operations of 1802 may be performed by a UE as described with reference to FIG. 14 and/or an NE as described with reference to FIG. 16.

At 1804, the method may include obtaining the data symbols from the first set of REs by performing FFT processing on the sensing signal. The operations of 1804 may be performed in accordance with examples as described herein. In some implementations, aspects of the operations of 1804 may be performed by a UE as described with reference to FIG. 14 and/or an NE as described with reference to FIG. 16.

At 1806, the method may include performing one or more measurements using the sensing signal based on the time-domain signal pattern. The operations of 1806 may be performed in accordance with examples as described herein. In some implementations, aspects of the operations of 1806 may be performed by a UE as described with reference to FIG. 14 and/or an NE as described with reference to FIG. 16.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A apparatus for wireless communication, comprising:
at least one memory; and
at least one processor coupled with the at least one memory and operable to cause the apparatus to:
determine one or more parameters of a time-domain signal pattern of a sensing signal, wherein the time-domain signal pattern defines signal characteristics subsequent to inverse fast Fourier transform (IFFT) processing of frequency domain resources;
select a first set of resource elements (REs) of the frequency domain resources allocated for transmission, by the apparatus, of data symbols using a data modulation scheme;
select a second set of REs of the frequency domain resources allocated for generation of the time-domain signal pattern;
calculate values for the second set of REs to produce the time-domain signal pattern based at least in part on the data symbols in the first set of REs, the time-domain signal pattern, IFFT block dimensions, a location of the second set of REs within an IFFT input, or some combination thereof;
generate the sensing signal having the time-domain signal pattern by performing the IFFT processing of the frequency domain resources including the first set of REs and the second set of REs; and
transmit the sensing signal.

2. The apparatus of claim 1, wherein, to select the second set of REs, the at least one processor is further operable to cause the apparatus to determine a resource allocation pattern that includes one or more of:
a starting RE position or physical resource block (PRB) position;
a quantity of consecutive REs or PRBs;
a frequency domain spacing between REs or PRBs;
a bitmap indicating the second set of REs; or
an index referencing preconfigured frequency domain resources.

3. The apparatus of claim 1, wherein, to select the second set of REs, the at least one processor is further operable to cause the apparatus to:
perform one or more channel measurements; and
select, for the second set of REs, REs having channel responses that satisfy a quality threshold.

4. The apparatus of claim 1, wherein, to select the second set of REs, the at least one processor is further operable to cause the apparatus to:
select the second set of REs based at least in part on capability information of the apparatus, the capability information including one or more of a computational capacity for time-domain shaping, a processing latency associated with time-domain shaping, or a threshold quantity of time-domain shaping REs.

5. The apparatus of claim 4, wherein the at least one processor is further operable to cause the apparatus to:
transmit, to a sensing configuration entity, the capability information; and
receive, from the sensing configuration entity, an indication of the one or more parameters.

6. The apparatus of claim 1, wherein the at least one processor is further operable to cause the apparatus to transmit, to a receiver apparatus or a configuration node, an indication of the one or more parameters, an indication of the second set of REs, or both.

7. The apparatus of claim 1, wherein, to select the second set of REs, the at least one processor is further operable to cause the apparatus to:
receive, from a receiver apparatus, a report that includes a channel quality indication corresponding to the second set of REs or an indication of a candidate set of frequency domain REs determined by the receiver apparatus according to predefined selection criteria; and
select the second set of REs based at least in part on the report.

8. The apparatus of claim 1, wherein a quantity of REs in the second set of REs corresponds to a quantity of time-domain samples defining the time-domain signal pattern.

9. The apparatus of claim 1, wherein the time-domain signal pattern comprises one or more of:
a pulse pattern having one or more zero-power periods and at least one non-zero power period;
an isolated zero-power period;
a pattern associated with reduction of a peak-to-average power ratio (PAPR) of the sensing signal; or
some combination thereof.

10. The apparatus of claim 1, wherein the sensing signal is transmitted within a portion of a symbol and has a quasi-co-location (QCL) relationship with frequency domain resources of a second signal that are precoded according to a same spatial pattern as the portion of the symbol.

11. The apparatus of claim 10, wherein the frequency domain resources of the second signal comprise data REs or demodulation reference signal (DMRS) REs, and wherein the at least one processor is further operable to cause the apparatus to transmit an indication of the QCL relationship to a receiver apparatus.

12. The apparatus of claim 1, wherein the time-domain signal pattern is associated with a first spatial transmission pattern and the first set of REs are associated with a second spatial transmission pattern different from the first spatial transmission pattern.

13. The apparatus of claim 1, wherein the time-domain signal pattern spans one or more transmission symbols or a portion of a transmission symbol.

14. A apparatus for wireless communication, comprising:
at least one memory; and
at least one processor coupled with the at least one memory and operable to cause the apparatus to:
receive a sensing signal having a time-domain signal pattern that defines signal characteristics subsequent to inverse fast Fourier transform (IFFT) processing of frequency domain resources of the sensing signal, wherein the frequency domain resources include at least a first set of resource elements (REs) allocated for data symbols using a data modulation scheme and a second set of REs allocated for generation of the time-domain signal pattern;
obtain the data symbols from the first set of REs by performing fast Fourier transform (FFT) processing on the sensing signal; and
perform one or more measurements using the sensing signal based at least in part on the time-domain signal pattern.

15. The apparatus of claim 14, wherein the at least one processor is further operable to cause the apparatus to receive a configuration indicating the second set of REs and one or more time-domain shaping parameters associated with the sensing signal.

16. The apparatus of claim 15, wherein the at least one processor is further operable to cause the apparatus to perform channel state information (CSI) estimation based at least in part on the configuration.

17. The apparatus of claim 14, wherein the sensing signal includes one or more zero-power time periods and at least one non-zero-power time period, and wherein the at least one processor is further operable to cause the apparatus to apply different automatic gain control states during different time periods of the sensing signal according to the time-domain signal pattern.

18. The apparatus of claim 14, wherein, to obtain the data symbols, the at least one processor is further operable to cause the apparatus to perform rate matching around the second set of REs.

19. The apparatus of claim 14, wherein the at least one processor is further operable to cause the apparatus to transmit a report that includes a channel quality indication corresponding to the second set of REs or an indication of a candidate set of frequency domain REs determined according to predefined selection criteria.

20. A method performed by an apparatus, comprising:
determining one or more parameters of a time-domain signal pattern of a sensing signal, wherein the time-domain signal pattern defines signal characteristics subsequent to inverse fast Fourier transform (IFFT) processing of frequency domain resources;
selecting a first set of resource elements (REs) of the frequency domain resources allocated for transmission, by the apparatus, of data symbols using a data modulation scheme;
selecting a second set of REs of the frequency domain resources allocated for generation of the time-domain signal pattern;
calculating values for the second set of REs to produce the time-domain signal pattern based at least in part on the data symbols in the first set of REs, the time-domain signal pattern, IFFT block dimensions, a location of the second set of REs within an IFFT input, or some combination thereof;
generating the sensing signal having the time-domain signal pattern by performing the IFFT processing of the frequency domain resources including the first set of REs and the second set of REs; and
transmitting the sensing signal.
